(19) United States
(12) Patent Application Publication
(10) Pub. No.: US 2025/0276748 A1
(43) Pub. Date: Sep. 4, 2025

(54) Robotic Muscle Device and Method of Actuation

(71) Applicant: SPIKE DYNAMICS, SAN FARNCISCO, CA (US)

(72) Inventor: ALEXANDER SERGEEV, SAN FRANCISCO, CA (US)

(73) Assignee: SPIKE DYNAMICS, SAN FRANCISCO, CA (US)

(21) Appl. No.: 18/772,172

(22) Filed: Jul. 14, 2024

Related U.S. Application Data
(63) Continuation-in-part of application No. 17/880,582, filed on Aug. 3, 2022.

(51) Int. Cl. B62D 57/032; B25J 9/00; B25J 9/12

(52) U.S. Cl. CPC B62D 57/032; B25J 9/0009; B25J 9/123

(57) ABSTRACT

An actuated or mobile device such as a mobile robot or robotic muscle is provided, wherein mobility may be enabled by means of novel models of inchworm actuator optimized to produce different varieties of motion, such as inching along different varieties of rail(s) or track(s) or extending and collapsing a paddle on a wheel. The various novel models of inchworm actuator further vary in step length, correlation of device state to power state, and other design aspects.

### CO-PENDING PATENT APPLICATION

This Nonprovisional Patent Application is a Continuation-in-Part Application to U.S. patent application Ser. No. 17/880,582 titled “Robotic muscle utilizing inchworm actuation” as filed on Aug. 3, 2022, by self-same Inventor Alexander Sergeev. Said U.S. patent application Ser. No. 17/880,582 is incorporated within the present disclosure in its entirety and for all purposes.

### FIELD OF THE INVENTION

This invention relates to inchworm actuator technology as utilized particularly in robotics, and more specifically to optimizations in clamp grip and design simplicity, and providing of novel locomotion systems, methods and applications.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Generally speaking, anywhere there is powered movement by a machine, there's an actuator that translates power from an energy source into physical motion, such as a motor that spins a shaft (a rotary actuator) or one that pushes or pulls on whatever may be attached (a linear actuator). The variety of mechanical actuators and motors known in the art of engineering allows for wide ranges of application already, and often allows an engineer to select, not just an actuator that is capable of a given task, but a variety of actuator that can accomplish the desired motion most efficiently and with the least additional engineering.

However, the field of robotics, particularly practical robots that are useful in everyday applications instead of as scientific curiosities, is strictly limited by what can be done efficiently and cheaply with actuators as currently known in the art, namely by what available and affordable actuators happen to already be ‘good at’. It's known in the art to use a larger number or variety of actuators to attempt to engineer almost any motion, such as that of a human hand as with robot hands and prosthetics, but such implementations currently utilize dozens or hundreds of actuators that have to be carefully engineered to do a complicated task none of the actuators are actually designed to do well, which adds up to a steep price tag.

Often, this principle limits what kind of mobile robotic technology is available for ordinary people to use in their homes or businesses, favoring robots which are stationary (such as smart appliances) or which move on wheels (such as a robotic vacuum cleaner) over robots with articulated limbs or other forms of locomotion that require lots of actuators to build with the current technology available and are therefore more expensive and difficult to build. As an example, this is generally why there are affordable robots that vacuum, but none that fold laundry; the former mode of motion is doable cheaply with simple motors that spin wheels, and the latter is not. A robot that walks, crawls, or scampers on individual limbs, or which uses arms or hands, is inefficient to build with the current available actuator technology.

Therefore, there is a long-felt need in the art of engineering and robotics to provide and make available further novel actuator implementations adapted to excel at different varieties of powered motion.

### SUMMARY OF THE INVENTION

Towards these and other objects of the method of the present invention (hereinafter, “the invented method”) that are made obvious to one of ordinary skill in the art in light of the present disclosure, an actuated or mobile device such as a mobile robot or robotic muscle is provided, wherein mobility may be enabled by means of novel models of inchworm actuator positioned to tighten, loosen, move, or pull on one or more strings (also called threads or tendons) to directly or indirectly effect motion. The one or more clamp elements of the inchworm actuator may include the novel optimization of being H-shaped. The mobility of the device may be effected by means of inchworm actuators tightening and/or loosening strings or tendons causing ‘foot’ elements to rotatably extend from or tuck into a surface of the device, enabling the device to pull itself along over a surface. The device may include one or more moveable joints implemented as a rigid arc frame and a string axis comprising bendable material shaped to bendably couple the arc frame to an opposite side of the joint such as a limb.

Inchworm actuators in general are a variety of “pulling” actuator that uses piezoelectric, electrostatic, magnetostriction, or similar motors to move a shaft with nanometer precision. The piezoelectric motors are activated in sequence to grip, extend, un-grip, and contract such that the shaft is moved along by an incremental ‘inching’ movement. The traditional view is that inchworm actuators excel at precision motions, able to measure the ‘inching’ motions down to the nanometer and start or stop very precisely. As generally known in the art, an inchworm actuator is fixed to a given spot and pulls on the shaft to change the position of the shaft relative to the fixed position of the actuator.

In preferred embodiments, the invented inchworm actuator as described herein is distinct in a few ways, and the system in which this invented inchworm actuator may be applied is counterintuitive to inchworm actuators as known in the art. For one, while most actuators would generally be mounted onto a single physical point of the machine being operated, such as with bolts or welding, the use of inchworm actuators in combination with tendon like structures may allow the weight of the actuator to be supported entirely by the tension of the tendon(s), with no mounting of the actuator actually necessary. This may provide unprecedented flexibility of design, both in expansion of what can be designed and in the movement capabilities of the resulting machines.

As an example of this kind of system's value in an application such as robotic muscles, one might consider a similarity in design to biological muscles. In the human body, muscles produce force and motion by contracting and releasing, and in doing so pull on tendons, which connect muscles to bones and can be put under tension like a rubber band. One's fingers don't need much on-site muscle of their own (think how bulky that would be!) because muscles in the palm and forearm provide the power, pulling on tendons connected to the finger bones. Now, one might consider that the invented actuator provides force to effect motion by expanding and contracting to put tension on a stretchable tendon (which, in this case, might actually be a rubber band). For a large limb, bigger tendons or more tendon systems operating in parallel may be needed, but the basic concept is similar for a knee, an elbow, a facial muscle, or a finger.

In various preferred embodiments of the invention, the tendon component may be flexible or a greater or lesser degree, such as a cord, stretchy band, wire, or thin metal or plastic rod, as several non-limiting examples. Tendons as understood herein need not resemble anatomical tendons; the concept inspiring this terminology is more generally that of a structure that allows a muscle to pull on something located distantly using an intermediary structure, rather than requiring muscles or actuators to be positioned directly at a site of motion. For instance, the majority of muscles used for moving one's fingers are located in one's forearms, not in the fingers themselves; tendons connect these muscles to the bones of the fingers and allow those forearm muscles to effect finger motion. It is noted, regarding more sophisticated musculature in the field of robotics, that if one wants to mimic motion found in nature (such as that of a human hand, limb, or face), one might benefit from following the corresponding naturally-occurring engineering examples, instead of trying to approximate the same effect using the same motors one might use to turn wheels.

A first embodiment of the invented inchworm actuated device may comprise or include at least a body, at least one spring element coupling a front end of the body to a back end of the body, at least one piezoelectric linear actuator coupled to two or more H-shaped clamping elements, and one or more lengths of string or tendon positioned to be gripped by the clamps. It is noted that this combination of inchworm actuator and tendons may be featured as an actuating component of any number of devices, including the second embodiment device outlined below; however, the second embodiment outlined below includes many more novel features besides the actuation components, and this first embodiment is generalized to be any kind of device that includes this novel approach to actuation. The inchworm actuated device may shift the position of the length of string or tendon relative to the position of the device itself, such that (1.) if the device is fixed in place, the position of the string may be altered; (2.) if the string is anchored, such as at one or both ends, the device may move itself by pulling on the anchored string; and (3.) if both the device and the string are anchored, the string may be pulled taut or loosened by shortening or lengthening the slack of the string length between the fixed position of the device relative to the anchored point of the string. The inchworm actuated device pulls on the string to effect any of these motions, ‘inching’ along the string as the term ‘inchworm actuator’ implies, by performing the following basic steps in rotation: (1.) the frontmost clamp grips the string; (2.) the linear actuator causes the device body to extend (the grip point on the string is pulled along with the front of the device, and the spring element is stretched out); (3.) the rearmost clamp grips the string and the frontmost clamp releases; and (4.) the released spring element causes the device to contract (and the grip point on the string is pushed along with the rear of the device). It is noted that ‘front’ and ‘rear’ are relative terms, signifying either toward or away from the direction in which one intends to pull the string. It is noted how, in an implementation such as a robotic muscle, the string therefore functions similarly to an anatomical tendon, effecting motion by being tightened and loosened. The novel H shape of the clamping elements in this instance, combined with narrow clamping elements pushing outward to press the tendons into place between the ascenders and descenders of the H-shaped clamping elements, provides for holding the string, not just between two flat elements as with a standard non-H-shaped clamping element, but also pinching the string in the gap of space between the two ascenders and the two descenders of the H shape. This may provide better stability, reduce the force necessary to securely clamp the string in place, or provide other unexpected benefits. Further, the novel spring element may provide at least the benefit of faster contraction of the actuation device, providing a significantly faster and more efficient contraction motion over that of inchworm actuators as generally known in the art which may rely on a second motion of the piezoelectric stack for the same function.

Further preferred features and embodiments having an H-shaped clamp as mentioned herein, or a U-shaped clamp (i.e. only half of the H), may further include as an opposite clamping component a protruding ‘beak’ element which presses the string or tendon, not just against the H or U shaped clamp element, but into the gap(s) formed by the H or U shape. Since the tendon material may often be at least a little flexible, this may provide a more secure clamp grip by bending the tendon around the ‘beak’ element and causing the tendon to be gripped in two narrow places—namely against the beak on either side, instead of just against a broader clamp surface. If one considers gripping a string with one's fingers, rather than a tendon in a clamp, the benefit might be comparable mechanically to the difference between holding the string between two fingers as opposed to weaving the string through or around one's fingers.

A second embodiment of the invented inchworm actuated device may comprise or include at least a body having a front end and a rear end, one or more spring elements coupled such that a first end of the spring is attached to the front end and a second end of the spring is attached to the rear end, and one or more assemblies each comprising a linear actuator motor, two or more clamps coupled to the linear actuator motor and positioned to grip a paired set of strings or tendons, the strings each anchored at a first end of the device and anchored to either side of a leg rotator at the opposite end; the leg rotator substantively cylindrical, rotatably coupled to the front end or to the rear end of the device, and positioned such that tension on either length of string (provided by the linear actuator and clamps) causes the leg rotator to rotate clockwise or counterclockwise around a central axis of the cylindrical shape of the leg rotator; and a foot coupled to the leg rotator such that when the leg rotator is rotated (by tension on the strings), the attached foot is folded out (extended) or folded in (retracted). The device may utilize coordinated extension and retraction of two or more feet positioned on the front and/or rear sections of the device to engage/disengage with a surface the device is traversing. One readily apparent application is that the device may also practice the inchworm-pattern motion as explicated above: engage front, extend the springs coupling the front end to the rear end, engage the back and disengage the front, retract the springs. In this way, the invented device may inch along using relatively few and simple actuators, providing a powerful actuator or robotic device with a novel variety of movement, simplicity of design, affordability, scalability, and versatility suitable to a number of actuated and robotic applications that may heretofore have been considered impractical with previously available technology. A preferred example may include a robot or device equipped with a camera and suited for navigating into tight spaces by pushing with the above-mentioned legs against the sides of the narrow space, such as a small and/or flat model for inspecting behind heavy furniture or up a chimney, or an even smaller model that could climb into a plumbing pipe, potentially saving a specialist or handy-person hours of labor otherwise required to move the furniture or access the pipe.

A third embodiment of the invented actuated device may comprise or include at least one articulated mechanical joint or coupling in the fashion of a bow joint comprising a rigid arc and twistable or bendable string element. The name “bow joint” is derived from the structure's similarity in shape to a bow used to shoot an arrow: a rigid arc or frame, with a string coupled at either end onto each end of the arc. With an element such as a shaft coupled to the string, the shaft is permitted to rotate orthogonally to the string, around the string as a central point, until the shaft hits the arc, but restricted from other degrees of motion, such as parallel to or laterally along the string. One might compare this to the joint of one's knee: though the actual mechanical structure of the human knee is different, that structure also performs the function of permitting a specifically limited range of motion, such that one's knee bends well for walking or sitting, but can't be bent in the opposite direction, nor outward to one's left or right. The mechanical enforcement of a preferred range of motion may make the human leg substantially more structurally stable and easier to use for walking without injury. Similarly, the invented mechanical bow joint provides a flexible articulated mechanical joint, and also a means for mechanically limiting range of motion as preferred.

One potential application for the invented actuator device as explicated herein is in a bi-directional servo motor implementation, such as might be used in electromagnetic locks and valves, or for remotely opening/closing windows, gates, or doors. While many applications of the invented actuator device are possible, including some yet unanticipated, this is an example of a possibly less-obvious way in which this new technology may be utilized. In the preferred implementation, the invented actuator device is moving along and/or tightening tendons hooked onto two opposite ends of a linear frame possibly including a rail, such that the invented actuator device may pull on the tendons to move itself between one frame end and the other frame end, in appearance like a piston, according to control signals. For instance, the invented actuator device may be configured to move ‘up’ when the control signal is ON, and ‘down’ when the control signal is OFF, thus controlling also a lock, door, or other mechanical element connected to the actuating device. The invented actuator device may also function as a ‘fader’, rather than a binary on/off switch. The bi-directional servo motor application may further include a shaft element attached to the end of the invented actuator device, such that “on and off” correspond with extension and retraction of this physical element, in an application such as a deadbolt.

Yet another further application of the invented technology may be in a structure which utilizes the actuated motion of tendons pulled by the invented device to turn an axle or shaft (as with a turbine or wheel). This implementation might consist of a single invented actuator device rotatably coupled to an axle, such as by a ring-shaped element, with the tendons of the invented actuating device looped around the axle such that pulling on the tendons causes the axle to turn.

If the axle is fixed in place and the actuator device is not, the same implementation might be suitable for allowing the actuating device to rotate itself around the axle by pulling on the tendons.

Parallel implementations of this rotary application, with several of the invented actuating devices rotatably coupled to the same axle and causing that axle to spin, are possible here. Running multiple actuators in parallel has at least the advantage of providing redundancy and increased force, such as for using the axle to move something heavy, as well as the ‘staggered re-spooling’ implementation discussed below. Further, this invented implementation for rotating an axle using the invented actuator device may be parallelized either by stacking multiple actuators in a line along the axle or by attaching multiple actuators to the same ring, causing the multiple actuators to be placed in a concentric arc or ring around the axle. A ‘star’ of actuators all the way around the same axle could be very powerful indeed, and further, one might do both, and form a ‘stacked star’.

This implementation might be considered a servo motor, as the available length of tendon is finite and this isn't ideal for continuous motion, such as spinning a wheel or turbine. However, one might precisely ‘program’ a certain amount of rotation by providing only enough tendon length to complete that amount. This also may be a good option for instances in which a significant amount of torque is required to perform a single movement. An example of this type of motion might be a batter swinging at a baseball: it's motion in an arc which has to be limited and precise (i.e. swinging too far is not preferred) but with a lot of torque and force.

Further, providing continuous motion might be achieved by having multiple actuators connected in a parallel implementation ‘take turns’ rewinding tendons while the other actuators continue to work, like a choir sustaining a long, continuous sound by the technique of individuals taking nonobvious breaths at different moments while the rest continue to sing.

Further, the structure of an instance of the invented actuator utilizing its tendons to rotate its own position relative to an axle may be an ideal structure for a robotic joint such as an elbow or knee, with the axle as the fulcrum point and an actuator to either side articulating the limb. Each side of the joint may also utilize multiple actuators in parallel. It is also possible to build a mechanical joint of this kind with more than one degree of freedom, by connecting two axles with a pole in-between them, such that a first actuator turns around a first axle, a second actuator turns around a second axle, and the axles are connected.

Continuing with the concept of utilizing two or more invented actuators rotating their own positions about a mutual axle to form a robotic joint, one might assemble an entire robotic hand this way, as disclosed herein, and the scalability of the invented actuators and tendons allows for a less bulky, cheaper, nimbler, and more dexterous implementation of a robotic hand than is generally expected or known in the art. It is noted that the use of inchworm actuators to tense and release tendon elements, as well as other elements disclosed herein, represents a unique and novel approach to actuated robotic motion, including that of robotic limbs, that may easily distinguish the robotic hands explicated herein from ‘robot hands’ as a generally understood concept. Many previous implementations of robotic hands in particular, which generally require dexterity, have struggled with fitting in bulky actuators that are ill-suited to the task, and which requiring lots of actuators carefully engineered to achieve the desired motion capabilities. The invention or inventions disclosed herein are believed to be a far better approach to this known problem, one that entirely eliminates much of the bulk, cost, difficulty, and delay that has generally characterized previous attempts at engineering robotic manual dexterity.

Yet another novel application of the invented actuator may be in pivoting a clawlike element to extend and retract. With a single invented actuator coupled with tendons to rotate and axle, and the axle further coupled to a clawlike appendage, the actuator may pivot the axle, and therefore fold or extend the claw appendage. This may be useful in particular for building a robot whose tasks necessitate the ability to climb. A few anticipated applications for such a climbing robot may include roof maintenance and power line maintenance.

Regarding suitable materials for constructing the invented device, the invented device may be constructed of any material deemed suitable by one skilled in the art as presently considered or discovered in the future to be suitable, including but not limited to plastics, wood, metal, rubber, synthetic polymers, and similar. In certain preferred embodiments, the string or tendon elements might be implemented from a composite material such as a composite material with ability to dissolve a part of material the way that only hard part may be left. For example, a rectangular string might contain two plastic or metal string and a filler. During the printing process all parts are in place, but then a part of material can be dissolved or removed by high temperature.

One skilled in the art recognizes that certain elements must be rigid, other elements must be flexible or twistable, other elements must conduct electricity, and may perceive other such practical limitations as stated herein regarding the individual elements, and that those practicalities may further limit the set of appropriate materials for certain specific elements from that which is listed here, or compel one to utilize a variety of a suggested material that suits the practical limitation concerned, such as using soft plastic instead of hard plastic as appropriate, or a metal that is more malleable rather than less as appropriate.

It is understood that this statement and any other regarding preferred or possible materials is not intended as a limitation, and is offered only as additional guidance in constructing an instance of the invention in an optimal fashion as understood presently by the inventor.

Specifically regarding preferred or suitable piezoelectric components for implementation of the invented actuator, it is noted that the invented design includes mechanical amplification of the displacement of the PZT stack through leverage, and that preferred qualities for a PZT stack in this context may include a displacement of 0.1%-0.2% and ability to provide a relatively strong force. While the model being utilized for building a prototype is the PK2FVF1 Amplified Piezoelectric Actuator, 75 V, 420 μm, as manufactured by Thorlabs, Inc. of New Jersey, USA, it should be noted that this is an example of a piezoelectric actuator that is considered merely adequate for demonstrating and illustrating the basic concept. A preferred model of PZT actuator would be smaller, lighter, and may be a custom design particular to the implementations described herein.

It is understood that any measurements given herein as to the size or scale of the invented devices disclosed herein pertains only to the examples given, and does not constitute a limitation regarding size or scale of the invention. The invented devices disclosed herein may be substantially scalable, making both very small and very large embodiments entirely possible and potentially useful depending upon the intended application. It is understood that the invented components presented herein are scalable, and indeed, benefits of this novel approach include the possibility of making very small functional embodiments utilizing the same principles. Any sizes or measurements included in this disclosure should be viewed as presenting of functional examples, rather than construed as limitations. This disclosure should not be construed as insisting upon or specifying any particular size or scale of the invention.

Preferred embodiments of the invention may be or include an apparatus comprising: a tensile element, the tensile element substantively inelastic along a traction axis, the tensile element comprising a first end and a second end; and an expandable means coupled with the tensile element by means of a coupling element wherein the tensile element is pinched by pressing of a length of the tensile element into a U-shaped gap, the expandable means adapted to expand and thereby deliver a force to the tensile element, the force initially being normal to the traction axis, whereby the force is transferred from the expandable means to the tensile element and causes the tensile element to exert force along the traction axis.

Further additional preferred embodiments of the invention may be or include an apparatus comprising: a device front end, a device rear end, at least one spring element coupling the device front end extendable to the device rear end, and at least one assembly comprising: a cylindrical element coupled rotatably to a selected device end selected from either the device front end or the device rear end, and coupled also to a protruding element, whereby an extension of the protruding element is increased and decreased by rotation of the cylindrical element around a central axis of the cylindrical element; a first tensile element (“the first string”) substantively inelastic along a first traction axis and comprising a first string first end and a first string second end, wherein the first string first end is coupled to the cylindrical element whereby pulling on the first string rotates the cylindrical element clockwise, and the first string second end is anchored to a device end opposite the selected device end coupled to the cylindrical element; a first expandable means coupled with the first string, the first expandable means adapted to expand and thereby deliver a force to the first string, the force initially being normal to the first traction axis, whereby the force is transferred from the first expandable means to the first string and causes the first string to exert force along the first traction axis and pull the cylindrical element to rotate clockwise; a second tensile element (“the second string”) substantively inelastic along a second traction axis and comprising a second string first end and a second string second end, wherein the second string first end is coupled to the cylindrical element whereby pulling on the second string rotates the cylindrical element counterclockwise, and the second string second end is anchored to the device end opposite the selected device end coupled to the cylindrical element; and a second expandable means coupled with the second string, the second expandable means adapted to expand and thereby deliver a force to the second string, the force initially being normal to the second traction axis, whereby the force is transferred from the second expandable means to the second string and causes the second string to exert force along the second traction axis and pull the cylindrical element to rotate counterclockwise.

Further additional preferred embodiments of the invention may be or include an apparatus comprising at least one articulated joint coupling, the articulated joint coupling comprising: a first side of the articulated joint coupling comprising a rigid arc with a first arc end and a second arc end; a string element with a first string end coupled to the first arc end and a second string end coupled to the second arc end; and a second side of the articulated joint coupling coupled to a point on the string element between the first string end and the second string end.

Further additional preferred embodiments of the invention may be or include a clamping apparatus for clamping a bendable string, the clamping apparatus comprising at least a first side, the first side shaped to include a gap positioned between a first column and a second column; a second side, the second side shaped to include a protruding element positioned to sit between the first column and the second column when the clamp is engaged, such that when the clamp is engaged, the bendable string is forced into the gap between the first column and the second column, and around the protruding element.

Further additional preferred embodiments of the invention may be or include a bidirectional servo motor utilizing the invented actuators as described above, which might be utilized as an actuated locking mechanism or similar.

Further additional preferred embodiments of the invention may be or include an axle torque servo motor utilizing embodiments of the invented device, wherein the force exerted by the tensile element either turns and axle or rotates the position of the device around an axle. This embodiment in particular may be utilized in an assembly comprising two axle torque servo motors oriented around the same axle, each able to pivot its own position relative to the axle, forming a movable robotic joint. Further, a variation of this robotic joint having two degrees of motion instead of one, may consist of an assembly comprising a first axle torque servo motor rotating itself around a first axle, and a second axle torque servo motor rotating itself around a second axle, the first axle and the second axle coupled together by a post, forming a movable robotic joint having two degrees of motion. A robotic hand with fingers might be constructed utilizing multiple instances of either of these movable robotic joints. A robotic claw could be made, comprising the axle torque servo motor with a claw-shaped element coupled to the axle, such that rotating the axle unfolds or retracts the claw, which might be suitable for constructing a climbing robot which can use these claws to grip and climb as a cat does.

A first alternate preferred embodiment of the present invention comprises an expandable and retractable element having a rooted end and an extending end, the expandable and retracting element configured to extend the extending end along an axis and away from the rooted end when energized or receiving internal or external momentum; and a lever assembly comprising a lever arm a fulcrum zone, the lever coupled with the extended end at an inner lever end and with a leg at an opposing outer lever end, wherein the fulcrum zone is configured to enable transfer of mechanical force received from the extending end to cause displacement of the outer lever end and the leg.

In certain alternate preferred embodiments of the present invention, the expandable and retracting is or comprises a piezoelectric element.

In certain other alternate preferred embodiments of the present invention, the fulcrum zone may be positioned (a.) to cause the leg to rotate toward the piezoelectric element rooted end when the lever receives mechanical force transferred from the extending end; (b.) closer to the inner lever end then to the outer lever end; (c.) drive the leg away from the rooted end extending when the lever receives mechanical force from the piezoelectric element extending end; or (d.) positioned to drive the outer lever end away from the piezoelectric element rooted end when the lever receives mechanical force from the piezoelectric element extending end.

Certain still alternate preferred embodiments of the present invention comprise (a.) a piezoelectric element having a rooted end and an extending end, the piezoelectric element configured to extend the extending end along an axis and away from the rooted end when energized; (b.) a first lever assembly comprising a first lever arm a first fulcrum zone, the first lever coupled with the extended end at a first inner lever end and with a first leg at an first opposing lever end, wherein the first fulcrum zone is configured to enable transfer of mechanical force received from the piezoelectric element extending end to cause displacement of the first outer lever end and the first leg; and (c.) a second lever assembly comprising a second lever arm a second fulcrum zone, the second lever coupled with the extended end at a second inner lever end and with a second leg at an second opposing lever end, wherein the second fulcrum zone is configured to enable transfer of mechanical force received from the piezoelectric element extending end to cause displacement of the second outer lever end and the second leg.

In certain still alternate preferred embodiments of the present invention, (a.) the fulcrum zone is positioned to enable the first leg to rotate toward the piezoelectric element rooted end when the first lever receives mechanical force transferred from the piezoelectric element extending end; (b.) the second fulcrum zone is positioned to enable the second leg to rotate toward the piezoelectric element rooted end when the second lever receives mechanical force transferred from the piezoelectric element extending end; (c.) the first fulcrum zone is positioned to enable the first leg to rotate away from the piezoelectric element rooted end when the first lever receives mechanical force transferred from the piezoelectric element extending end.

Certain even alternate preferred embodiments of the present invention further comprise (a.) a frame, wherein the first lever is attached to the first leg and with the frame at a first side of the frame, and the second lever is attached to the second leg and with the frame at an opposing second side of the frame; (b.) comprising a second assembly having a a second piezoelectric element presenting a second rooted end and a second extending end, the second piezoelectric element configured to extend the second extending end along the axis and in opposite direction from the direction of extension of another piezoelectric element; (c.) a third lever assembly comprising a third lever arm and a third fulcrum zone, the third lever coupled with the second extended end at a third inner lever end and with a third leg at a third opposing lever end, wherein the third fulcrum zone is configured to enable transfer of mechanical force received from the second piezoelectric element extending end to cause displacement of the third outer lever end and the third leg, wherein the third lever is attached to the third leg and with the frame at the first side of the frame; and/or (d.) a fourth lever assembly comprising a fourth lever arm and a fourth fulcrum zone, the fourth lever coupled with the second extended end at a fourth inner lever end and with a fourth leg at a fourth opposing lever end, wherein the fourth fulcrum zone is configured to enable transfer of mechanical force received from the second piezoelectric element extending end to cause displacement of the fourth outer lever end and the fourth leg, wherein the fourth lever is attached to the fourth leg and with the frame at the opposing second side of the frame.

In certain additional alternate preferred embodiments of the present invention, (a.) wherein a third fulcrum zone is positioned to cause the third leg to rotate toward the second piezoelectric element rooted end when the third lever receives mechanical force transferred from the second piezoelectric element extending end; (b.) an alternate third fulcrum zone is positioned closer to the third inner lever end then to the third outer lever end; (c.) fourth fulcrum zone is positioned to drive the fourth leg away from the second rooted end when the fourth lever receives mechanical force from the second piezoelectric element extending end; and/or a fourth fulcrum zone is positioned to drive the fourth outer lever end toward the second rooted end when the fourth lever receives mechanical force from the second piezoelectric element extending end.

A first alternate embodiment of the invented may comprise one or more of the following aspects: (a.) positioning a device between a first surface and an opposing second surface, the device comprising a piezoelectric element having a frame, a rooted end and an extending end, the piezoelectric element configured to extend the extending end along an axis and away from the rooted end when energized, a first lever assembly comprising a first lever arm a first fulcrum zone, the first lever coupled with the extended end at a first inner lever end and with a first leg at an first opposing lever end, wherein the first fulcrum zone is configured to enable transfer of mechanical force received from the piezoelectric element extending end to cause displacement of the first outer lever end and the first leg; and a second lever assembly comprising a second lever arm a second fulcrum zone, the second lever coupled with the extended end at a second inner lever end and with a second leg at an second opposing lever end, wherein the second fulcrum zone is configured to enable transfer of mechanical force received from the piezoelectric element extending end to cause displacement of the second outer lever end and the second leg; and (b.) energizing the piezoelectric element to cause the piezoelectric element to extend, whereby both the first leg and the second leg are displaced.

Additional alternate preferred embodiments of invented method further comprise one or more of the following aspects: (a.) a device further comprising: a second piezoelectric element having a second rooted end and a second extending end, the second piezoelectric element configured to extend the second extending end along the axis and in opposite direction from the direction of extension of the piezoelectric element, a third lever assembly comprising a third lever arm and a third fulcrum zone, the third lever coupled with the second extended end at a third inner lever end and with a third leg at a third opposing lever end, wherein the third fulcrum zone is configured to enable transfer of mechanical force received from the second piezoelectric element extending end to cause displacement of the third outer lever end and the third leg; a fourth lever assembly comprising a fourth lever arm and a fourth fulcrum zone, the fourth lever coupled with the second extended end at a fourth inner lever end and with a fourth leg at a fourth opposing lever end, wherein the fourth fulcrum zone is configured to enable transfer of mechanical force received from the second piezoelectric element extending end to cause displacement of the fourth outer lever end and the fourth leg, wherein the first lever is attached to the first leg and with the frame at a first side of the frame, the second lever is attached to the second leg and with the frame at an opposing second side of the frame, the third lever is attached to the third leg and with the frame at the first side of the frame, and the fourth lever is attached to the fourth leg and with the frame at the opposing second side of the frame; and (b.) energizing the piezoelectric element to cause the piezoelectric element to extend, whereby both the first leg and the second leg are displaced; and
e. energizing the second piezoelectric element to cause the second piezoelectric element to extend, whereby both the third leg and the fourth leg are displaced.

Yet other alternate preferred embodiments of invented method further comprise positioning the first fulcrum zone to enable the first leg to rotate toward the piezoelectric element rooted end when the first lever receives mechanical force transferred from the piezoelectric element extending end.

Still other alternate preferred embodiments of invented method further comprise positioning the first fulcrum zone to enable the first leg to rotate away from the piezoelectric element rooted end when the first lever receives mechanical force transferred from the [first] piezoelectric element extending end.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

The present disclosure incorporates by reference the two registered US Patents and one US Provisional Patent Application, in their entirety and for all purposes, of US Patent Reg. No. 10,422,359, issued on Sep. 24, 2019, and titled TENSILE ACTUATOR; US Patent Reg. No. 10,920,800, issued on Feb. 16, 2021, and titled TENSILE ACTUATOR; and US Patent Application Appn. Ser. No. 63/158,859, filed on Mar. 9, 2021 and titled INCHWORM ACTUATOR; US Patent Publication No. US20220405441A1 (Inventors Subraya; Chandrashekar, et al.) as published on Dec. 12, 2022 and titled DESIGNING A STRUCTURAL PRODUCT INCLUDING STRUCTURAL ANALYSIS AND POST-PROCESSING; US Patent Publication No. US20140180654A1 (Inventor Seymour; Stephen Michael) as published on Jun. 26, 2014 and titled Client Finite Element Submission System; and US Patent Publication No. US20170308633A1 (Inventors Lee; Hangki, et al.) as published on Oct. 26, 2017 and titled SYSTEM FOR FINITE ELEMENT MODELING AND ANALYSIS OF A STRUCTURAL PRODUCT.

The above-cited US Patents and Provisional Patent Application are incorporated herein by reference in their entirety and for all purposes.

### BRIEF DESCRIPTION OF DRAWINGS

The detailed description of some embodiments of the invention is made below with reference to the accompanying figures, wherein like numerals represent corresponding parts of the figures.

FIG. 1A is a first line drawing of an invented prototype actuator device with tendons belonging to a first embodiment of the invented device;

FIG. 1B is a diagram presenting further information about the clamping elements and tendon motion of the device of FIG. 1A;

FIG. 2 is a second line drawing of the invented actuator device of FIG. 1A;

FIG. 3 is a third line drawing of the invented actuator device of FIG. 1A;

FIG. 4 is a 3D model of the invented actuator device of FIG. 1A without tendons included;

FIG. 5 is a 3D model providing a view of the invented actuator device of FIG. 4 from an additional angle;

FIG. 6 is a 3D model of the invented actuator device of FIG. 1A in a partially-assembled state with the clamp elements partially removed to show other elements;

FIG. 7 is a 3D model providing a view of the partially-assembled invented actuator device of FIG. 6 from an additional angle;

FIG. 8 is a 3D model providing a view of the first embodiment of the invented device in the partially-assembled state of FIG. 6 as viewed from a third additional angle;

FIG. 9 is a 3D model of the frame and clamp elements of the first embodiment of the invented device;

FIG. 10 is the 3D model of the frame element of FIG. 9 at a different angle and without the clamps;

FIG. 11 is the 3D model of the frame element of FIG. 10 at an additional different angle;

FIG. 12 is a 3D model of the first embodiment of the invented device of FIG. 4 in a partially-assembled state, with the frame of FIG. 9 and the H-shaped clamp holders removed to view other elements;

FIG. 13 is a 3D model providing a view of the first embodiment of the invented device in the partially-assembled state of FIG. 12 as viewed from an additional angle;

FIG. 14 is a 3D model providing a view of the first embodiment of the invented device in the partially-assembled state of FIG. 12 as viewed from a second additional angle;

FIG. 15 is a 3D model of a clamp element of FIG. 4 presented separately;

FIG. 16 is a line drawing of the frame element of FIG. 9 coupled together with three H-shaped clamping elements, with a fourth H-shaped clamping element removed to display;

FIG. 17 is a line drawing of the frame element of FIG. 17 coupled together with the four H-shaped clamping elements;

FIG. 18 is a line drawing presenting a prototype device representing a second embodiment of the invention;

FIG. 19 is a second line drawing presenting an additional view of the device of FIG. 18;

FIG. 20 is a third line drawing presenting an additional view of the device of FIG. 18;

FIG. 21 is a fourth line drawing presenting an additional view of the device of FIG. 18;

FIG. 22 is a fifth line drawing presenting an additional view of the device of FIG. 18;

FIG. 23 is a line diagram representation of the tendon structure of the second embodiment of FIG. 18;

FIG. 24A is a first line diagram presenting a method of folding and unfolding robot legs by means of a couple of pulling actuators of FIG. 23, wherein the leg is folded in;

FIG. 24B is a second line diagram presenting the leg of FIG. 24A now in an extended position;

FIG. 25 is a line diagram of a system similar to those of FIGS. 24A and 24B, showing how the same two actuators may be further utilized to pull on more strings and thus operate two legs instead of just one;

FIG. 26 is a line drawing presenting a first mechanical joint with one degree of motion belonging to a third embodiment of the invention;

FIG. 27 is a line drawing presenting the mechanical joint of FIG. 26 in a rotated position;

FIG. 28 is a 3D model presenting the string component of the mechanical joint of FIG. 26 in a perspective view;

FIG. 29 is a 3D model presenting the string component of FIG. 28 in a top view;

FIG. 30 is a 3D model presenting the string component of FIG. 28 in a side view;

FIG. 31A is a line drawing presenting the mechanical joint of FIG. 26 in a partially-bent position;

FIG. 31B is a line drawing presenting the mechanical joint of FIG. 26 bent to approximately a 90 degree angle;

FIG. 31C is a line drawing presenting the mechanical joint of FIG. 26 in an unbent position;

FIG. 32 is a line drawing presenting a second mechanical joint having two degrees of motion belonging to the third embodiment of the invention;

FIG. 33 is a line drawing presenting an additional view of the second mechanical joint of FIG. 32;

FIG. 34 is a line drawing presenting an additional view of the second mechanical joint of FIG. 32, bended into a position demonstrating the flexibility of the mechanical joint;

FIG. 35 is a 3D model presenting a perspective view of the flexible element of the second mechanical joint of FIG. 32;

FIG. 36 is a 3D model presenting a top view of the flexible element of FIG. 35;

FIG. 37 is a 3D model presenting a side view of the flexible element of FIG. 35;

FIG. 38A is a first 3D model view of a beak feature for potential use in clamping assemblies of various embodiments such as but not limited to the invented actuator device of FIG. 1A;

FIG. 38B is a second 3D model view of a beak feature for potential use in clamping assemblies of various embodiments such as but not limited to the invented actuator device of FIG. 1A;

FIG. 38C is a third 3D model view of a beak feature for potential use in clamping assemblies of various embodiments such as but not limited to the invented actuator device of FIG. 1A;

FIG. 39A is a 3D model of a bi-directional servo motor implementation utilizing an embodiment of the invented actuator device of FIG. 1A;

FIG. 39B is the 3D model of the bi-directional servo motor of FIG. 39A, presented from a first additional viewing angle;

FIG. 39C is the 3D model of the bi-directional servo motor of FIG. 39A, presented from a second additional viewing angle;

FIG. 39D is the 3D model of the bi-directional servo motor of FIG. 39A, presented from a third additional viewing angle;

FIG. 40A is a 3D model of an axle-rotation servo motor implementation utilizing an embodiment of the invented actuator device of FIG. 1A;

FIG. 40B is a diagram similar to that of FIG. 1B, pertaining to the axle-rotation servo motor implementation of FIG. 40A;

FIG. 40C is a diagram presenting more information about the internal mechanics of the axle-rotation servo motor implementation of FIG. 40A;

FIG. 40D is a first possible cross-section of the frame element of FIG. 40A;

FIG. 40E is a second possible cross-section of the frame element of FIG. 40A;

FIG. 41 is a 3D model of four of the axle-rotation servo motor implementation of FIG. 40A set up to work in parallel along the same axle;

FIG. 42A is a 3D model of three of the axle-rotation servo motor implementation of FIG. 40A set up to work in parallel oriented around the same axle in a partial arc;

FIG. 42B is a first different angle of the 3D model of FIG. 42A;

FIG. 42C is a second different angle of the 3D model of FIG. 42A;

FIG. 43 is a 3D model of multiple of the axle-rotation servo motor implementation of FIG. 40A set up to work in parallel oriented around the same axle in a full orbit forming a star shape;

FIG. 44 is a 3D model of multiple of the axle-rotation servo motor implementation of FIG. 40A, parallelized both around the same axle as in FIG. 43 and along the same axle as in FIG. 41, forming a stacked star shape;

FIG. 45 is a 3D model presenting an implementation of an artificial joint utilizing two of the axle-rotation servo motors of FIG. 40A;

FIG. 46A is a 3D model presenting an implementation of an artificial joint utilizing two parallelized sets of the axle-rotation servo motors of FIG. 42A;

FIG. 46B is a different angle of the 3D model of FIG. 46A;

FIG. 46C is a 3D model presenting an implementation of an artificial joint utilizing two stacked parallelized sets of the axle-rotation servo motors of FIG. 46A, in the manner of FIG. 44;

FIG. 47A is a 3D model presenting an implementation of an artificial joint having two degrees of freedom, utilizing two of the axle-rotation servo motors of FIG. 40A;

FIG. 47B is a different angle of the 3D model of FIG. 47A;

FIG. 47C is a closer view of the 3D model of FIG. 47B;

FIG. 48A is a first view of a 3D model presenting a robotic hand implemented using axle-rotation servo motor joints as presented in FIG. 46A and onward;

FIG. 48B is a second view of the 3D model robotic hand of FIG. 47A;

FIG. 48C is a third view of the 3D model robotic hand of FIG. 47A;

FIG. 49A is a profile view of a claw assembly implemented utilizing the axle torque assembly of FIG. 40A, with the claw folded in;

FIG. 49B is a profile view of the claw assembly of FIG. 49A, with the claw folded out;

FIG. 49C is a top view of the claw assembly of FIG. 49A, with the claw folded in;

FIG. 50A is a first view of a robot utilizing multiple instances of the claw assembly of FIG. 49A for climbing;

FIG. 50B is a second view of a robot utilizing multiple instances of the claw assembly of FIG. 49A for climbing;

FIG. 51A is a line diagram presenting a guided linear actuator, which is an embodiment of the inchworm actuator of FIG. 1A designed for locomotion on a parallel track;

FIG. 51B is a line diagram presenting the GLA of FIG. 51A placed onto a track;

FIG. 51C is a line diagram presenting a side view of the GLA and track of FIG. 51B;

FIG. 51D is a line diagram presenting the piezoelectric actuator elements of the GLA of FIG. 51A in isolation;

FIG. 51E is a line diagram presenting the frame of the GLA of FIG. 51A in isolation;

FIG. 52A is a table regarding the actuator states of the GLA of FIG. 51A as a holding GLA;

FIG. 52B is a line diagram regarding operation of the holding clamp of FIG. 51A;

FIG. 52C is a line diagram regarding operation of the holding clamp of FIG. 51A;

FIG. 53A is a line diagram presenting a nonholding embodiment of the GLA of FIG. 51A;

FIG. 53B is a line diagram presenting the nonholding GLA of FIG. 53A on a track;

FIG. 53C is a line diagram presenting a front view of the nonholding GLA and track of FIG. 53B;

FIG. 53D is a line diagram presenting the three actuators of the nonholding GLA of FIG. 53A in isolation;

FIG. 54A is a table regarding the actuator states of the nonholding GLA of FIG. 53A;

FIG. 54B is a line diagram regarding operation of the nonholding clamp of FIG. 53A;

FIG. 54C is a line diagram regarding operation of the nonholding clamp of FIG. 53A;

FIG. 55 is a line diagram presenting an embodiment of the GLA of FIG. 51A which has an amplifying middle section design;

FIG. 56A is a line diagram presenting a first additional alternative variation of the middle section shape of the GLA of FIG. 51A;

FIG. 56B is a line diagram presenting a second additional alternative variation of the middle section shape of the GLA of FIG. 51A;

FIG. 56C is a line diagram presenting a third additional alternative variation of the middle section shape of the GLA of FIG. 51A;

FIG. 56D is a line diagram presenting a fourth additional alternative variation of the middle section shape of the GLA of FIG. 51A;

FIG. 56E is a line diagram presenting a fifth additional alternative variation of the middle section shape of the GLA of FIG. 51A;

FIG. 56F is a line diagram presenting a sixth additional alternative variation of the middle section shape of the GLA of FIG. 51A;

FIG. 57A is a line drawing presenting a first visual aid regarding further discussion of modifying the shape of the middle section;

FIG. 57B is a line drawing presenting a second visual aid regarding further discussion of modifying the shape of the middle section;

FIG. 58A is a line drawing presenting an amplified push embodiment of the GLA of FIG. 51A;

FIG. 58B is a line drawing presenting a first partial assembly of the amplified push embodiment of FIG. 58A;

FIG. 58C is a line drawing presenting only the frame pieces of the amplified push embodiment of FIG. 58A;

FIG. 58D is a line drawing presenting an exploded view of a partial assembly of the amplified push actuator middle section of FIG. 59A;

FIG. 58E is a line drawing further presenting the amplified push actuator middle section of the GLA of FIG. 58A;

FIG. 58F is a line drawing presenting a side view of the amplified push actuator middle section of FIG. 59A;

FIG. 58G is a line drawing presenting a partial assembly of the amplified push actuator middle section of FIG. 59A in isolation;

FIG. 58H is a line drawing presenting the actuator elements of the amplified push actuator middle section of FIG. 59A in isolation;

FIG. 58I is a line drawing presenting a partial assembly of the amplified push actuator middle section of FIG. 59A in isolation;

FIG. 58J is a line drawing presenting the amplified push actuator middle section of FIG. 58A, with bending of lever components exaggerated to demonstrate how actuator expansion moves components of the amplified push actuator frame;

FIG. 58K is a line drawing presenting a top view of the amplified push actuator middle section of FIG. 58A in an unpowered state, for comparison alongside FIG. 58L;

FIG. 58L is a line drawing presenting a top view of the amplified push actuator middle section of FIG. 58A, with bending of lever components exaggerated to demonstrate how actuator expansion moves components of the amplified push actuator frame;

FIG. 59 is a function table for an extending model middle section;

FIG. 60 is a function table for a contracting model middle section;

FIG. 61A is a first alternative clamp design for the clamps of the GLA of FIG. 51A;

FIG. 61B is a second alternative clamp design for the clamps of the GLA of FIG. 51A;

FIG. 61C is a third alternative clamp design for the clamps of the GLA of FIG. 51A;

FIG. 61D is a fourth alternative clamp design for the clamps of the GLA of FIG. 51A;

FIG. 61E is a fifth alternative clamp design for the clamps of the GLA of FIG. 51A;

FIG. 61F is a sixth alternative clamp design for the clamps of the GLA of FIG. 51A;

FIG. 61G is a seventh alternative clamp design for the clamps of the GLA of FIG. 51A;

FIG. 61H is an eighth alternative clamp design for the clamps of the GLA of FIG. 51A;

FIG. 62 is a one-armed clamp design for the clamps of the GLA of FIG. 51A which might be preferable in some applications;

FIG. 63A is a line drawing presenting a version of the GLA of FIG. 51A designed for locomotion along a rail;

FIG. 63B is a line drawing presenting a view of the GLA of FIG. 63A without the rail;

FIG. 63C is a line drawing presenting a view of the GLA of FIG. 63A without the rail and with some components removed to show other components;

FIG. 63D is a line drawing presenting the actuators of the GLA of FIG. 63A in isolation;

FIG. 64A is a line drawing presenting second alternative version of the GLA of FIG. 63A designed for locomotion along a rail, with the GLA shaped to fit around the rail;

FIG. 64B is a line drawing presenting the actuator elements of the GLA of FIG. 64A and the rail in isolation;

FIG. 64C is a line drawing presenting the actuator elements of the GLA of FIG. 64A in isolation;

FIG. 65 is a line drawing presenting a “holding” clamp component for inclusion in the GLA of FIG. 64A;

FIG. 66 is a line drawing presenting a “nonholding” clamp component for inclusion in the GLA of FIG. 64A;

FIG. 67A is a line drawing presenting a solenoid actuator version of the one rail GLA of FIG. 63A;

FIG. 67B is a second line drawing presenting the solenoid actuator GLA of FIG. 67A in a different clamp state;

FIG. 67C is a third line drawing presenting the solenoid actuator GLA of FIG. 67A in an additional different clamp state;

FIG. 68A is a line drawing presenting a version of the GLA of FIG. 51A designed for locomotion along a pair of parallel rails;

FIG. 68B is a line drawing presenting the two-rail GLA of FIG. 68A with the rails not pictured;

FIG. 68C is a line drawing presenting the actuator elements of the two-rail GLA of FIG. 68A in isolation;

FIG. 69 is a line drawing presenting the two-rail GLA of FIG. 68A on rails, wherein the rails further provide electrical power;

FIG. 70A is a line drawing presenting an alternative version of the two-rail GLA of FIG. 68A designed for differently shaped rails;

FIG. 70B is a line drawing presenting the rails and actuator elements of the two-rail GLA of FIG. 70A in isolation;

FIG. 71A is a line drawing presenting a version of the GLA of FIG. 51A adapted for locomotion on a pair of toothed rails;

FIG. 71B is a line drawing presenting the GLA and toothed rails of FIG. 71A without the track housing;

FIG. 72A is a line drawing presenting a tandem system of two instances of the GLA of FIG. 51A which facilitates two different speeds of locomotion, and further introducing a laser interferometer;

FIG. 72B is a line drawing presenting a view of the tandem GLA system of FIG. 72A with the track removed;

FIG. 72C is a line drawing presenting the tandem GLA system of FIG. 72A with some elements removed to better display other elements;

FIG. 72D is a first line drawing presenting the laser interferometer system components of the tandem GLA system of FIG. 72A in isolation;

FIG. 72E is a second line drawing presenting the laser interferometer system components of the tandem GLA system of FIG. 72A in isolation;

FIG. 73A is a line drawing presenting a rotating apparatus incorporating a plurality of linear actuators;

FIG. 73B is a line drawing presenting the rotating apparatus of FIG. 73A with the casing removed;

FIG. 73C is a line drawing presenting the linear actuator component of the rotating apparatus of FIG. 73A;

FIG. 73D is a second line drawing presenting the linear actuator component of the rotating apparatus of FIG. 73A;

FIG. 73E is a line drawing presenting some selected components of the rotating apparatus of FIG. 73A in isolation;

FIG. 73F is a line drawing presenting some selected components of the rotating apparatus of FIG. 73A in isolation;

FIG. 73G is a line drawing presenting some selected components of the rotating apparatus of FIG. 73A in isolation;

FIG. 73H is a line drawing presenting some selected components of the rotating apparatus of FIG. 73A in isolation;

FIG. 73I is a line drawing presenting a front view of the rotating apparatus of FIG. 73A;

FIG. 73J is a line drawing presenting a back view of the rotating apparatus of FIG. 73A;

FIG. 73K is a line drawing presenting a top view of the rotating apparatus of FIG. 73A;

FIG. 73L is a line drawing presenting the top view of FIG. 73K with one of the outer discs removed to show additional detail;

FIG. 73M is a line drawing presenting a view of the rotating apparatus of FIG. 73A to show the positioning of the inset view of FIG. 73M;

FIG. 73N is a line drawing presenting an inset view to show further detail of the rotating apparatus of FIG. 73A;

FIG. 73O is a line drawing presenting some selected components of the rotating apparatus of FIG. 73A in isolation;

FIG. 74A is a line drawing presenting a double-decker embodiment related to the amplified push GLA of FIG. 58A;

FIG. 74B is a second line drawing pertaining to discussion of the double-decker amplified push GLA of FIG. 74A;

FIG. 74C is a third line drawing presenting a second view of the double-decker amplified push GLA of FIG. 74A; and

FIG. 74D is a line drawing presenting an exploded view of the double-decker amplified push GLA of FIG. 74A.

### DETAILED DESCRIPTION OF DRAWINGS

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limit's ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

Throughout this specification, like reference numbers signify the same elements throughout the description of the figures.

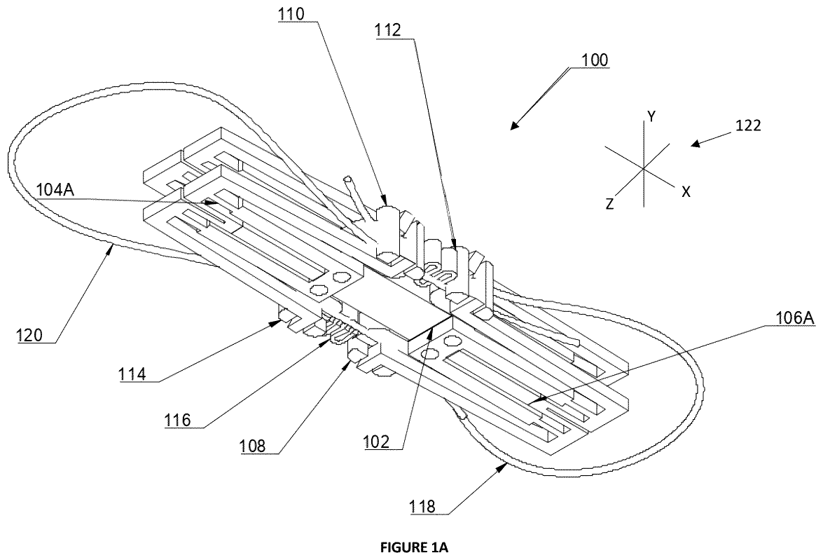

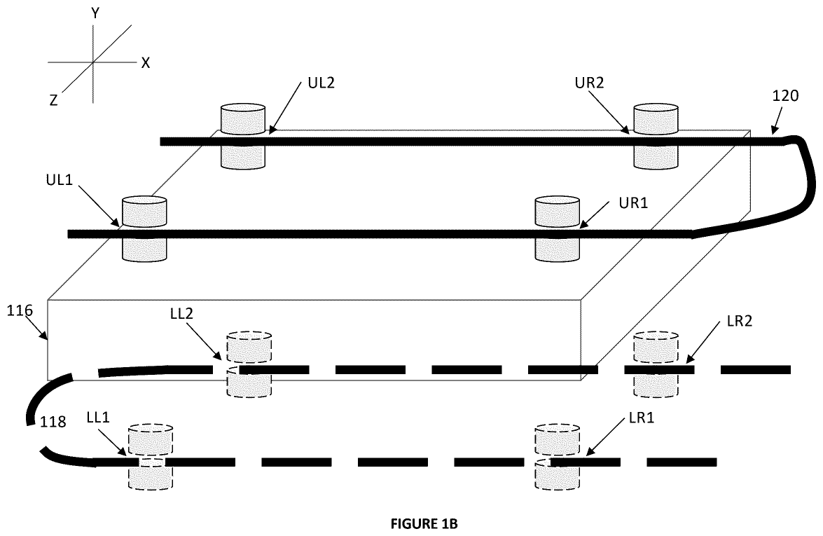

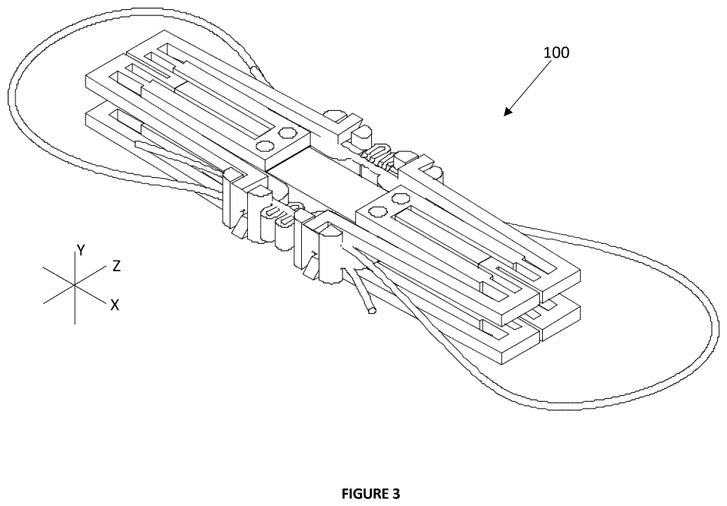

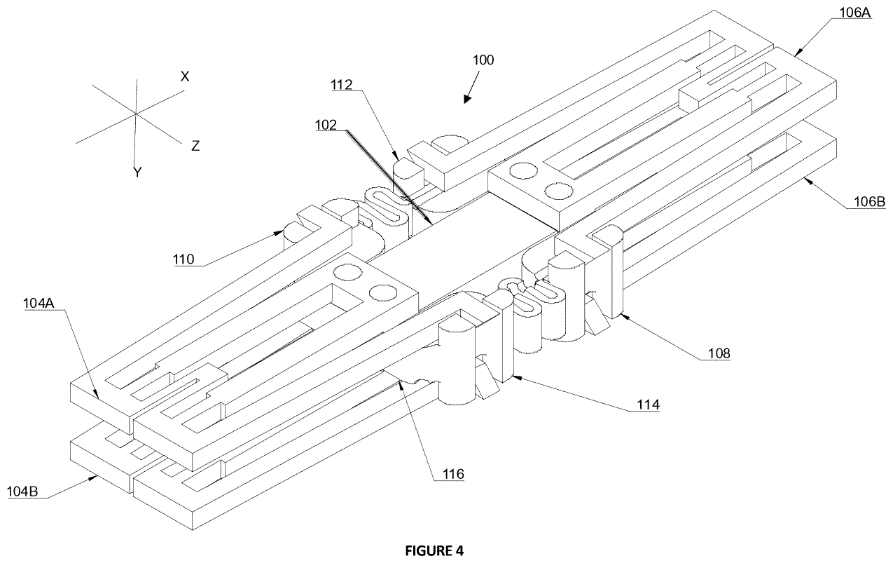

Referring now generally to the Figures and particularly to FIG. 1A, FIG. 1A is a first line drawing of an invented prototype actuator device with tendons, belonging to a first embodiment of the invented device. A first device 100 as pictured here comprises a piezoelectric stack 102; a set of clamping elements 104-114 comprising a first upper inner clamp element 104A, a second upper inner clamp element 106A (these elements are duplicated on the opposite side of the device to the camera, and aren't visible in this image, namely a first lower inner clamp element 104B and a second lower inner clamp element 106B as presented in FIG. 4), a first outer clamp element 108, a second outer clamp element 110, a third outer clamp element 112, a fourth outer clamp element 114; and a frame 116. The clamping elements 104-114 are positioned to controllably grip and release a first tendon 118 and a second tendon 120 (“the tendons 118 & 120”), as a result of being pushed on or released by the piezoelectric stack 102. It is noted that a piezoelectric material is a material that expands in volume in response to receiving an electrical current; therefore, the piezoelectric stack 102 can be controlled to expand by applying an electrical current, and by this expansion engages the clamping elements 104-114 by pressing against the first upper inner clamp element 104A, the first lower inner clamp element 104B (shown in FIG. 4), the second upper inner clamp element 106A, and the second lower inner clamp element 106B (shown in FIG. 4), forcing these elements out toward the first outer clamp element 108, the second outer clamp element 110, the third outer clamp element 112, and the fourth outer clamp element 114, and trapping the first tendon 118 and the second tendon 120 between inner and outer clamping elements. Preferred implementation of this device 100 is as a tandem inchworm actuator comprising multiple coordinated lanes.

Certain Figures presented throughout further include a compass 122, wherein an X axis, a Y axis, and a Z axis are each mutually orthogonal to one another. As these pertain to the presented devices in the various Figures, the Y axis parallels the vertical dimension of up-and-down (i.e. the top and bottom of the device), the X-axis parallels the dimension of forward-and-back (i.e. along the tendons or direction of travel if any), and the Z-axis parallels the dimension of side-to-side. It is noted that some images are top or profile views, and may therefore only show two axes, not three, with the third not visible as it may be ‘pointed toward the viewer’.

Referring now generally to the Figures and particularly to FIG. 1B, FIG. 1B is a diagram presenting more information about the orientation and operation of the clamping elements 104-114 in interaction with the tendons 118 & 120. In FIG. 1A, the clamping elements were named as components of the device 100, specifically as outer pieces and inner pieces capable of being forced together to clamp down on the tendons 118 & 120 at the points where the outer pieces and inner pieces meet. In FIG. 1B, the discussion turns to these clamping points, and how engaging and releasing of these clamping points produces inchworm actuator motion with the tendons 118 & 120. This diagram includes a set of eight clamping points UL1-LR2 (“the clamping points UL1-LR2”): a first upper left clamping point UL1 engaged by the compressing of the first upper inner clamp element 104A against the fourth outer clamp element 114; a second upper left clamping point UL2 engaged by the compressing of the first upper inner clamp element 104A against the second outer clamp element 110; a first lower left clamping point LL1 engaged by the compressing of the first lower inner clamp element 104B (shown in FIG. 4) against the fourth outer clamp element 114; a second lower left clamping point LL2 engaged by the compressing of the first lower inner clamp element 104B (shown in FIG. 4) against the second outer clamp element 110; a first upper right clamping point UR1 engaged by the compressing of the second upper inner clamp element 106A against the first outer clamp element 108; a second upper right clamping point UR2 engaged by the compressing of the second upper inner clamp element 106A against the third outer clamp element 112; a first lower right clamping point LR1 engaged by the compression of the second lower inner clamp element 106B against the first outer clamp element 108; and a second lower right clamping point LR2 engaged by the compression of the second lower inner clamp element 106B (shown in FIG. 4) against the third outer clamp element 112. It is understood that ‘left’, ‘right’, ‘upper’, ‘lower’, ‘first’, and ‘second’ are all arbitrary designations of these components, intended for distinguishing elements of interest and providing as much clarity as possible. It is noted that the device 100 might be oriented differently, such as turning the device around such that all of the ‘left’ elements are placed on the viewer's right-hand side, and nothing would actually change about the device 100.

In the diagram of FIG. 1B, each of the clamping points UL1-LR2 as listed above is represented as a pair of cylinders on either side of one of the tendons 118 & 120, indicating a point at which that tendon may be clamped. It is noted that, in actual operation of the device 100 as presented in FIG. 1A, this clamping generally occurs on either side of the device 100, not on the top and bottom (unless of course one rotates the device to orient the sides as the top and bottom), and the clamping action is generally sideways and outward from the device 100. It is noted that other embodiments of the invented device 100 may implement clamps oriented differently, and that this is more of a clarification regarding the appearance of this diagram as mapped onto the photo of FIG. 1A, than any indication of a limitation. Further, while visual representations herein present components such as clamps as having certain shape or structure, it is also understood that these may vary broadly. One skilled in the art will recognize that there are many shapes of clamp available that would be suitable but are not presented herein, and that the art may further innovate to construct a clamping mechanism ideal for this purpose. One notes that, while inchworm actuators use clamping to effect motion, the means of clamping does not ‘matter’ to the actuator as long as the clamp works. The diagram of FIG. 1B is intended to present the functionality of the clamping points UL1-LR2, not necessarily to present the physical structure of the clamp mechanisms accurately. As presented here, the first tendon 118 fits through and is clamped by the ‘lower’ group of clamping points, specifically, LL1, LL2, LR1, and LR2; and the second tendon 120 fits through and is clamped by the ‘upper’ group of clamping points, specifically, UL1, UL2, UR1, and UR2.

In preferred operation, the device 100 is controlled by supplying power selectively to the piezoelectric stack 102, causing the piezoelectric stack 102 to expand and contract, pushing against the inner clamping elements 104A, 104B, 106A, and 106B and thus engaging and disengaging the clamping points UL1-LR2. A possible pattern of states for effecting motion is as follows:

| | UL | UR | LL | LR | Body | | |
|---|---|---|---|---|---|---|---|
| Zero | + | + | + | + | holds the position | | |
| LEFT1 | − | + | − | + | not moving | \| | |
| LEFT2 | − | + | − | + | extends | \| | Repeating 4 steps |
| LEFT3 | + | − | + | − | not moving | \| | continuously until |
| LEFT4 | + | − | + | − | contracts | \| | reaching the position |
| Zero | + | + | + | + | holds the position | | |
| Right1 | + | − | + | − | not moving | | |
| Right2 | + | − | + | − | extends | | |
| Right3 | − | + | − | + | not moving | | |
| Right4 | − | + | − | + | contracts | | |

Referring now generally to the Figures and particularly to FIG. 2, FIG. 2 is a second line drawing of the invented actuator device of FIG. 1.

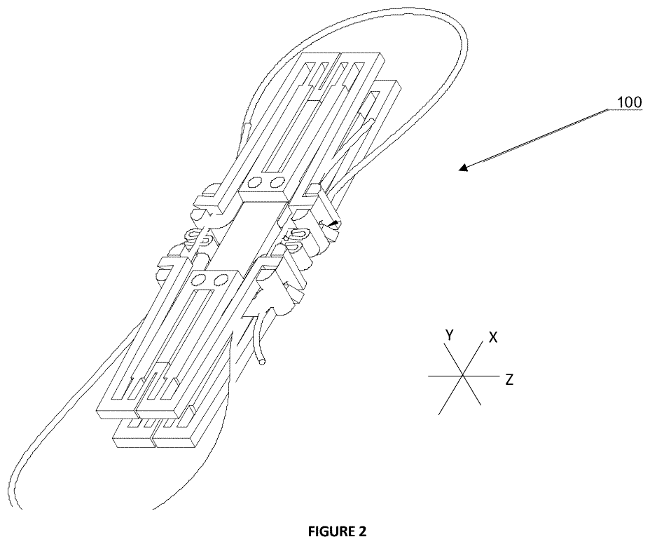

Referring now generally to the Figures and particularly to FIG. 3, FIG. 3 is a third line drawing of the invented actuator device of FIG. 1.

Referring now generally to the Figures and particularly to FIG. 4, FIG. 4 is a 3D model of the invented actuator device of FIG. 1A, no longer presenting the first tendon 118 and the second tendon 120. All of the elements mentioned previously are also labeled here for reference between FIG. 1A and this Figure, namely the first device 100 comprising the piezoelectric stack 102; the set of clamping elements 104-114 comprising the first upper inner clamp element 104A, the second upper inner clamp element 106A the first lower inner clamp element 104B, the second lower inner clamp element 106B, the first outer clamp element 108, the second outer clamp element 110, the third outer clamp element 112, the fourth outer clamp element 114; and the frame 116. In FIG. 4, the X-axis as shown indicates the length dimension of the first device 100; the Y axis indicates the height dimension of the first device 100; and the Z-axis indicates the width dimension of the first device 100. The first device 100 as shown here may be built to be any size considered feasible and appropriate for desired application. The width of the first device 100 may be in the range of from less than one inch to over twelve inches; the length of the first device 100 may be in the range of from less than one inch to over twelve inches; and the height of the first device 100 may be in the range of from less than one inch to over twelve inches.

Referring now generally to the Figures and particularly to FIG. 5, FIG. 5 is a 3D model providing a view of the invented actuator device of FIG. 4 from an additional angle.

Referring now generally to the Figures and particularly to FIG. 6, FIG. 6 is a 3D model of the invented actuator device of FIG. 1A in a partially-assembled state with the clamp elements partially removed to show other elements. Particularly, the piezoelectric stack 102, the first outer clamp element 108, the second outer clamp element 110, the third outer clamp element 112, the fourth outer clamp element 114, and the frame 116 are present, and the first upper inner clamp element 104A, the second upper inner clamp element 106A the first lower inner clamp element 104B, the second lower inner clamp element 106B are omitted from this image to more clearly present other elements of the assembly such as the shape of the frame 116.

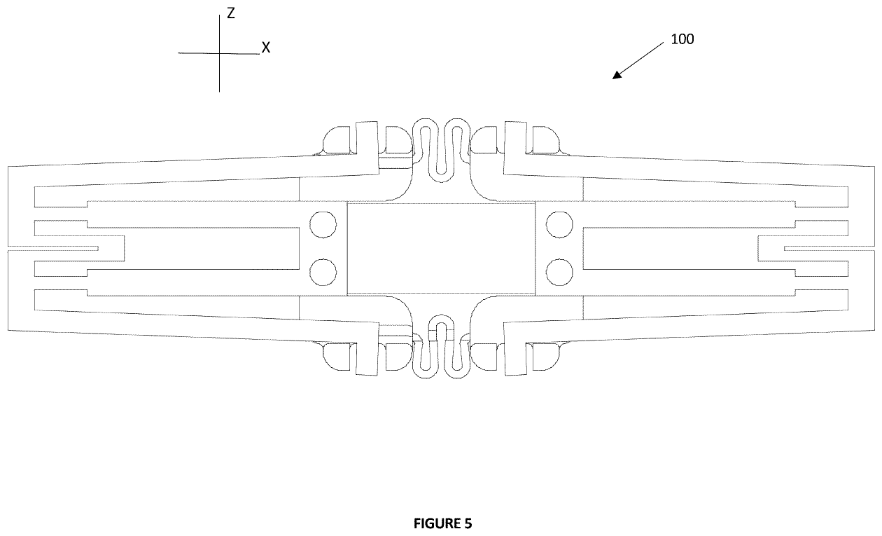

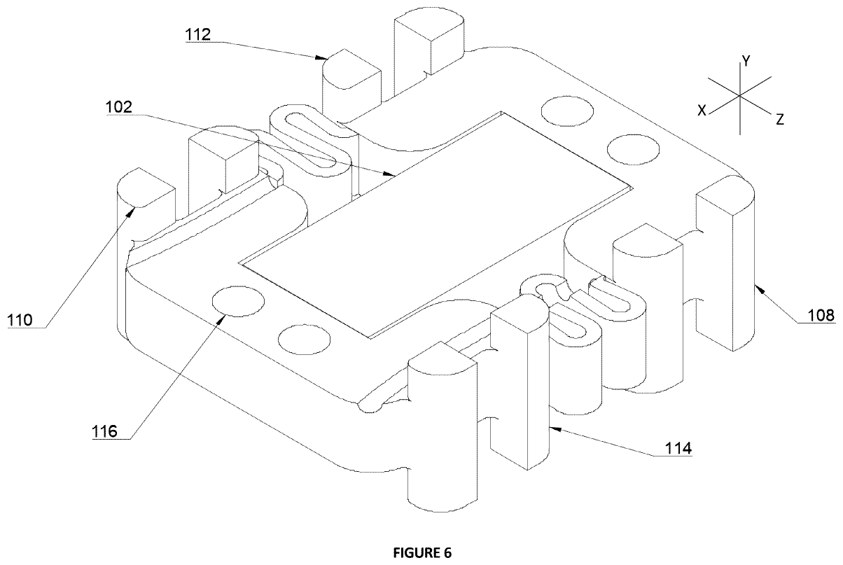

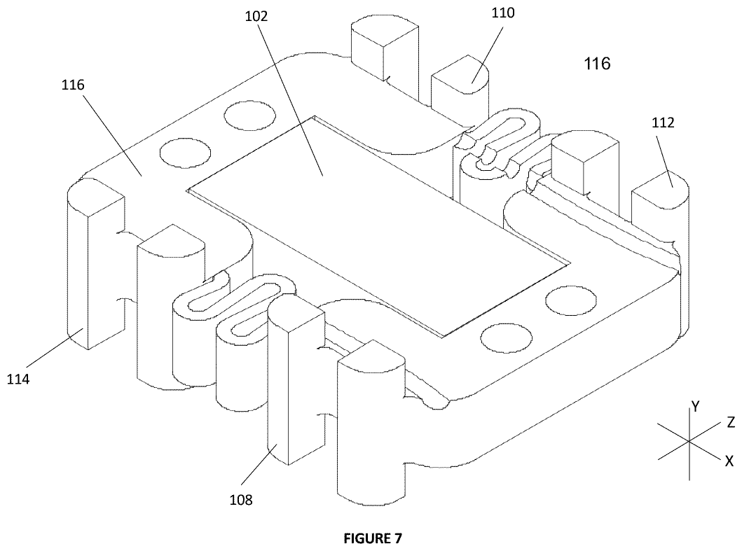

Referring now generally to the Figures and particularly to FIG. 7, FIG. 7 is a 3D model providing a view of the partially-assembled invented actuator device of FIG. 6 from an additional angle.

Referring now generally to the Figures and particularly to FIG. 8, FIG. 8 is a 3D model providing a view of the first embodiment of the invented device in the partially-assembled state of FIG. 6 as viewed from a third additional angle.

Referring now generally to the Figures and particularly to FIG. 9, FIG. 9 is a 3D model of the frame 116 of the first embodiment of the invented device.

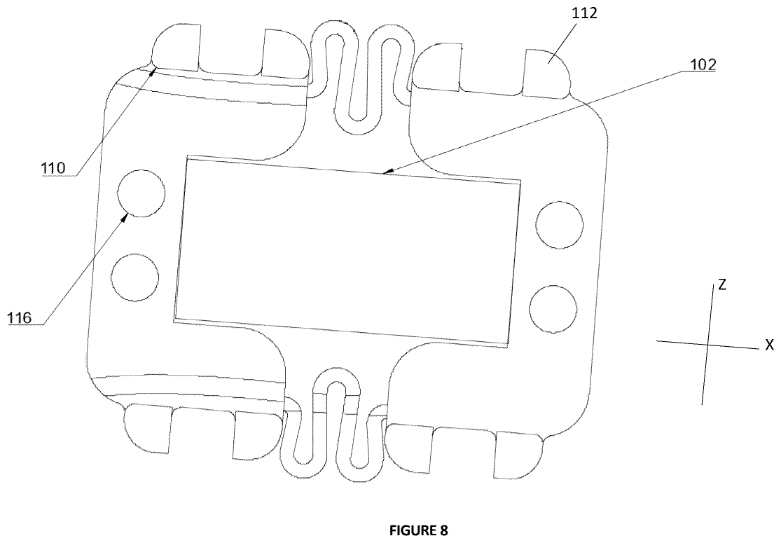

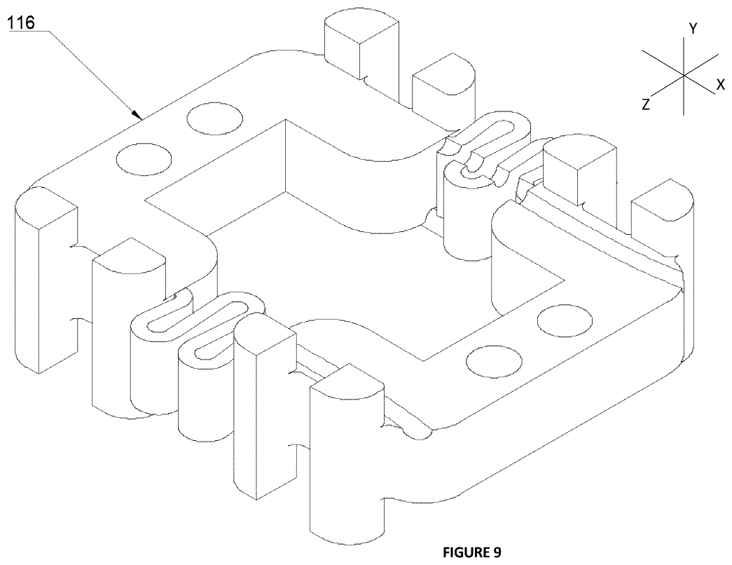

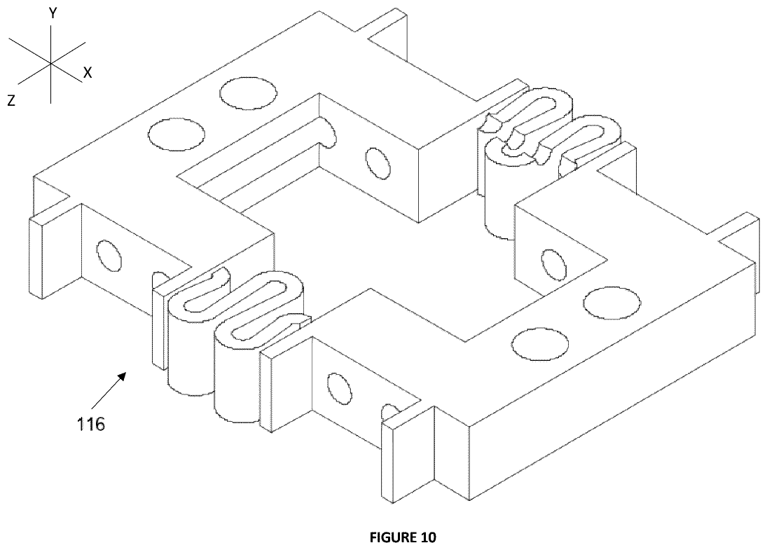

Referring now generally to the Figures and particularly to FIG. 10, FIG. 10 is the 3D model of the frame 116 of FIG. 9 at a different angle.

Referring now generally to the Figures and particularly to FIG. 11, FIG. 11 is the 3D model of the frame 116 of FIG. 9 at an additional different angle.

Referring now generally to the Figures and particularly to FIG. 12, FIG. 12 is a 3D model of the first embodiment of the invented device of FIG. 4 in a partially-assembled state, including the piezoelectric stack 102, the first upper inner clamp element 104A, the second upper inner clamp element 106A the first lower inner clamp element 104B, and the second lower inner clamp element 106B. The first outer clamp element 108, the second outer clamp element 110, the third outer clamp element 112, the fourth outer clamp element 114, and the frame 116 are omitted to present the shown elements more clearly, including how the first upper inner clamp element 104A, the second upper inner clamp element 106A the first lower inner clamp element 104B, and the second lower inner clamp element 106B are fitted close to the piezoelectric stack 102 such that expansion of the volume of the piezoelectric stack 102 would push on the first upper inner clamp element 104A, the second upper inner clamp element 106A the first lower inner clamp element 104B, and the second lower inner clamp element 106B, causing these in turn to push outward.

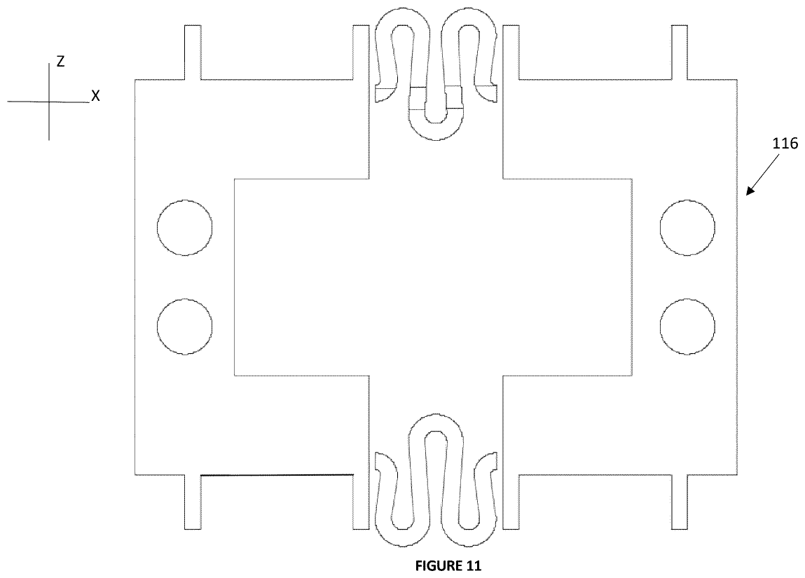

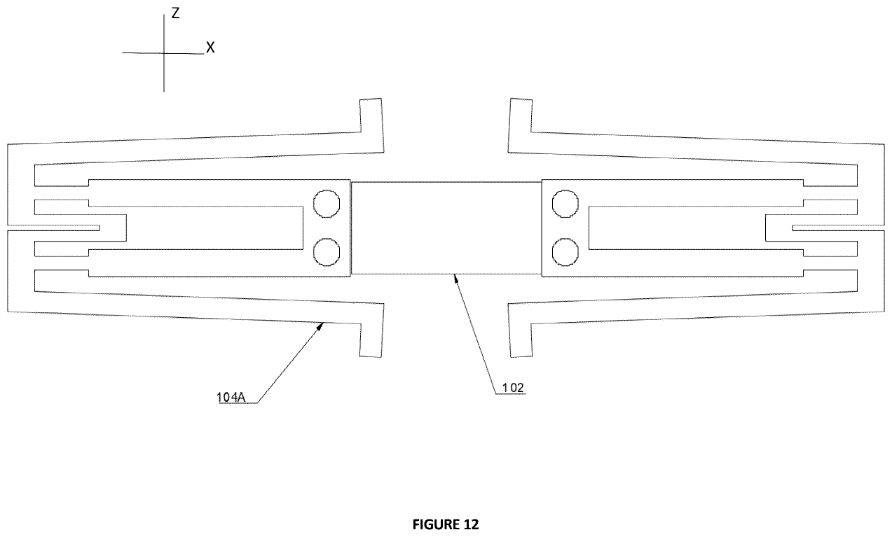

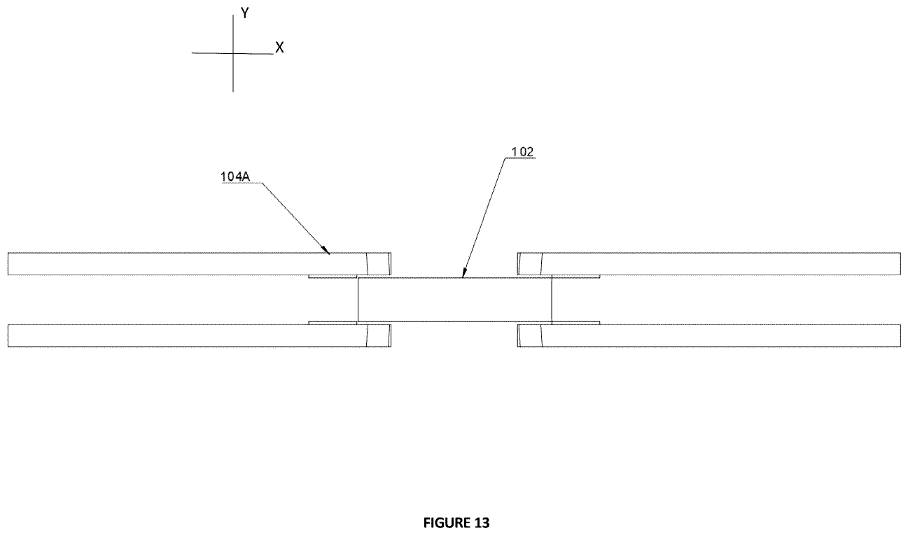

Referring now generally to the Figures and particularly to FIG. 13, FIG. 13 is a 3D model providing a view of the first embodiment of the invented device in the partially-assembled state of FIG. 12 as viewed from an additional angle.

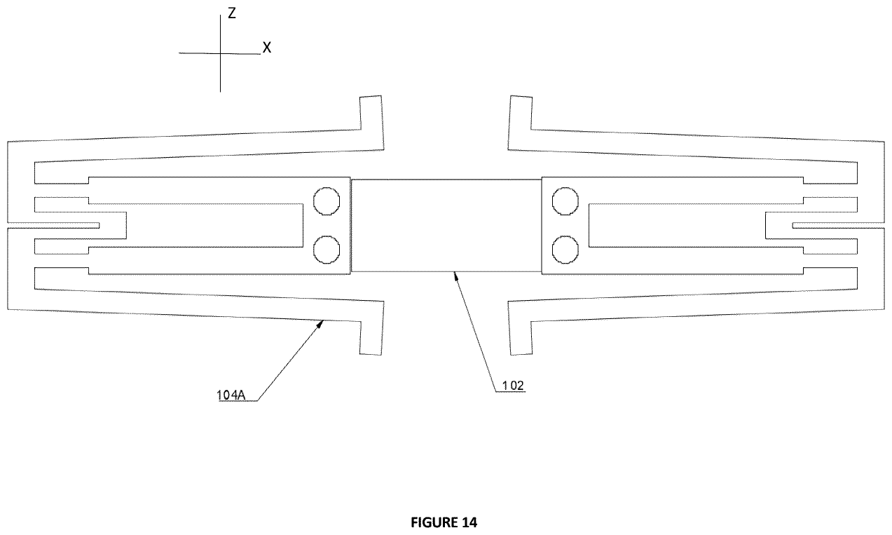

Referring now generally to the Figures and particularly to FIG. 14, FIG. 14 is a 3D model providing a view of the first embodiment of the invented device in the partially-assembled state of FIG. 12 as viewed from a second additional angle.

Referring now generally to the Figures and particularly to FIG. 15, FIG. 15 is a 3D model of an inner clamp element of FIG. 4 such as the first upper inner clamp element 104A, the second upper inner clamp element 106A the first lower inner clamp element 104B, or the second lower inner clamp element 106B, presented separately to show the shape of this element. It is noted that, in preferred embodiments, the first upper inner clamp element 104A, the second upper inner clamp element 106A the first lower inner clamp element 104B, and the second lower inner clamp element 106B are duplicates of the same component, and the only distinction between these may be their positioning on the device. It is further noted that, while this may be a convenient approach if all four elements are intended to perform the same task in different positions, this is not a compulsory limitation and an embodiment wherein like elements of the device 100 may not be completely or even remotely identical might provide some further benefit if this seems appropriate to one skilled in the art who may be making an embodiment of the device.

Referring now generally to the Figures and particularly to FIG. 16, FIG. 16 is a line drawing of the frame 116 of FIG. 9 coupled together with the first outer clamp element 108, the fourth outer clamp element 114, and the third outer clamp element 112, with the second outer clamp element 110 uncoupled from the frame 116 to present this element in isolation.

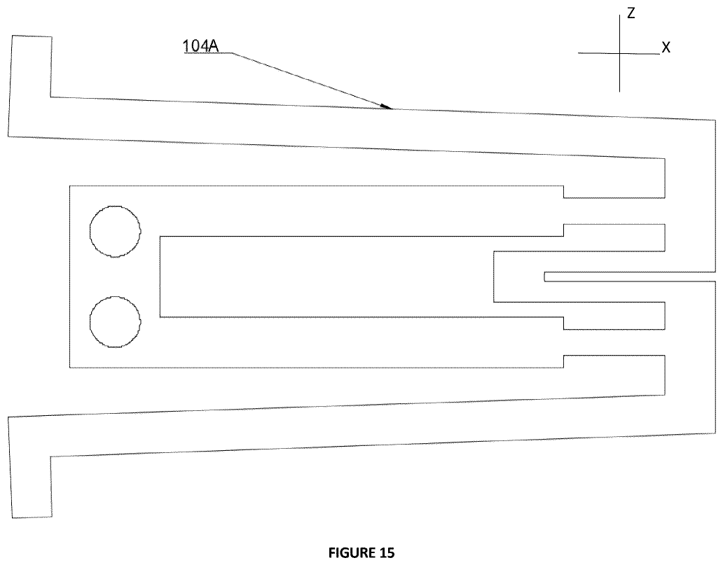

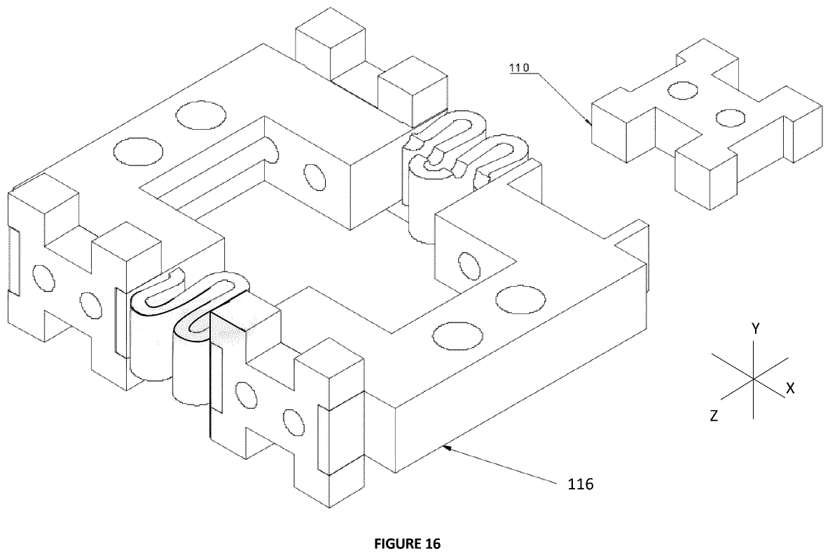

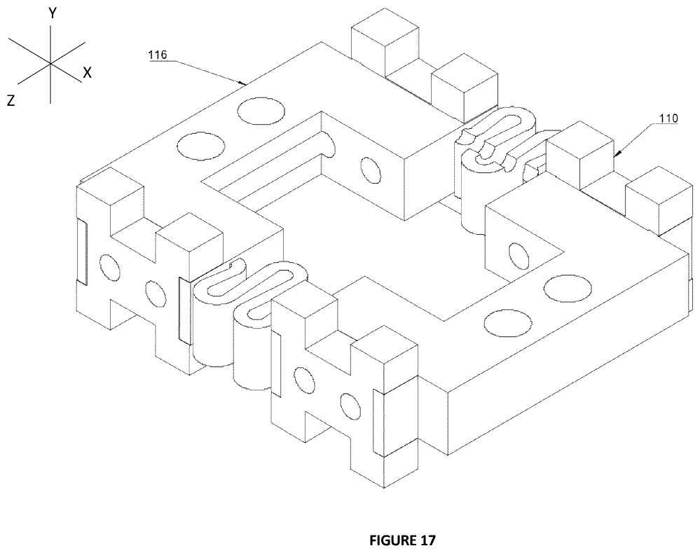

Referring now generally to the Figures and particularly to FIG. 17, FIG. 17 is a line drawing of the frame element of FIG. 17 coupled together with the first outer clamp element 108, the second outer clamp element 110, and the third outer clamp element 112, and the fourth outer clamp element 114.

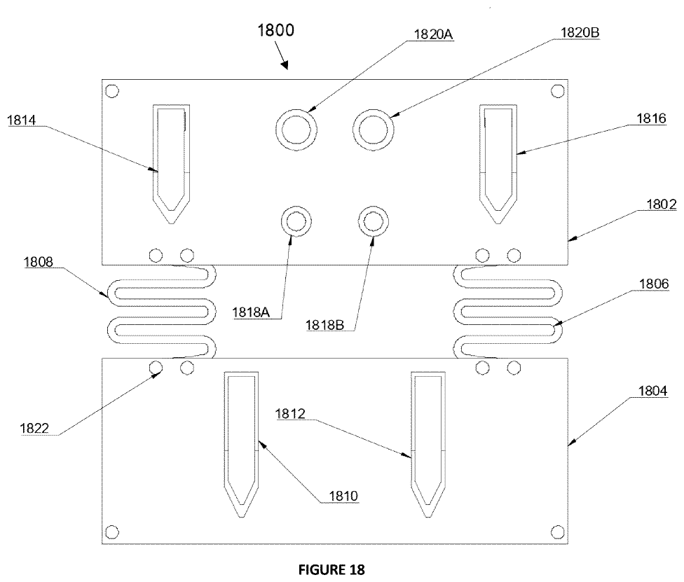

Referring now generally to the Figures and particularly to FIG. 18, FIG. 18 is a line drawing presenting a prototype device 1800 representing a second embodiment of the invention. It is understood that size is not a limitation of the invention, and any measurement presented herein is solely for the purposes of clear disclosure by concrete example. Particularly, it is noted that a device this small and lightweight that can propel itself without the use of wheels or similar is relatively novel, and the possible applications myriad. One apparent application may be controlled locomotion into tight spaces, such as behind or underneath heavy furniture that would otherwise have to be physically moved in order to inspect a wall or fixture; a camera or other sensor on the device may allow for any necessary inspection to be done remotely. The device 1800 as pictured here includes a front end 1802, a rear end 1804, a right spring 1806, a left spring 1808, a left rear leg 1810, a right rear leg 1812, a left front leg 1814, a right front leg 1816, a first button 1818A, a second button 1818B, a first sensor 1820A, and a camera 1820B. It is noted that placement, quantity, or variety of sensors, cameras, and controls such as buttons may differ or vary as preferred. The device 1800 further includes a plurality of bolts 1822 coupling components of the device 1800 securely together; it is additionally noted that a means other than bolting could be used to accomplish this, and that if bolting is preferred, the bolts or screws used may be of any suitable variety as known in the art. In this image, the front left leg 1814 is in a retracted position, the front right leg 1816 is in a retracted position, the left rear leg 1810 is in an extended position, and the right rear leg 1812 is in an extended position.

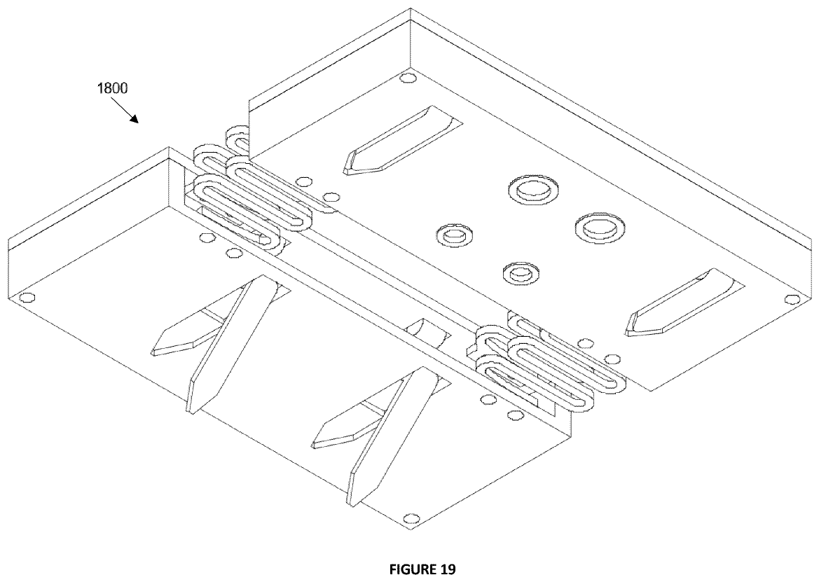

Referring now generally to the Figures and particularly to FIG. 19, FIG. 19 is a second line drawing presenting an additional view of the device of FIG. 18.

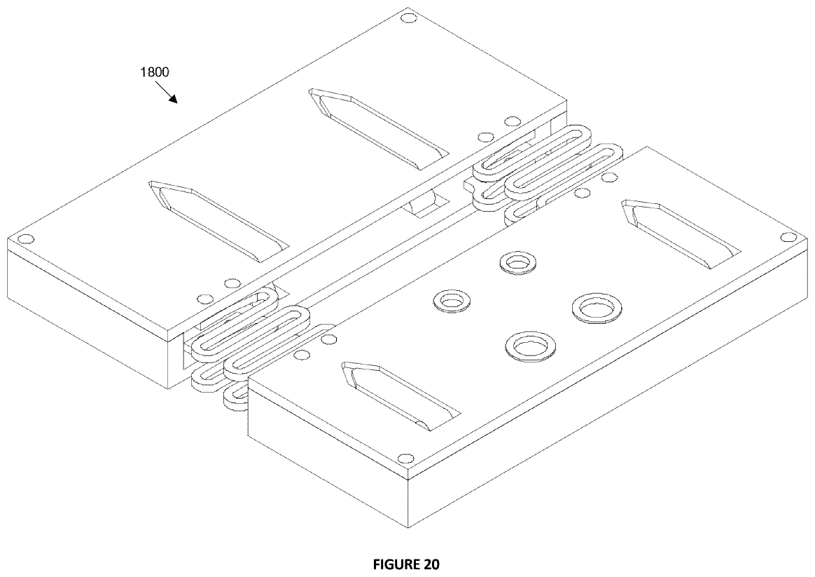

Referring now generally to the Figures and particularly to FIG. 20, FIG. 20 is a third line drawing presenting an additional view of the device of FIG. 18.

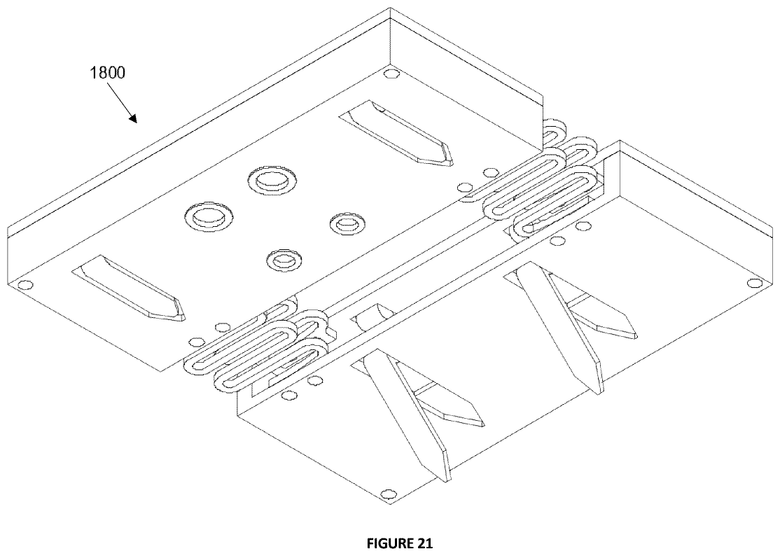

Referring now generally to the Figures and particularly to FIG. 21, FIG. 21 is a fourth line drawing presenting an additional view of the device of FIG. 18.

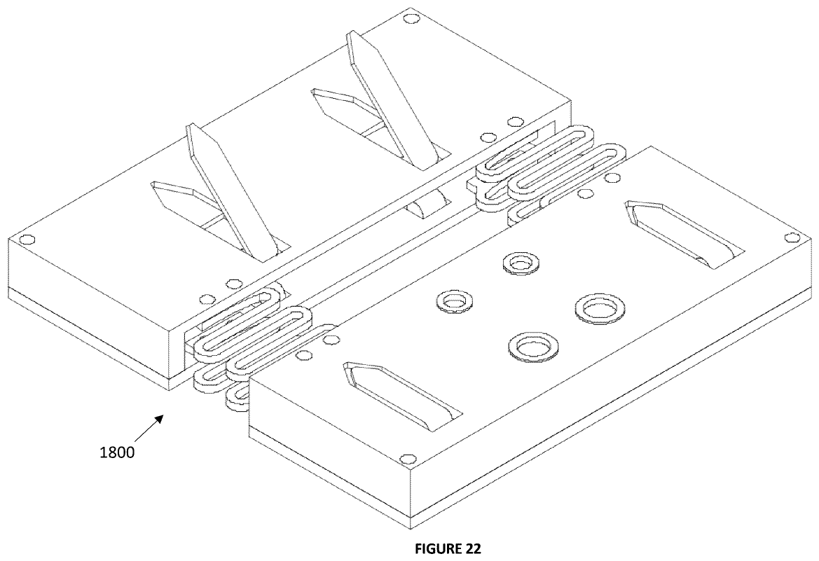

Referring now generally to the Figures and particularly to FIG. 22, FIG. 22 is a fifth line drawing presenting an additional view of the device of FIG. 18.

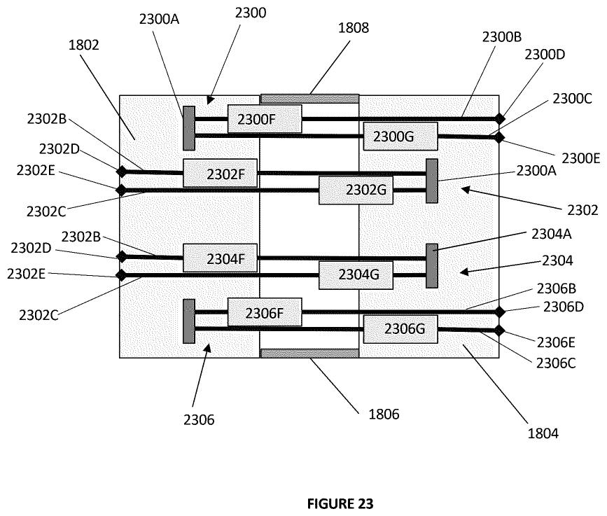

Referring now generally to the Figures and particularly to FIG. 23, FIG. 23 is a line diagram representation of the tendon structure of the second embodiment of FIG. 18, presenting key internal elements that power the front left leg 1814, the front right leg 1816, the left rear leg 1810, and the right rear leg 1812 to extend and retract. This drawing represents the front end 1802, the rear end 1804, the left spring 1806, the right spring 1808, and further diagrams a set of four tendon assemblies 2300-2306, namely a first tendon assembly 2300, a second tendon assembly 2302, a third tendon assembly 2304, and a fourth tendon assembly 2306, each of these controlling the movement of a leg 1810-14 as selected from the front left leg 1814, the front right leg 1816, the left rear leg 1810, and the right rear leg 1812. The first tendon assembly 2300 comprises a first roller 2300A, a first up string 2300B, a first down string 2300C, a first up anchor point 2300D, a first down anchor point 2300D, a first up actuator 2300F, and a first down actuator 2300G. The first roller 2300A is directly coupled to the front right leg 1816 and rotatably to the front end 1802, such that when the first roller 2300A is rolled in one direction, the front right leg 1816 extends, and when the first roller 2300A is rolled in an opposite direction, the front right leg 1816 retracts. The first up string 2300B is coupled to the first roller 2300A at a first end of the first up string 2300B, and anchored at the first up anchor point 2300C, such that the first up string 2300B can be put under tension between the first roller 2300A and first up anchor point 2300C, and such that when the first up string 2300B exerts force on the first roller 2300A, such as by the first up string 2300B having been pulled in the direction of the first up anchor point 2300C, the first roller 2300A is rotated such that the front right leg 1816 retracts (or is pulled ‘up’, hence ‘up string’ as differentiating terminology). The first up actuator 2300F can be controlled to pull on the first up string 2300B and increase the tension of the first up string 2300B; certain of the actuator varieties mentioned herein and disclosed in some of Applicant's previous patents incorporated herein by reference might be ideal for this implementation. Similarly, the first down string 2300C is coupled to the first roller 2300A and at the first down anchor point 2300E, and the first down actuator 2300G is positioned to pull on the first down string 2300C, increase the tension of the first down string 2300C between the first down anchor point 2300E and the first roller 2300A, causing the first roller 2300A to roll in a direction opposite to that of the first up string 2300B, thus causing the front right leg 1816 to retract. It is noted that, if there is an actuator device that is capable of simultaneously controlling both strings as required to perform the functions of extending and retracting the front right leg 1816, the first up actuator 2300F and the first down actuator 2300G might be combined as a single actuator. Regardless, the number and complexity of mechanisms required to implement this effect is notably modest. Similarly, the second tendon assembly 2302 consists of a second roller 2302A, a second up string 2302B, a second down string 2302C, a second up anchor point 2302D, a second down anchor point 2302E, a second up actuator 2302F, and a second down actuator 2302G, and controls the extension and retraction of the right rear leg 1812 in accordance with the method recited above pertaining to the first tendon assembly 2300. Similarly, the third tendon assembly 2304 consists of a third roller 2304A, a third up string 2304B, a third down string 2304C, a third up anchor point 2304D, a third down anchor point 2304E, a third up actuator 2304F, and a third down actuator 2304G, and controls the extension and retraction of the left rear leg 1810 in accordance with the method recited above pertaining to the first tendon assembly 2300. Similarly, the fourth tendon assembly 2306 consists of a fourth roller 2306A, a fourth up string 2306B, a fourth down string 2306C, a fourth up anchor point 2306D, a fourth down anchor point 2306E, a fourth up actuator 2306F, and a fourth down actuator 2306G, and controls the extension and retraction of the left front leg 1814 in accordance with the method recited above pertaining to the first tendon assembly 2300.

Referring now generally to the Figures and particularly to FIG. 24A, FIG. 24A is a first line diagram visually presenting the method recited above, wherein the first tendon assembly 2300 operates the right front leg 1816. This diagram presents the right front leg 1816 in a retracted position.

Referring now generally to the Figures and particularly to FIG. 24B, FIG. 24B is a second line diagram visually presenting the method recited above, wherein the first tendon assembly 2300 operates the right front leg 1816. This diagram presents the right front leg 1816 in an extended position.

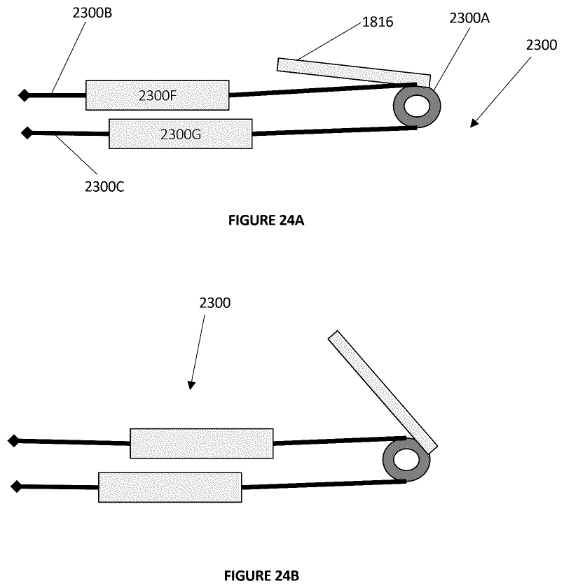

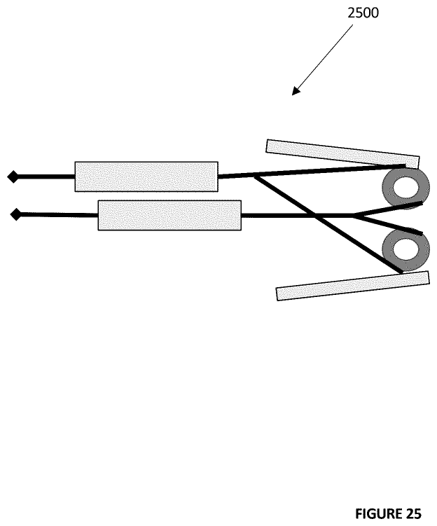

Referring now generally to the Figures and particularly to FIG. 25, FIG. 25 is a line diagram of a two-foot assembly 2500 which is similar to those of FIGS. 24A and 24B, showing how the same two actuators of a single tendon assembly 2300-2306 of FIGS. 23, 24A, and 24B may be further utilized to pull on additional strings and thus operate two legs instead of just one. It is noted that this may be a suitable implementation in an application where the two legs controlled by the same tendon assembly 2300-2306 may constructively move in tandem and need not move independently of each other.

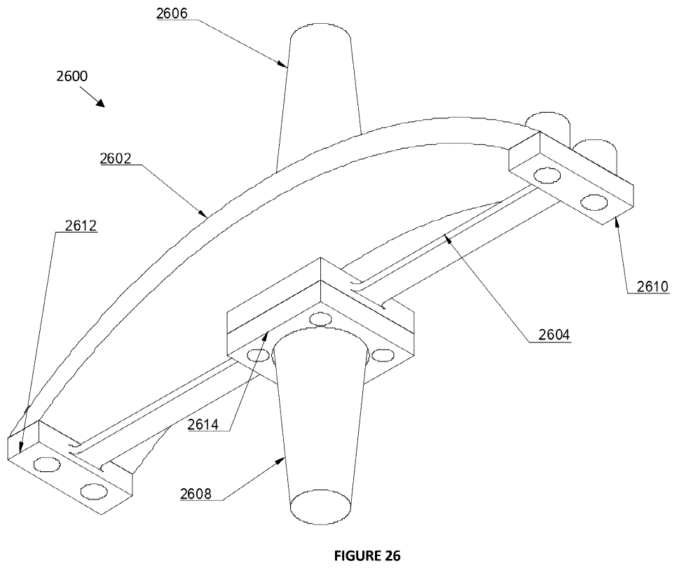

Referring now generally to the Figures and particularly to FIG. 26, FIG. 26 is a line drawing presenting a first invented mechanical joint 2600 (“the first joint 2600”) with one degree of motion belonging to a third embodiment of the invention. The first joint 2600 comprises at least a rigid arc 2602, a string element 2604, a bow side 2606, a non-bow side 2608, a first fastening point 2610, a second fastening point 2612, and a middle fastening point 2614. As subsequent Figures will make clear, the first joint 2600 comprises a flexible coupling of the bow side 2606 to the non-bow side 2608, similar to how one's elbow is a flexible coupling of one's upper arm (humerus) to one's lower arm (radius and ulna). Other elements may be further coupled onto the bow side 2606 or non-bow side 2608 elements shown, but in this image, these are represented minimally. The string element 2604 is coupled at either end to either end of the rigid arc, namely the first fastening point 2610 and the second fastening point 2612. A point at the middle of the string element 2604, namely the middle fastening point 2614, is fastened in turn to the non-bow side 2608. This fastening is, in this instance, done with small bolts; other means of fastening are possible, obvious, and may be preferred in other assemblies. The first joint 2600 as shown here may be built to be any size considered feasible and appropriate for desired application. The width of the first joint 2600 may be in the range of from less than one inch to over twelve inches; the height of the first joint 2600 may be in the range of from less than one inch to over twelve inches; and the depth of the first joint 2600 may be in the range of from less than one inch to over twelve inches.

Referring now generally to the Figures and particularly to FIG. 27, FIG. 27 is a line drawing presenting the mechanical joint of FIG. 26 in a rotated position. The non-bow side 2608 is permitted to rotate, twisting the string element 2604, but is only mechanically capable of rotating in one dimension, namely in line with the bow side 2606, and could not rotate very far sideways, out toward the first fastening point 2612 or the second fastening point 2614. Thus, the first joint 2600 is mechanically adapted for facilitating articulated motion within a specified degree of freedom but not others.

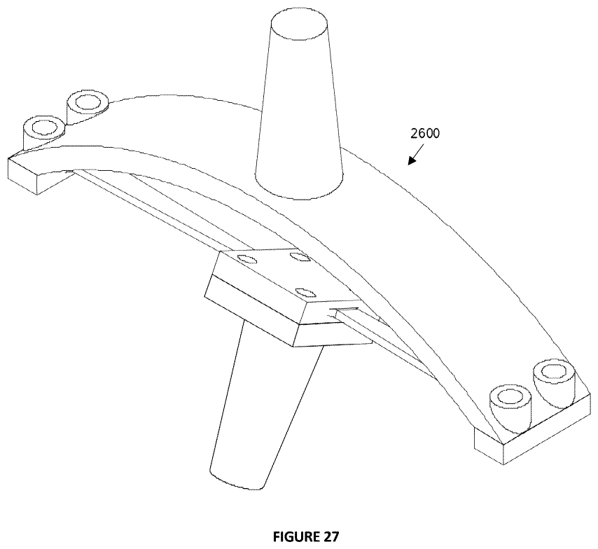

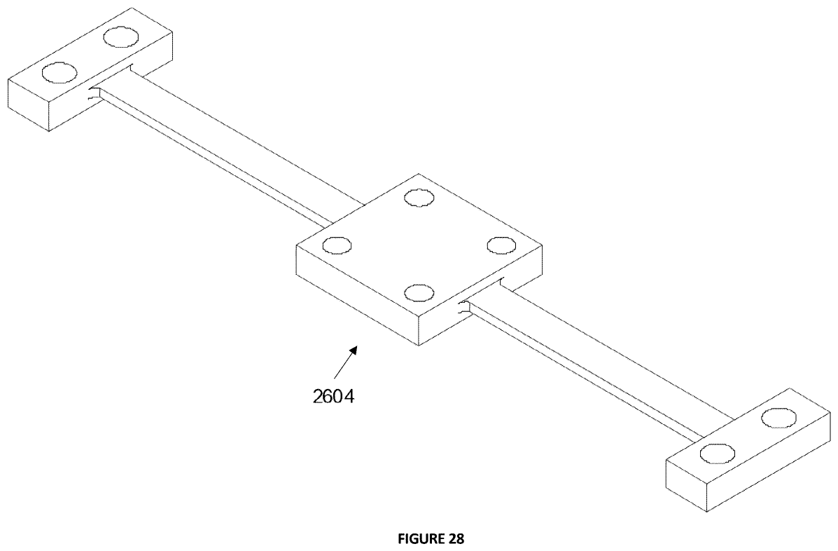

Referring now generally to the Figures and particularly to FIG. 28, FIG. 28 is a 3D model presenting the string element 2604 of the mechanical joint of FIG. 26 in a perspective view.

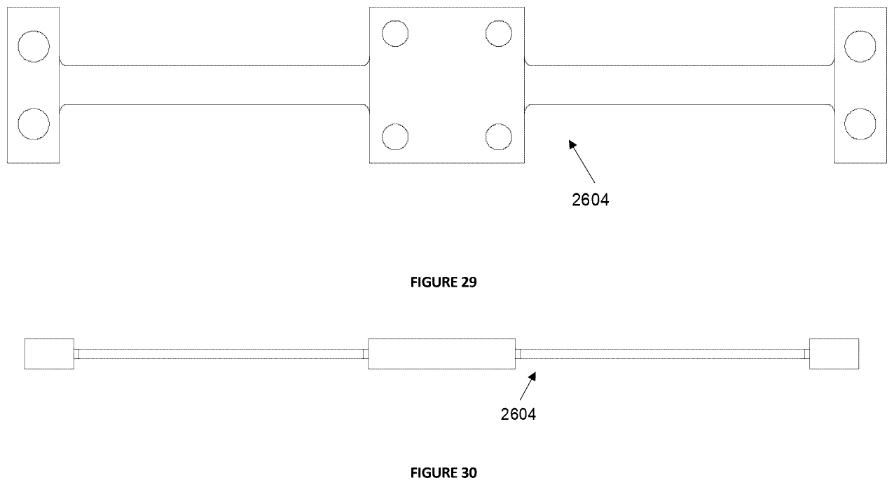

Referring now generally to the Figures and particularly to FIG. 29, FIG. 29 is a 3D model presenting the string element 2604 of FIG. 28 in a top view.

Referring now generally to the Figures and particularly to FIG. 30, FIG. 30 is a 3D model presenting the string component of FIG. 28 in a side view.

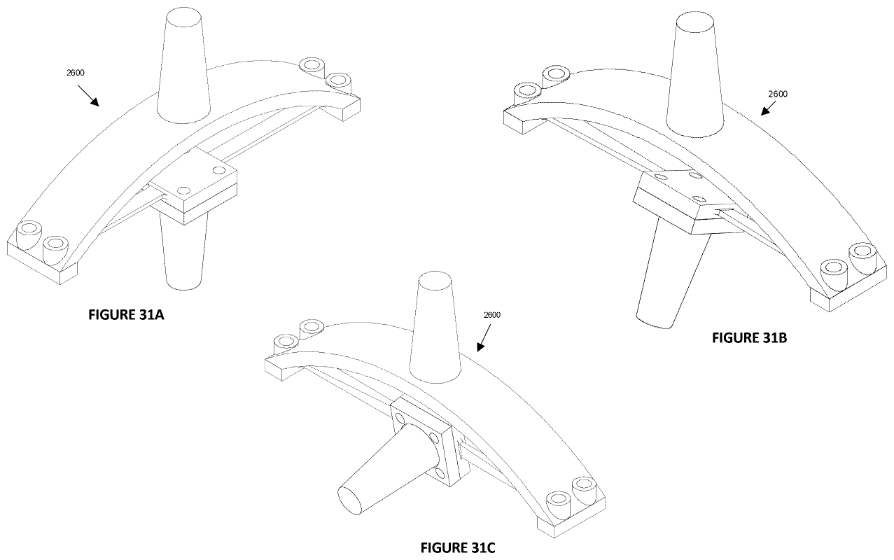

Referring now generally to the Figures and particularly to FIG. 31A, FIG. 31A is a line drawing presenting the mechanical joint of FIG. 26 in a partially-bent position.

Referring now generally to the Figures and particularly to FIG. 31B, FIG. 31B is a line drawing presenting the mechanical joint of FIG. 26 bent to approximately a 90 degree angle.

Referring now generally to the Figures and particularly to FIG. 31C, FIG. 31C is a line drawing presenting the mechanical joint of FIG. 26 in an unbent position.

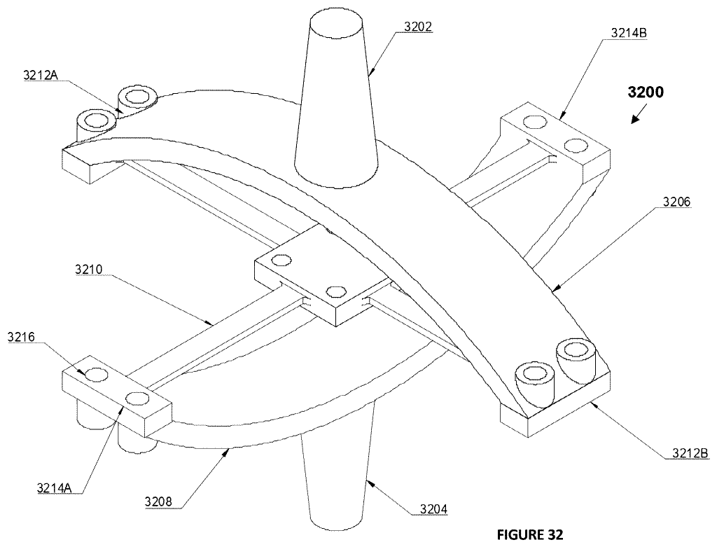

Referring now generally to the Figures and particularly to FIG. 32, FIG. 32 is a line drawing presenting a second mechanical joint 3200 (“the second joint 3200”) having two degrees of motion, belonging to the third embodiment of the invention. The second joint 3200 comprises a first arc side 3202, a second arc side 3204, a first rigid arc 3206, a second rigid arc 3208, a four-way string element 3210, a first arc first fastening point 3212A, a first arc second fastening point 3212B, a second arc first fastening point 3214A, a second arc second fastening point 3214B, and a plurality of fastening means 3216, bolts in this instance, providing fastening at the above-mentioned fastening points. The positioning of the first rigid arc 3206, the second rigid arc 3208, and the four-way string element 3210 permits the second joint 3200 two degrees of freedom of motion, instead of the one degree of motion of the first joint 2600.

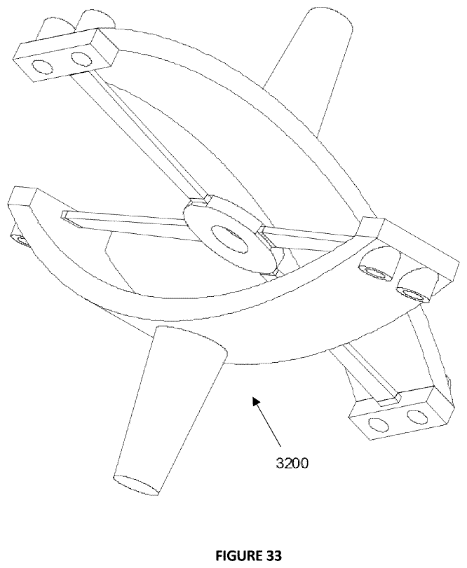

Referring now generally to the Figures and particularly to FIG. 33, FIG. 33 is a line drawing presenting an additional view of the second mechanical joint of FIG. 32.

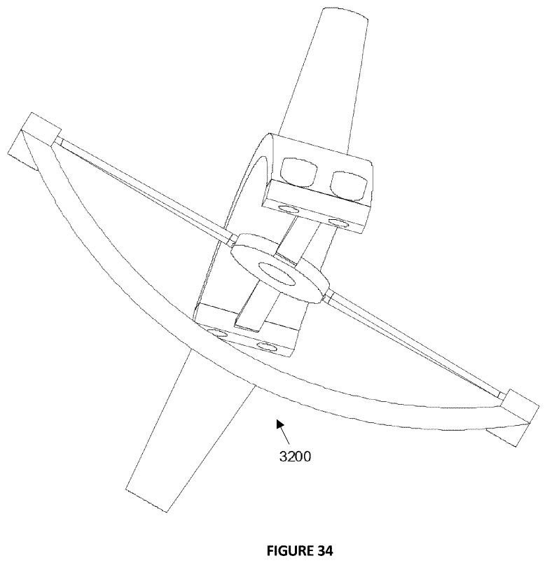

Referring now generally to the Figures and particularly to FIG. 34, FIG. 34 is a line drawing presenting an additional view of the second joint 3200 of FIG. 32, bended into a position demonstrating the flexibility of the second joint 3200.

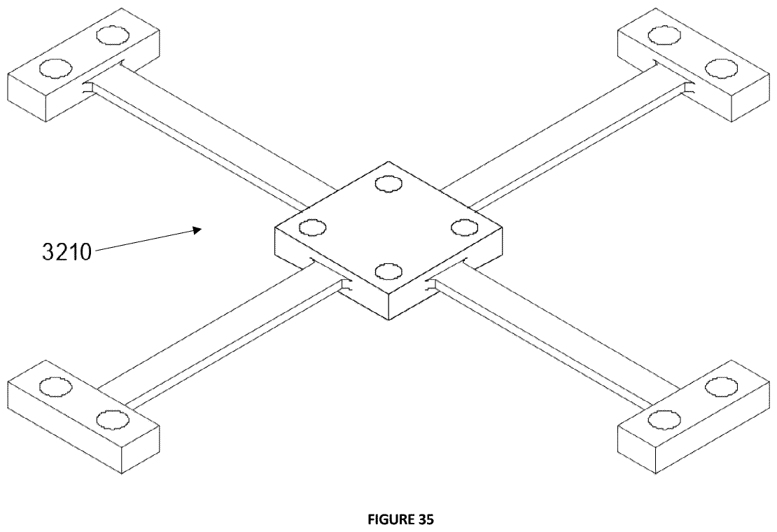

Referring now generally to the Figures and particularly to FIG. 35, FIG. 35 is a 3D model presenting a perspective view of the four-way string element 3210 of the second joint 3200 of FIG. 32.

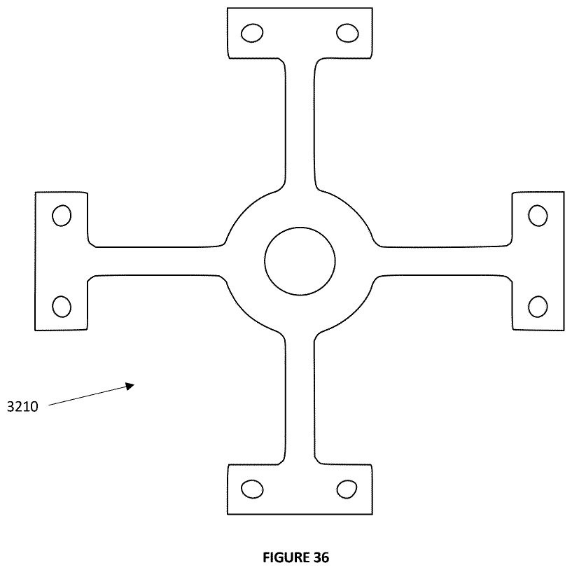

Referring now generally to the Figures and particularly to FIG. 36, FIG. 36 is a 3D model presenting a top view of the four-way string element 3210 of FIG. 35.

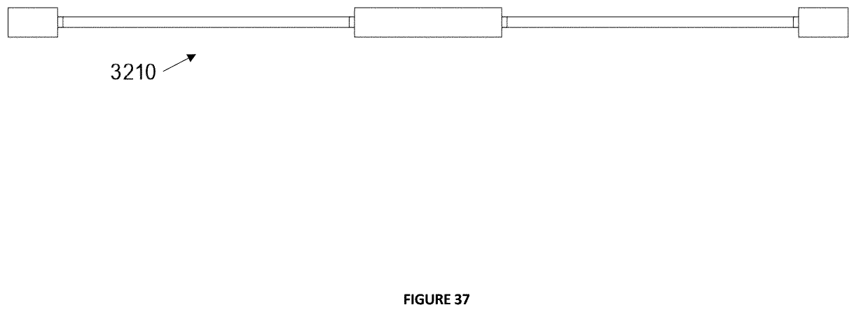

Referring now generally to the Figures and particularly to FIG. 37, FIG. 37 is a 3D model presenting a side view of the four-way string element 3210 of FIG. 35.

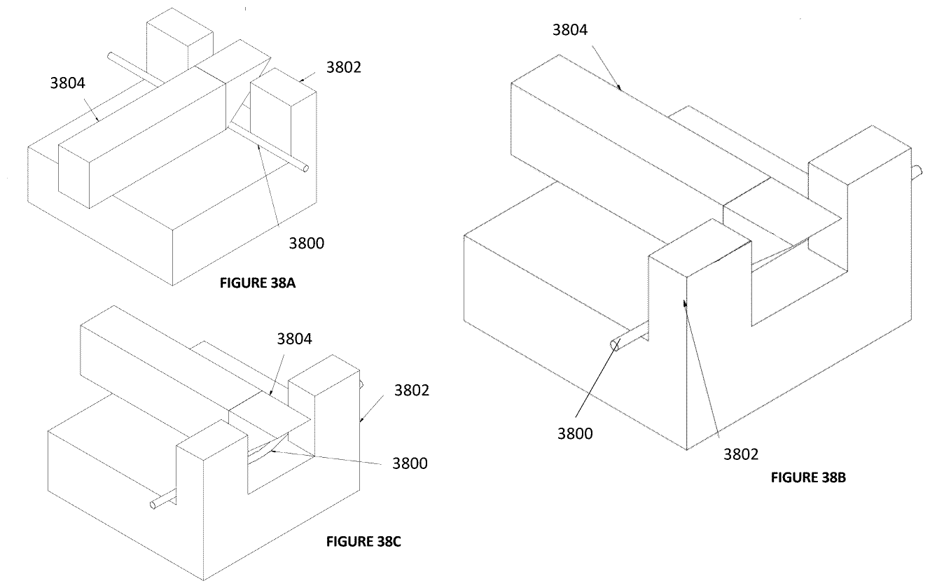

Referring now generally to the Figures and particularly to FIG. 38A, FIG. 38A is a first 3D model view of a beak feature for potential use in clamping assemblies of various embodiments such as but not limited to the invented actuator device of FIG. 1. This image presents a side view of a tendon 3800 being gripped by a U-shaped clamp piece 3802 and a beak element 3804, such that the beak element 3804 pushes the flexible tendon 3800 into the gap formed by the U-shaped clamp piece 3802, and bends the tendon 3800 around the front of the beak element 3802.

This structural adaptation is considered to be a possible feature for inclusion in any embodiments of the invention as discussed herein that may improve efficiency and grip wherever clamping is required. The beak element 3804 is pushed outward toward the U-shaped clamp piece 3802, or the U-shaped-clamp piece 3802 is pulled inward toward the beak element 3804, and the tendon 3800 is forced towards the open gap between the vertical portions of the U-shaped clamp piece 3802. The movement of the beak element 3804 may bend the tendon 3800 around the shape of the beak element 3804, as shown in FIG. 38C. The tendon 3800 is pressed between the beak element 3804 and the sides of the U-shaped clamp piece 3802, so the edges of the U-shaped clamp piece 3802 and the beak element 3804 hold the string tightly and with a desirable friction. This is preferred because the U-shaped clamp piece 3802 and the beak element 3804 hold the tendon 3800 in the right position, provide significant friction when needed but have almost no friction when the beak element 3804 is displaced from that position, allowing the tendon 3800 to move smoothly when the tendon 3800 should move, but be securely and efficiently held in place when the tendon 3800 should not move. It is understood that, while a single instance of this assembly is pictured here, an H-shaped clamp piece as shown in other Figures might be preferred for providing a tandem assembly that could hold onto two tendons instead of one.

Referring now generally to the Figures and particularly to FIG. 38B, FIG. 38B is a second 3D model view of a beak feature for potential use in clamping assemblies of various embodiments such as but not limited to the invented actuator device of FIG. 1. This image presents a top view of the tendon 3800 being gripped by the U-shaped clamp piece 3802 and the beak element 3804, such that the beak element 3804 pushes the flexible tendon 3800 into the gap formed by the U-shaped clamp piece 3802, and bends the tendon 3800 around the front of the beak element 3802. This structural adaptation is considered to be a possible feature for inclusion in any embodiments of the invention as discussed herein that may improve efficiency and grip wherever clamping is required by providing additional friction. It is noted that the clamping elements 104-114 of FIG. 1A may usefully employ this beak element 3804 as a feature, and that the H-shaped outer clamping elements 108-114 of FIG. 1A may each be considered a combination of two U-shaped clamp pieces 3802 for the purposes of applying this concept.

It is noted that usage of the beak element 3804 in this capacity requires a level of displacement atypical for most PZT stacks (such as the PZT stack 102), and that this concern is addressed herein by mechanical amplification of the displacement of the PZT stack 102 through leverage. The leaned surface of the beak element 3804 can be concave or convex. The edges of the beak element 3804 might be chamfered. The beak element 3804 may be sharp or blunt, and it is noted that sharp edges of the U-shaped clamp piece 3802 into which the beak element 3804 fits may be preferred, because this may provide sharp corners for increased friction against a clamped tendon. The beak element 3804 is preferably made of metal such as hardened steel, or similar material and is preferably durable, as this element is providing friction to hold other elements in place and may be supporting weight (depending upon the application). It is noted that a non-durable beak element 3804 (such as a plastic one) might be used temporarily (such as for a demonstration of a prototype), but probably wouldn't last very long before getting bent out of shape or otherwise falling apart. It is noted, and the rest of the disclosure will show, how critical it is to the basic function of the invention overall that various clamps are able to reliably and securely grip their respective tendons without slipping or failing. The beak element 3804 feature is mentioned as a way of optimizing these critical clamping mechanisms.

Referring now generally to the Figures and particularly to FIG. 38C, FIG. 38C FIG. 38C is a third 3D model view of a beak feature for potential use in clamping assemblies of various embodiments such as but not limited to the invented actuator device of FIG. 1. This image presents a front view of the tendon 3800 being gripped by the U-shaped clamp piece 3802 and the beak element 3804, such that the beak element 3804 pushes the flexible tendon 3800 into the gap formed by the U-shaped clamp piece 3802, and bends the tendon 3800 around the front of the beak element 3802. This structural adaptation is considered to be a possible feature for inclusion in any embodiments of the invention as discussed herein that may improve efficiency and grip wherever clamping is required.

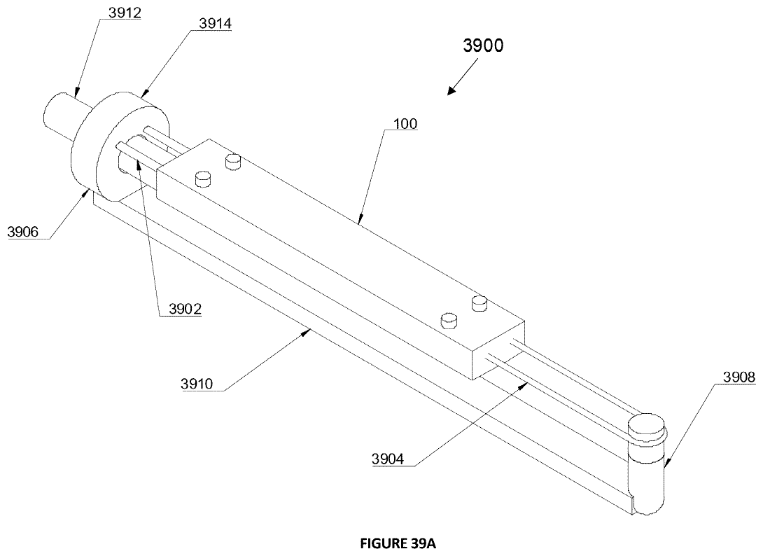

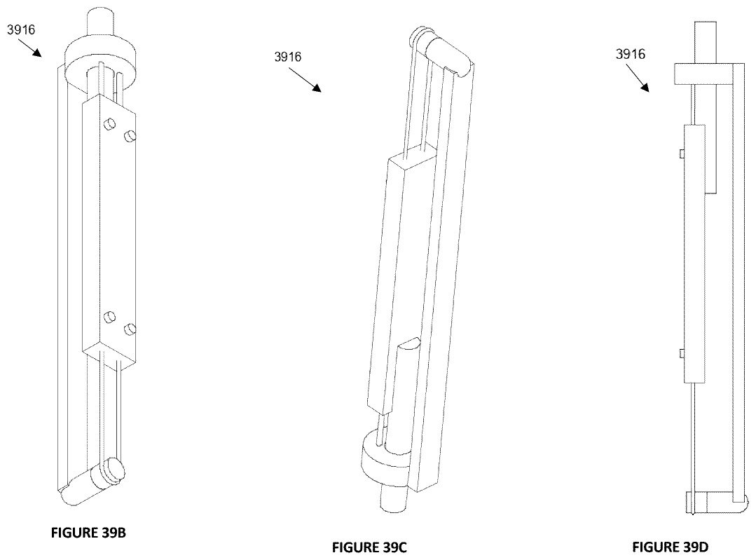

Referring now generally to the Figures and particularly to FIG. 39A, FIG. 39A is a 3D model of a bi-directional servo motor 3900 implementation utilizing an embodiment of the invented actuator device of FIG. 1A or similar embodiment of the invented device as described herein. The bi-directional servo motor 3900 may consist of the invented actuator device 100 connected to a first looped tendon 3902 and a second looped tendon 3904 (“the tendons 3902 & 3904”). It is noted that the invented actuator device 100 is pictured here as just a box, and the tendons 3902 & 3904 as simple lines, with no depiction of clamping mechanisms or other elements such as the piezoelectric stack 102. It is understood that this is a simplified representation of these elements that have already been explicated in more detail elsewhere. The invented actuator device 100, as in other implementations, may be controlled by electrical input (causing the piezoelectric stack 102 to expand, contract, and push on the clamping elements) to adjust its own position or the position or tension of the tendons 3902 & 3904. In this implementation, that functionality enables the invented actuator device 100 to shift its own position between a first end 3906 of the bi-directional servo motor 3900 and a second end 3908 of the bi-directional servo motor 3900 in response to controlled electrical input, along a base 3910 of the bi-directional servo motor 3900. The motion of the invented actuator device 100 may be further controlled by adding of a mechanical guide such as a rail. The bi-directional servo motor 3900 may further include a shaft 3912, and may also include a guide ring 3914 as shown, such that when the invented actuator device 100 shifts toward the first end 3906, the shaft 3912 is extended out beyond the first end 3906; and when the invented actuator device 100 shifts toward the second end 3908, the shaft is retracted. The guide ring 3914 may help to ensure that the extension is consistent and straight. The guide ring 3914 may be further enhanced with friction-reducing elements such as internal ball bearings and/or grease.

One potential application for the invented actuator device as explicated herein is in a bi-directional servo motor implementation, such as might be used in electronic locks and valves, or for remotely opening/closing windows, gates, or doors. While many applications of the invented actuator device are possible, including some yet unanticipated, this is an example of a possibly less-obvious way in which this new technology may be utilized. In the preferred implementation, the invented actuator device 100 is moving along and/or tightening tendons hooked onto two opposite ends of a linear frame possibly including a rail, such that the invented actuator device may move itself between one frame end and the other end, in appearance like a piston, according to control signals. For instance, the invented actuator device may be configured to move ‘up’ when the control signal is ON, and ‘down’ when the control signal is OFF, thus controlling also a lock, door, or other mechanical element connected to the actuating device. It is noted that, while one might consider the first end 3906 and the second end 3908 a practical on/off binary, the positional adjustability between these two extremes would make this mechanism operable as a fader also, rather than only a binary switch. It is noted that the shaft 3912 and guide ring 3914 need not be circular in cross-section.

Referring now generally to the Figures and particularly to FIG. 39B, FIG. 39B is a 3D model of a second bi-directional servo motor 3916 having four clamps (two clamp pairs) instead of the eight clamps of the bi-directional servo motor 3900 of FIG. 39A. It is noted that, in this case, the shaft 3912 itself provides an additional guide to keep the actuator moving in a straight line. It is possible to construct this embodiment utilizing the same elements as the bi-directional servo motor 3900. This model has the advantages of being simpler, cheaper, and more lightweight, and the disadvantage of being slower to operate. With this device only one tendon pair is moving. This means that one tendon pair could be as short as possible or even removed at all. In this case the element is mounted directly to the frame, without tendons, by lowest part of the element.

Referring now generally to the Figures and particularly to FIG. 39C, FIG. 39C is the 3D model of the bi-directional servo motor 3916 of FIG. 39B, presented from a first additional viewing angle.

Referring now generally to the Figures and particularly to FIG. 39D, FIG. 39D is the same 3D model of the bi-directional servo motor 3916 of FIG. 39B, presented from a second additional viewing angle.

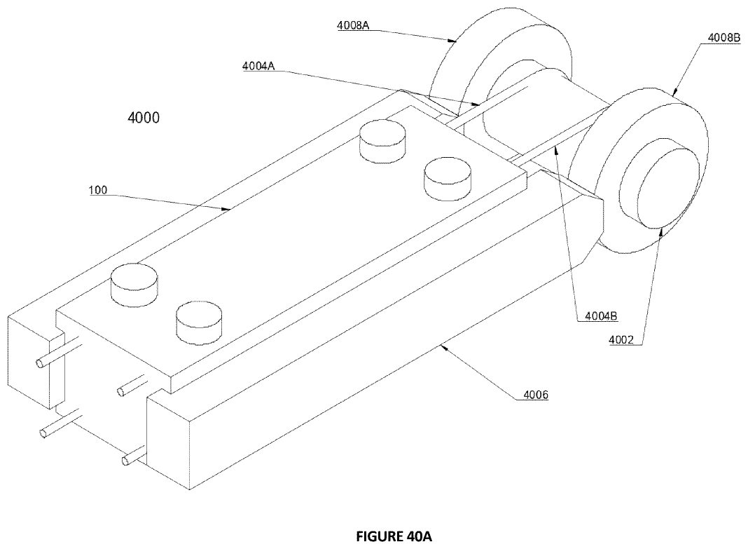

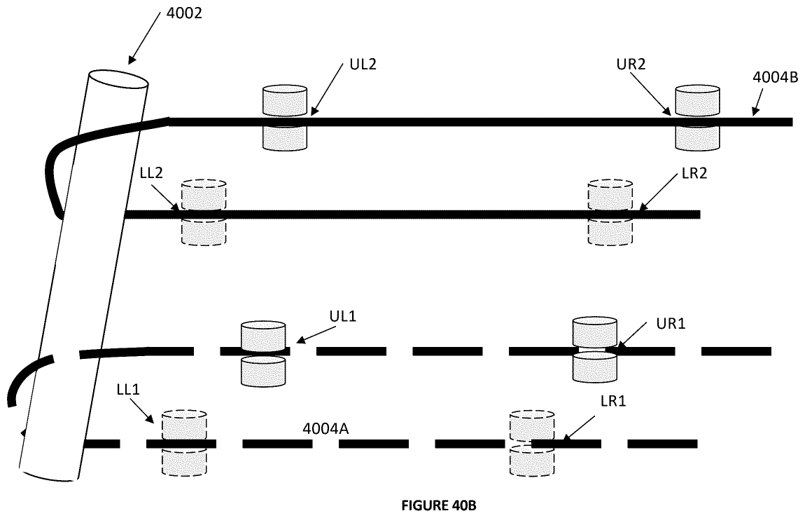

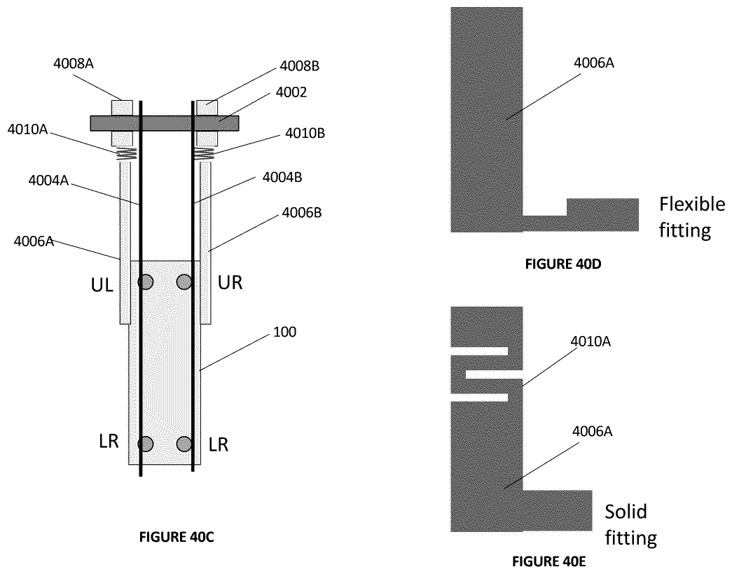

Referring now generally to the Figures and particularly to FIG. 40A, FIG. 40A is a 3D model of an axle-rotation servo motor implementation utilizing an embodiment of the invented actuator device of FIG. 1, and presents the invented actuator device 100 utilized in the context of an axle torque assembly 4000 rotatably coupled to an axle 4002. The axle torque assembly 4000 consists, in this application, of at least an instance of the invented actuator device 100, a first tendon 4004A and a second tendon 4004B (“the tendons 4004”) each looped around the axle 4002 as shown (it is noted that this is a reversal of one of the tendon orientations as presented at least in FIG. 1B, such that in this embodiment both ‘loop ends’ of tendon are facing the same direction and looped over the axle 4002), and a frame 4006 including a first bearing 4008A and a second bearing 4008B (“the bearings 4008”) securing the invented actuator device 100 rotatably in position relative to the axle 4002. It is noted that the invented actuator device 100 is pictured here as just a box, and the tendons 4004 as simple lines, with no depiction of clamping mechanisms or other elements such as the piezoelectric stack 102. It is understood that this is a simplified representation of these elements that have already been explicated in more detail elsewhere. When the tendons 4004 are pulled on by the invented actuator device 100 as disclosed elsewhere in the disclosure, friction between the tendons 4004 and the axle 4002 causes the position of the axle 4002 and axle torque assembly 4000 relative to each other to change; depending upon which elements may be fixed in place, this may either spin the axle 4002 or rotate the axle torque assembly 4000 around the axle 4002. It is noted that only the part of the axle 4002 engaging with the axle torque assembly 4000 is shown here, and this axle 4002 may be longer, such as for use in rotating a wheel or any other application for an actuated turning axle such as the axle 4002 as generally known in the art. It is also noted that only the axle torque assembly 4000 itself is shown here, while this element may also be connected to something else in need of rotation around the fulcrum point provided by the axle 4002, such as a robotic limb. Additionally, either the axle torque assembly 4000 or the axle 4002 (but probably not both, unless the intention is to saw through the axle 4002 with the tendons 4004, perhaps) may be fixed in place, such as by being bolted down to something heavy. It is noted that the bearings 4008 need not be rotatable, and having these non-rotatably coupled to the frame 4006 may be preferred. The bearings 4008 are preferably annular, or some other shape that permits rotation of the axle 4002 relative to the frame 4006. It may be useful to think of the bearings 4008 as serving the same purpose as rings on a curtain rod, if the curtain rod also had to be rotatable. In preferred operation, the invented actuator device 100 pulls on its tendons 4004, as disclosed in previous sections, thus causing friction of the tendons 4004 against the axle 4002 and causing the axle 4002 to rotate. This kind of mechanism is versatile in application, as upcoming Figures will further explicate, and is generally good for producing non-continuous motion (such as swinging an arm, and not such as continuously spinning a turbine) requiring significant torque. Another ready benefit is that this invented application is easily scalable, including, most relevantly, the ability to scale down to very small sizes. A lower limit to miniaturization is a weakness much of the prior art field of actuators shares in common, limiting the field of robotics in particular.

Referring now generally to the Figures and particularly to FIG. 40B, FIG. 40B is a diagram similar to the diagram of FIG. 1B, for presenting the differences in tendon 4004 layout and clamping position UL1-LR2 operation particular to the axle torque assembly 4000 and similar embodiments. The axle 4002 is included for positional reference. Like the device 100 as presented in FIG. 1B, the device 100 as implemented in the axle torque assembly 4000 may have eight clamping points UL1-LR2, with the tendons 4004 positioned to be gripped by these eight clamping points UL1-LR2. As a significant point of distinction, the diagram of FIG. 1B had the ‘looped’ ends of the two tendons 118 & 120 pointing in opposite directions, and oriented such that the first tendon 118 had the ‘lower’ track and the second tendon 120 the ‘upper’; in the axle torque assembly 4000 implementation, the tendon loops are pointing in the same direction, the tendons 4004 are positioned along either side of the device 100 to hang from the axle 4002 (like one's arms when hanging from an exercise bar) and the tendons 4004 are looped around the axle 4002 such that by pulling on the tendons 4004 by engaging the clamping points UL1-LR2, the device 100 can spin the axle 4002 or rotate the frame 4006 (including itself) around the axle 4002, depending on which elements may be fixed in position (e.g. bolted down). The first tendon 4004A may be threaded through the clamping points UR1, UL1, up over the axle 4002, LL1, and LR1. The second tendon 4004B may be threaded through the clamping points UR2, UL2, up over the axle 4002, LL2, and then LR2. It is noted that the designations ‘left’ and ‘right’ as established in FIG. 1B are even less accurate here, as this implementation is generally oriented with ‘left’ up and ‘right’ down, but the original clamping point designations are perpetuated for clarity in reading the diagrams.

Presented below is a table of the motions and clamping patterns of the invented actuator device 100 as connected to spinning of the axle in clockwise (CW) and counterclockwise (CCW) directions:

| | UL | LL | UR | LR | Body | | |
|---|---|---|---|---|---|---|---|
| Zero | + | + | + | + | holds the position | | |
| CCW1 | − | + | + | − | not moving | \| | |
| CCW2 | − | + | + | − | extends | \| | Repeating 4 steps |
| CCW3 | + | − | − | + | not moving | \| | continuously until |
| CCW4 | + | − | − | + | contracts | \| | reaching the position |
| Zero | + | + | + | + | holds the position | | |
| CW1 | + | − | − | + | not moving | | |
| CW2 | + | − | − | + | extends | | |
| CW3 | − | + | + | − | not moving | | |
| CW4 | − | + | + | − | contracts | | |

Referring now generally to the Figures and particularly to FIG. 40C, FIG. 40C is a diagram presenting further information regarding the mechanics of the axle torque assembly 4000 of FIG. 40A. It is noted that the tightening of the tendons is the force effecting the turning of the axle 4002, and therefore that it is preferred for as much force as possible go toward tightening the tendons, such that the axle 4002 is forced to turn in order to loosen the tension.

It is noted that this is only a diagram for explaining tendons and clamping points, and is not intended as an accurate representation of the mechanical shapes of these elements. The diagram includes the axle 4002, sections of the frame 4006 (here subdivided into a left frame leg 4006A and a right frame leg 4006B), the bearings 4008, the tendons 4004, and the device 100.

Further labeled here is an optional feature if preferred, a first spring 4010A and a second spring 4010B built into the frame 4006 as shown, providing additional flexibility or leeway for the device 100 to actuate. It is noted as an important nuance that the frame 4006 is preferred to not be entirely rigid, as the invented actuator device 100 is expanding and contracting, at least a little, in order to pull on the tendons and effect motion. Flexibility to allow for this motion of the invented actuator device 100 may preferably be built into the frame 4006, such as by including the springs 4010A & 4010B, or utilizing a flexibly fitted frame 4006 such as the frame 4006 shape of FIG. 40D. It is noted that the flexibility of the springs 4010A & 4010B in this context should generally be enough to accommodate the vertical displacement of the leg 0.02 mm-0.05 mm under the force 100-200N.

Referring now generally to the Figures and particularly to FIG. 40D, FIG. 40D is a possible shape of the frame 4006 for providing a flexible fit with the invented actuator device 100. It is understood that the invented actuator device 100 may be elongating and contracting in order to move the tendons, and this motion might be rapid to produce the intended effect on the axle 4002. In some implementations, a loose or flexible frame may be preferred for accommodating this function. It is noted that many other shapes of the frame 4006 may be possible or preferable, and this shape is offered as an example of one that may be preferred or beneficial.

Referring now generally to the Figures and particularly to FIG. 40E, FIG. 40E is a possible shape of the frame 4006 for providing a solid fit with the invented actuator device 100. It is understood that the invented actuator device 100 may be elongating and contracting in order to move the tendons, and this motion might be rapid to produce the intended effect on the axle 4002. In some implementations, a snug-fitting or solid frame may be preferred for accommodating this function, and a spring 4010A may be provided to accommodate the motion of the device 100. It is noted that many other shapes of the frame 4006 may be possible or preferable, and this shape is offered as an example of one that may be preferred or beneficial.

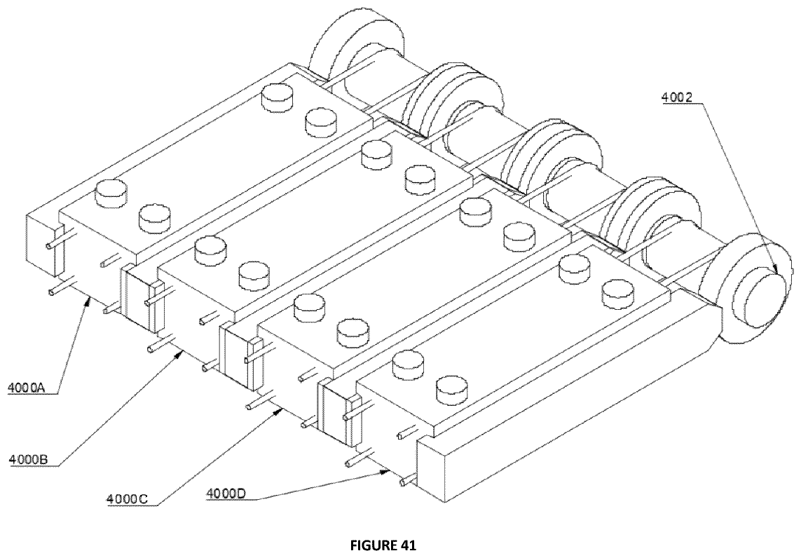

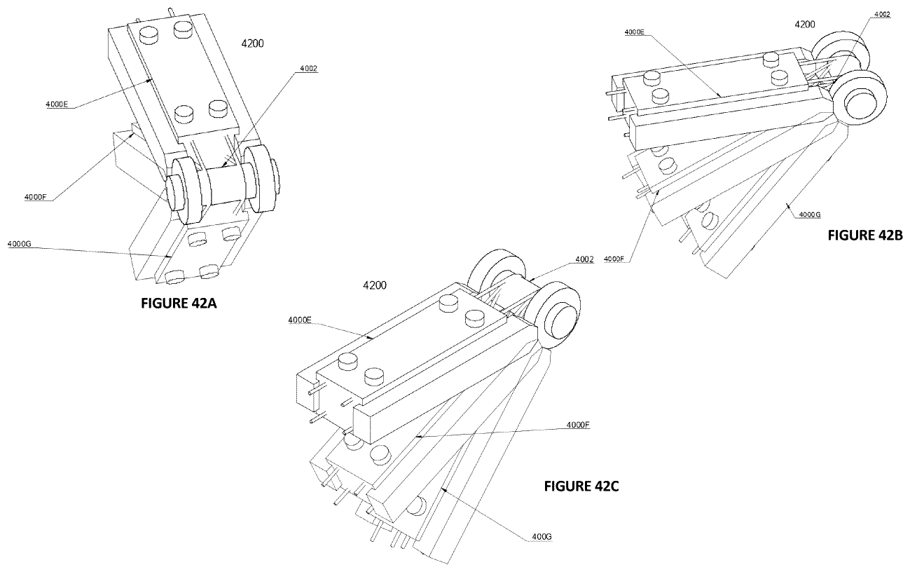

Referring now generally to the Figures and particularly to FIG. 41, FIG. 41 presents an application of four axle torque assemblies 4000, specifically a first parallel axle torque assembly 4000A, a second parallel axle torque assembly 4000B, a third parallel axle torque assembly 4000C, and a fourth parallel axle torque assembly 4000D, (collectively, “the first set of parallelized axle torque assemblies 4000A-D”) stacked in parallel along the same axle 4002, such that the force and torque provided by all four invented actuation devices 100 is applied to turning the same axle 4002. It is noted that this might be implemented by coupling of four instances of FIG. 40A together at the frames 4006, or by constructing the frame 4006 to fit four invented actuation devices 100 instead of just one. It is further noted that four is an arbitrarily-chosen number, and any quantity of these might be stacked together in similar fashion, limited only by the logistical concern of taking up increasing amounts of space in a straight line. The subject of this concern may lead into the next embodiment represented herein, starting at FIG. 42A.

Referring now generally to the Figures and particularly to FIG. 42A, FIG. 42A is a 3D model presenting three of the axle torque assemblies 4000 of FIG. 40A, specifically a fifth parallel axle torque assembly 4000E, a sixth parallel axle torque assembly 4000F, and a seventh parallel axle torque assembly 4000G, (collectively, “the second set of parallelized axle torque assemblies 4000E-G”) configured as a triad axle torque assembly 4200, for turning the same axle 4002 in concert or parallel. Rather than the linear stacking for parallelization of FIG. 41, these three axle torque assemblies 4000 form a partial arc around the axle 4002 as shown, allowing parallelization of axle torque assemblies 4000 in a format that may be more suitable and compact in many instances. It is noted that the frames 4006 and bearings 4008 of these axle torque assemblies 4000 may be partially combined as appropriate.

Referring now generally to the Figures and particularly to FIG. 42B, FIG. 42B is a second image presenting the same 3D model of FIG. 42A from a different angle. It is recognized that a directional designation such as ‘top view’ or side view’ would be entirely arbitrary, and the assembly presented here might be oriented however is deemed appropriate.

Referring now generally to the Figures and particularly to FIG. 42C, FIG. 42C is a third image presenting the same 3D model of FIG. 42A from a different angle. It is recognized that a directional designation such as ‘top view’ or side view’ would be entirely arbitrary, and the assembly presented here might be oriented however is deemed appropriate.

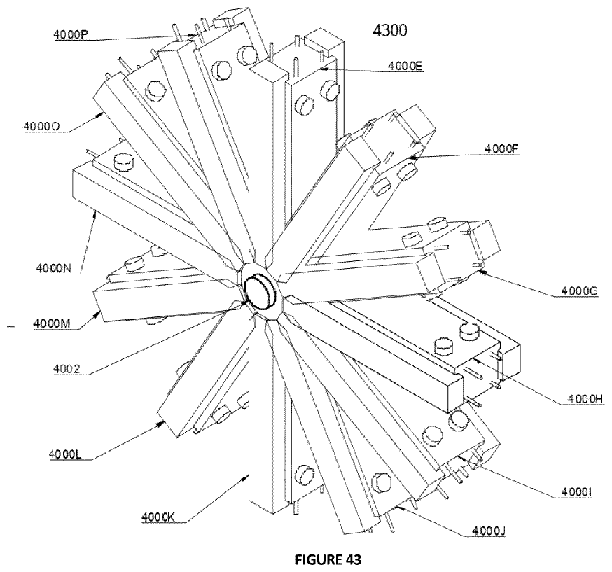

Referring now generally to the Figures and particularly to FIG. 43, FIG. 43 is a 3D model presenting twelve of the axle torque assemblies 4000 of FIG. 40A coupled in a parallelization implementation for turning the same axle 4002, continuing the idea of FIG. 42A-C into an arc that forms a full ‘star’ around the same single axle. For element numbering, the second set of parallelized axle torque assemblies 4000E-G is incorporated as ¼ of the star, in addition to an eighth parallel axle torque assembly 4000H, a ninth parallel axle torque assembly 4000I, a tenth parallel axle torque assembly 4000J, an eleventh parallel axle torque assembly 4000K, a twelfth parallel axle torque assembly 4000L, a thirteenth parallel axle torque assembly 4000M, a fourteenth parallel axle torque assembly 4000N, a fifteenth parallel axle torque assembly 4000O, and a sixteenth parallel axle torque assembly 4000P. This ‘star’ construction of twelve axle torque assemblies 4000 configured to rotate the same single central axle 4002 constitutes an axle torque star assembly 4300. It is noted that the axle torque star assembly 4300 is not limited to twelve axle torque assemblies 4000 may comprise any number of axle torque assemblies 4000 as the physical dimensions suit. It is further noted that an additional axle torque assembly 4000, perhaps requiring longer tendons, would fit into each triangular gap of the star shape, and the tendons belonging to that axle torque assembly 4000 could fit through the gap between the tops of two others to wrap around the axle, thus forming a possible second ‘layer’ of points of the star, which is not shown here.

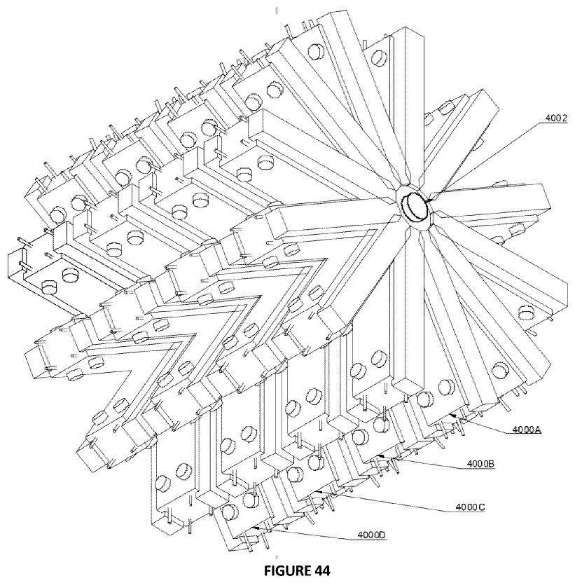

Referring now generally to the Figures and particularly to FIG. 44, FIG. 44 is a 3D model presenting multiple axle torque star assemblies 4300 stacked in linear parallel along the same axle, as single axle torque assemblies 4000A-D were in FIG. 41. For element numbering, these are a first parallel axle torque star assembly 4300A, a second parallel axle torque star assembly 4300B, a third parallel axle torque star assembly 4300C, and a fourth parallel axle torque star assembly 4300D, each of these comprising a plurality of single axle torque assemblies 4000 as presented in FIG. 43. It is noted again that the number of axle torque assemblies 4000 which may fit into a construction like this may not necessarily always be twelve, and how many axle torque star assemblies 4300 may be stacked in parallel is not limited to four, which was selected arbitrarily for the purposes of demonstration here. It is further noted that this relatively compact assembly as shown provides forty-eight axle torque assemblies 4000 exerting force on the same single axle 4002, and room, as mentioned above, for forty-eight more by adding a little width and no length, or capability for expanding the length a little and providing room for another star of twelve more.

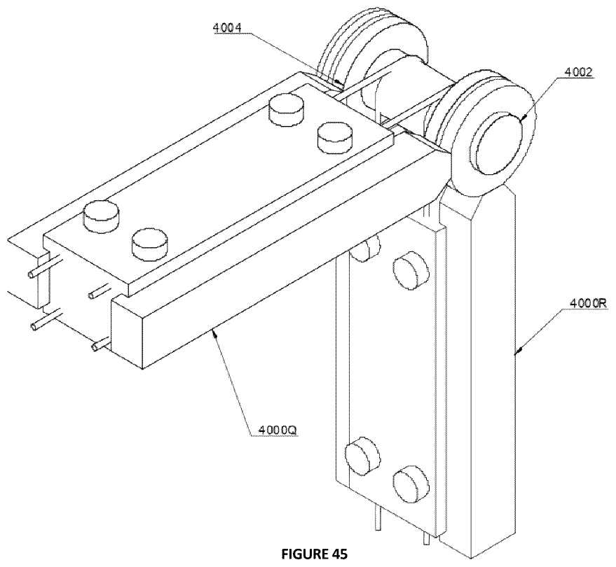

Referring now generally to the Figures and particularly to FIG. 45, FIG. 45 is a 3D model presenting an implementation of an artificial joint utilizing two of the axle torque assemblies 4000 of FIG. 40A. In this implementation, an upper axle torque assembly 4000Q and a lower axle torque assembly 4000R are oriented to pivot themselves, using their respective tendons 4004, around a joint axle 4002, such that exertion of either the upper axle torque assembly 4000Q or the lower axle torque assembly 4000R would result in the joint moving and/or bending in a comparable fashion to an elbow or knee. Again, a key benefit to this implementation is how small this mechanism could be scaled and still be functional, which is a limitation that particularly impairs robotics, as there's currently a threshold on how small, nimble, or dexterous a robot can be based on what kind of actuation technology is available to make a robot move.

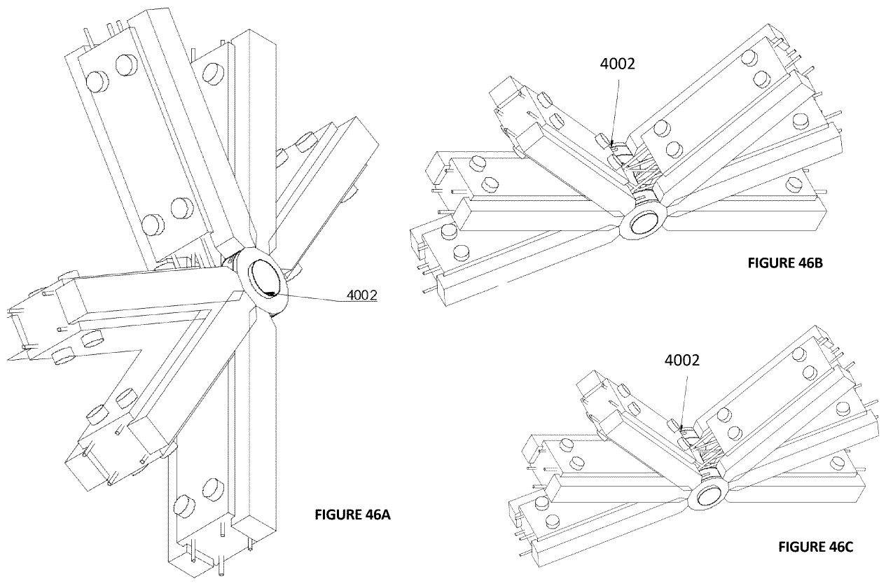

Referring now generally to the Figures and particularly to FIG. 46A, FIG. 46A is a 3D model presenting an implementation of an artificial joint similar to that of FIG. 45, but utilizing two of the triad axle torque assemblies 4200 of FIG. 42A instead of single axle torque assemblies 4000. It is noted that even with the multiple axle torque assemblies 4000 taking up more space than the single axle torque assemblies 4000 of FIG. 45, there is still a lot of room for the joint to flex.

Referring now generally to the Figures and particularly to FIG. 46B, FIG. 46B is a different angle of the 3D model of FIG. 46A. This might be considered an instance of the mechanical joint of FIG. 45 which applies the parallelization concept introduced in FIG. 42A-C.

Referring now generally to the Figures and particularly to FIG. 46C, FIG. 46C is a 3D model presenting an implementation of an artificial joint similar to that of FIG. 46A, utilizing two stacked parallelized sets of the triad axle torque assemblies 4200 of FIG. 46A, in the stacking manner of FIG. 44. This might be considered an application of the stacking concept introduced in FIG. 44 to the joint of FIG. 46A. Naturally, it is understood that the concepts introduced here are further expandable within the same patterns, such as making a similar joint but with five triads stacked, or ten, if suited to the situation at hand. This disclosure is understood to have anticipated and outlined all such obvious variations, without spelling out every possible one.

Referring now generally to the Figures and particularly to FIG. 47A, FIG. 47A is a 3D model presenting an implementation of an artificial joint having two degrees of freedom (“a 2DOF axle torque joint 4700”), utilizing two of the axle torque assemblies 4000 of FIG. 40A, specifically an upper 2DOF axle torque assembly 4000S and a lower 2DOF axle torque assembly 4000T. The upper 2DOF axle torque assembly 4000S rotates an upper axle 4002A, and the lower 2DOF axle torque assembly 4000T rotates a lower axle 4002B, and the upper axle 4002A and the lower axle 4002B are connected by a post 4702, such that rotation of either axle pulls on the other axle. This joint is capable of a broader range of motion than the single degree of freedom provided by the joint of FIG. 45.

Referring now generally to the Figures and particularly to FIG. 47B, FIG. 47B is a different angle of the 3D model of FIG. 47A. The upper 2DOF axle torque assembly 4000S rotates an upper axle 4002A, the lower 2DOF axle torque assembly 4000T rotates a lower axle 4002B, and the upper axle 4002A and the lower axle 4002B are connected by a post 4702, such that rotation of either axle pulls on the other axle. This joint is capable of a broader range of motion than the single degree of freedom provided by the joint of FIG. 45.

Referring now generally to the Figures and particularly to FIG. 47C, FIG. 47C is a closer view of the 3D model of FIG. 47B. The upper 2DOF axle torque assembly 4000S rotates an upper axle 4002A, the lower 2DOF axle torque assembly 4000T rotates a lower axle 4002B, and the upper axle 4002A and the lower axle 4002B are connected by a post 4702, such that rotation of either axle pulls on the other axle. This joint is capable of a broader range of motion than the single degree of freedom provided by the joint of FIG. 45.

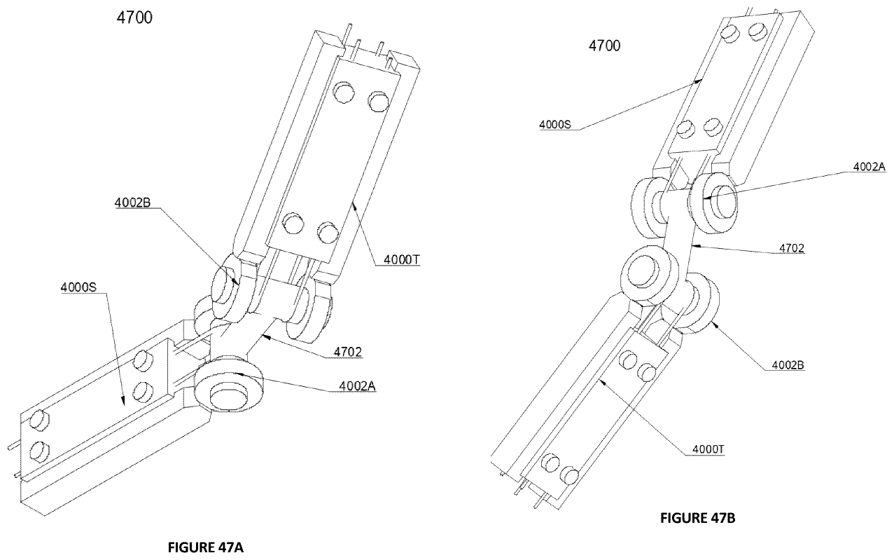

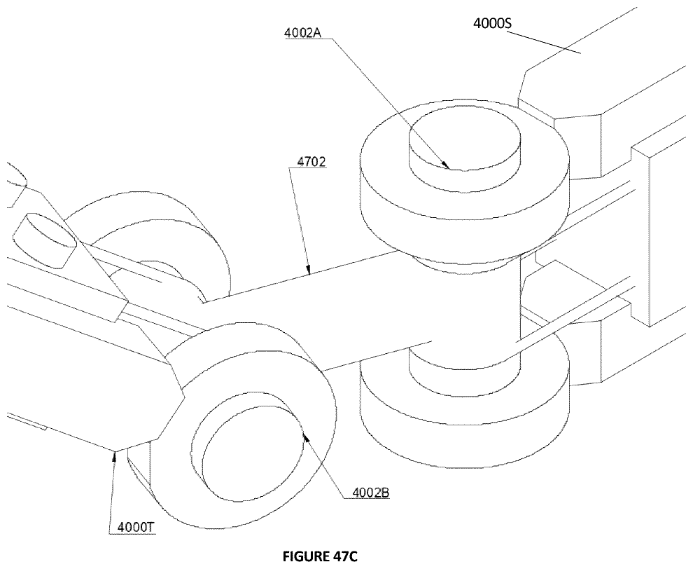

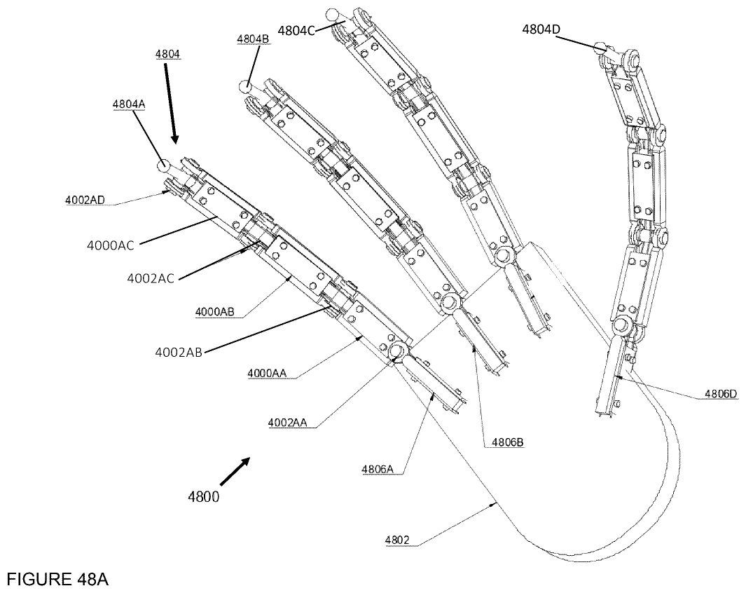

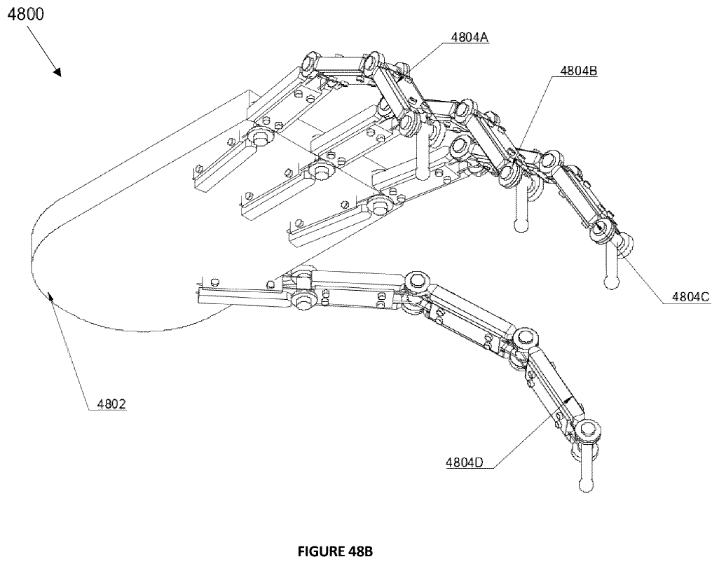

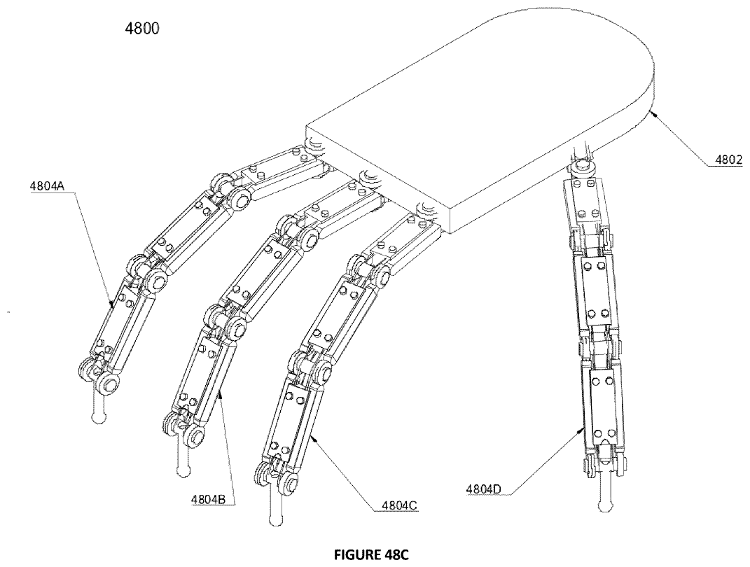

Referring now generally to the Figures and particularly to FIG. 48A, FIG. 48A is a first view of a 3D model presenting a robotic hand assembly 4800 implemented using a plurality of axle-rotation servo motor joints as presented in FIG. 46A. With particular reference to FIGS. 40A, 45, and 47A, one might already appreciate visually how these concepts have been applied to engineer a lightweight, relatively-easily-constructed handlike assembly with nimble, multi-jointed fingers. The robotic hand assembly 4800 comprises a palm 4802 coupled to at least one finger assembly 4804, specifically, a first finger assembly 4804A, a second finger assembly 4804B, a third finger assembly 4804C, and a fourth finger assembly 4804D. It is understood that the fourth finger assembly 4804D functions as a ‘thumb’ by being coupled to the palm 4802 at a different angle, and these finger assemblies 4804A-D are generally otherwise identical to each other. It is noted that, while terminology used herein to identify parts of the robotic hand assembly 4800 is inspired by the anatomical terms given to parts of the human hand, it's not necessarily a perfect metaphor and nothing should be assumed or read into this disclosure based solely on this usage of anatomical terminology. The components of the first finger assembly 4804A as described herein can be understood as also being duplicated in the other finger assemblies 4804, though only labeled on the first finger assembly 4804A and discussed in the context of the first finger assembly 4804A for this explanation. The first finger assembly 4804A further comprises at least a metacarpal actuator 4806A, a first phalange actuator 4000AA, a second phalange actuator 4000AB, a third phalange actuator 4000AC, a first knuckle axle 4002AA, a second knuckle axle 4002AB, a third knuckle axle 4002AC, a fingertip axle 4002AD, and a fingertip 4808A. It is noted that the metacarpal actuator 4806A, the first phalange actuator 4000AA, the second phalange actuator 4000AB, and the third phalange actuator 4000AC are all instances of the axle torque assembly 4000 originally introduced in FIG. 40A, and each ‘knuckle’ of the first finger assembly 4804A is an application of the artificial joint concept introduced in FIG. 45, wherein two axle torque assemblies 4000 share the same axle 4002 and pivot themselves around the axle 4002 (or pivot the axle 4002 with respect to themselves) to effect joint motion similar to that of an elbow, knee, or in this case, knuckle. It is noted that all of these axle torque assemblies 4000 include tendons (though not labeled herein) in the same manner as the assemblies of FIGS. 40A and 45, which turn the axle 4002 or pivot the position of the axle torque assembly 4000 around the axle 4002. The metacarpal actuator 4806A is coupled onto or into the palm 4802, supporting the weight of the rest of the first finger assembly 4804A and providing some lateral flexibility by controllably pivoting with the first knuckle axle 4000AA. The first phalange actuator 4000AA is coupled with the first knuckle axle 4000AA, and shares the second knuckle axle 4002AB with the second phalange actuator 4000AB as an artificial joint of FIG. 45. The second phalange actuator 4000AB further also shares the third knuckle axle 4002AC with the third phalange actuator 4000AC as an artificial joint of FIG. 45. The third phalange actuator further also pivots the fingertip axle 4002AD, to control the motion of the fingertip 4808A for gripping something. The fingertip 4808A may further be padded or adapted with a friction element such as texturing, to provide an improved gripping capability. It is again noted that, while the first finger assembly 4804A is the one described in detail, everything stated regarding the components of the first finger assembly 4804A may be understood as duplicated in the other finger assemblies 4804A-D. It is understood that this is just one possible application of this concept, and other implementations may have more or fewer fingers, fingers with more or fewer segments, differently positioned fingers, and so on, and providing of this particular example is not intended as a limitation of other possible embodiments.

Referring now generally to the Figures and particularly to FIG. 48B, FIG. 48B is a second view of the 3D model robotic hand of FIG. 47A. The robotic hand assembly 4800 comprises the palm 4802 coupled to the finger assemblies 4804, specifically, the first finger assembly 4804A, the second finger assembly 4804B, the third finger assembly 4804C, and the fourth finger assembly 4804D.

Referring now generally to the Figures and particularly to FIG. 48C, FIG. 48C is a third view of the 3D model robotic hand of FIG. 47A. The robotic hand assembly 4800 comprises the palm 4802 coupled to the finger assemblies 4804, specifically, the first finger assembly 4804A, the second finger assembly 4804B, the third finger assembly 4804C, and the fourth finger assembly 4804D.

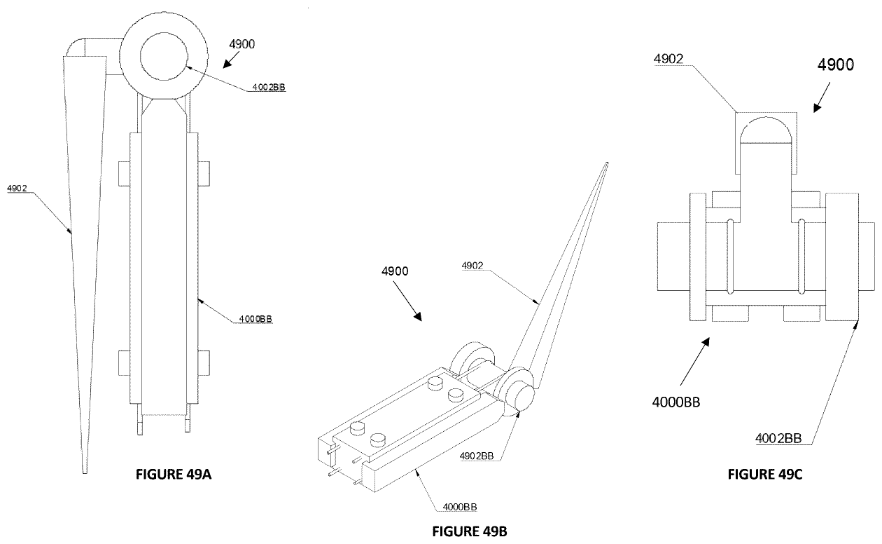

Referring now generally to the Figures and particularly to FIG. 49A, FIG. 49A is a profile view of a claw assembly 4900 implemented utilizing an axle torque assembly 4000BB of FIG. 40A. The claw assembly 4900 may comprise the axle torque assembly 4000BB, an instance of the axle torque assembly 4000 initially introduced in FIG. 40A, pivoting an axle 4002BB, and the axle 4002BB being coupled to a claw element 4902, such that when the axle 4002BB is turned or pivoted by the axle torque assembly 4000BB, the claw element 4902 folds in (as presented in FIG. 49A) or out (as presented in FIG. 49B).

Referring now generally to the Figures and particularly to FIG. 49B, FIG. 49B is a profile view of the claw assembly 4900 of FIG. 49A, with the claw 4902 folded out. The claw assembly 4900 may comprise the axle torque assembly 4000BB, an instance of the axle torque assembly 4000 initially introduced in FIG. 40A, pivoting an axle 4002BB, and the axle 4002BB being coupled to a claw element 4902, such that when the axle 4002BB is turned or pivoted by the axle torque assembly 4000BB, the claw element 4902 folds in (as presented in FIG. 49A) or out (as presented in FIG. 49B).

Referring now generally to the Figures and particularly to FIG. 49C, FIG. 49C is a top view of the claw assembly 4900 of FIG. 49A, with the claw element 4902 folded in. Referring now generally to the Figures and particularly to FIG. 49B, FIG. 49B is a profile view of the claw assembly 4900 of FIG. 49A, with the claw element 4902 folded out. The claw assembly 4900 may comprise the axle torque assembly 4000BB, an instance of the axle torque assembly 4000 initially introduced in FIG. 40A, pivoting an axle 4002BB, and the axle 4002BB being coupled to a claw element 4902, such that when the axle 4002BB is turned or pivoted by the axle torque assembly 4000BB, the claw element 4902 folds in (as presented in FIG. 49A) or out (as presented in FIG. 49B).

Referring now generally to the Figures and particularly to FIG. 50A, FIG. 50A is a first view of a climbing robot 5000 utilizing multiple instances of the claw assembly 4900 of FIG. 49A, specifically a first claw assembly 4900A, a second claw assembly 4900B (hidden at this angle; visible in FIG. 50B), a third claw assembly 4900C, and a fourth claw assembly 4900D, for climbing up a surface such as a pole 5002.

Referring now generally to the Figures and particularly to FIG. 50B, FIG. 50B is a second view of the climbing robot 5000 of FIG. 50A utilizing multiple instances of the claw assembly 4900 of FIG. 49A, specifically the first claw assembly 4900A, the second claw assembly 4900B, the third claw assembly 4900C, and the fourth claw assembly 4900D, for climbing up a surface such as a pole 5002.

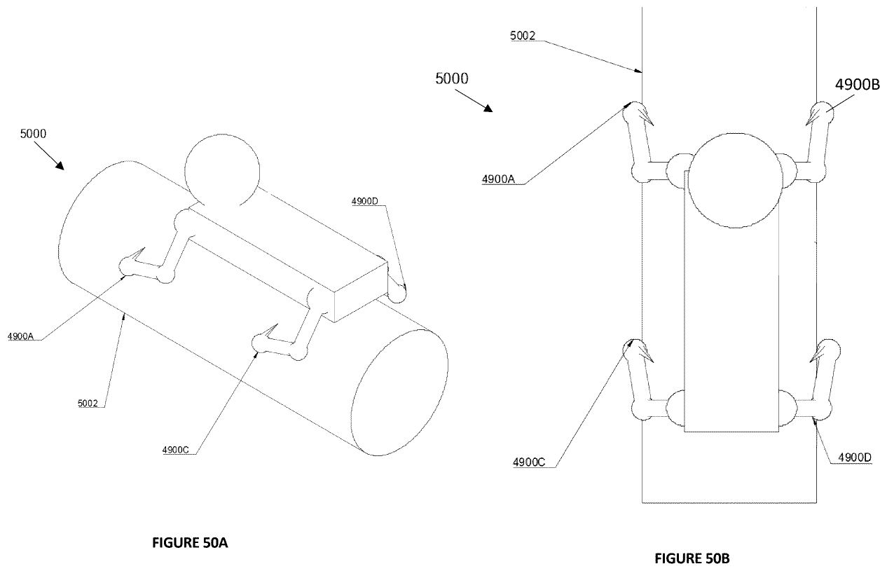

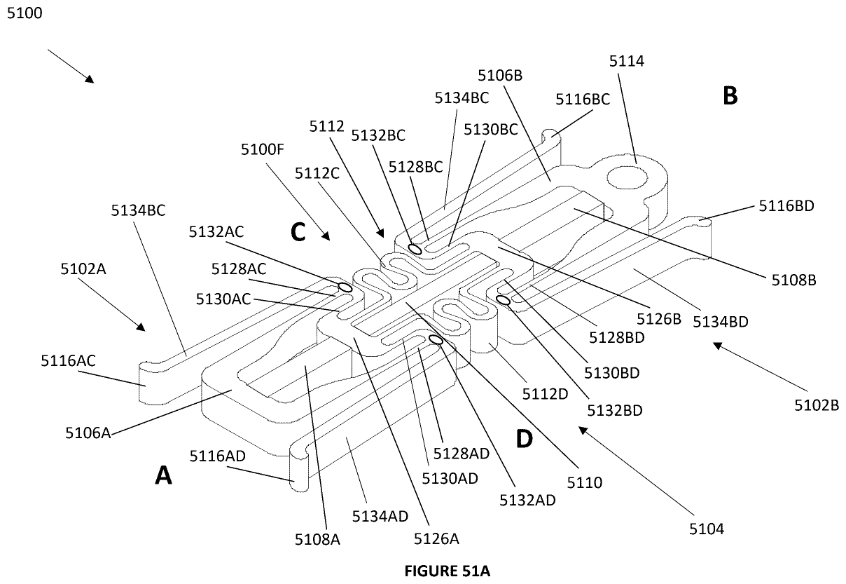

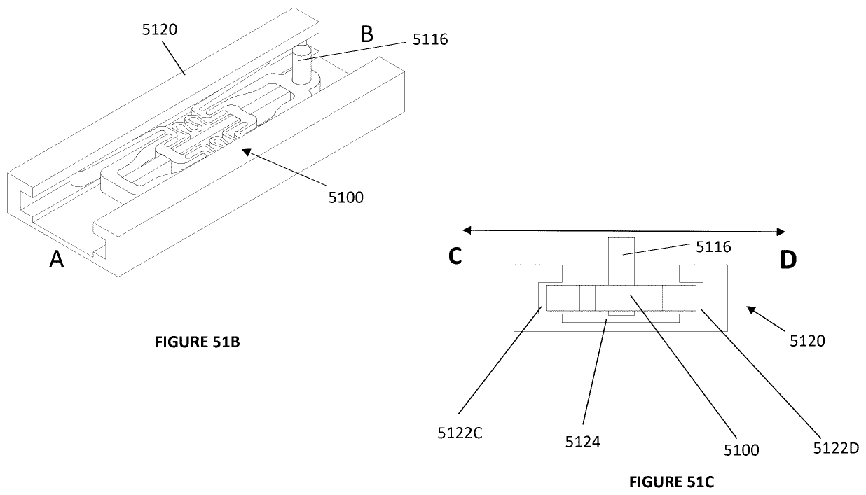

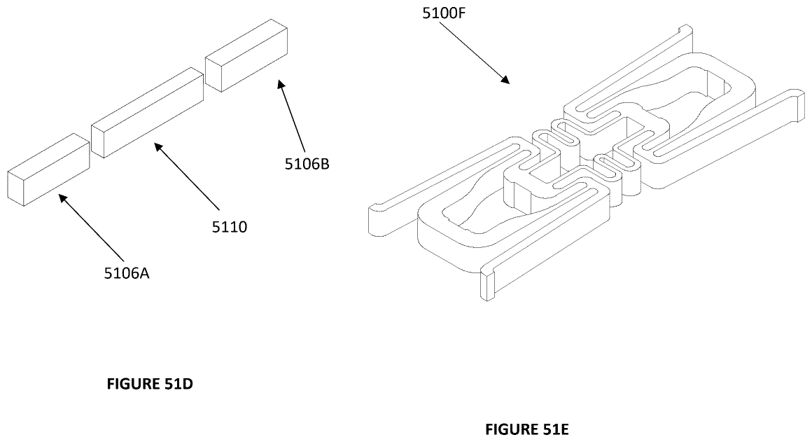

Referring now generally to the Figures and particularly to FIG. 51A, FIG. 51A is a line drawing of a guided linear actuator 5100 (“the GLA 5100”). Please further note establishment of a convention of an A end, a Bend, a C side, and a D side, as labeled here, wherein the A-B axis is the axis of travel (i.e. “forward and backward”) and the C-D axis is orthogonal to the A-B axis and analogous to the left and right sides of the GLA 5100. The GLA 5100 may comprise two clamps 5102, individually an A end clamp 5102A and a B end clamp 5102B, at either end of a middle section 5104. Each of the two clamps 5102 further comprises each of a pair of two clamp actuators 5106 and a pair of two clamp bodies 5108, individually an A end clamp actuator 5106A and an A end clamp body 5108A of the A end clamp 5102A, and a B end clamp actuator 5106B and a B end clamp body 5108B of the B end clamp 5102B. The middle section 5104 further comprises a middle actuator 5110 and a middle body 5112, which further comprises a C side spring 5112C and a D side spring 5112D. The GLA 5100 may also comprise a rod aperture 5114 at one end of the GLA 5100, into which is fitted a loading force rod 5116 as presented and discussed later starting at FIG. 51B. Further labeled here are an A end and a B end of the GLA 5100, wherein the A end is a side of the GLA 5100 toward the A end clamp 5102A, and the B end of the GLA 5100 is a side of the GLA 5100 toward the B end clamp 5102B. The GLA 5100 generally comprises (1.) three simple actuators which are preferably piezoelectric or solenoid actuators—the two clamp actuators 5106 and the middle actuator 5110; and (2.) a frame 5100F comprising the A end clamp body 5108A, the B end clamp body 5108B, and the middle body 5112. The frame 5100F may be implemented as one piece or assembled with several pieces; some preferred materials for the frame include metal, plastic, or ceramics. It is noted that the simple actuators as discussed above provide powered motion by expanding and contracting according to receiving of electrical current, and the frame elements mechanically amplify the expansion and contraction motions of the simple actuators into physical motions of the device, such as engaging and disengaging the two clamps 5102 and expanding and contracting the middle section 5104. Relevant to further discussion below regarding FIGS. 51B through 54D, this drawing also labels a set of feet 5116, specifically an AC foot 5116AC, an AD foot 5116AD, a BC foot 5116BC, and a BD foot 5116BD.

In this particular embodiment the actuators 5106 & 5110 are piezoelectric stacks, such as but not limited to a PICMA® High-Performance Monolithic Multilayer Piezo Stack Actuators (PZT), the PI P8882 product line, as marketed by Physik Instrumente (PI) USA of Auburn, MA or a THORLAB PA4 as marketed by ThorLabs Inc. of Newton, New Jersey, but can be replaced by any extending/contracting actuator or material like electromagnetic solenoid, electrostatic actuators, EAP actuators, etc. Preferred materials for manufacturing the frame 5100F may include steel 1095, steel titanium alloy grade 5, titanium ASTM grade 5, and other metals as considered to be suitable by one skilled in the art; ceramics as considered to be suitable by one skilled in the art; plastics as considered to be suitable by one skilled in the art; and other materials as considered to be suitable by one skilled in the art. The thinnest elements of the frame 5100F may be in the range of 50 microns to 400 microns, more preferably in the range of 200 to 350 microns, and most preferably about 300 microns varying no more than +/−10%. The thickest elements of the frame 5100F may be thicker than 0.5 mm, and most preferably between 1.5 mm to 5 mm.

It is noted that both “holding” and “nonholding” embodiments are discussed herein later on, where the distinction is which device state corresponds with a powered-off “default” state of the actuators. By changing the shape of frame elements discussed above, one may design a device wherein either the clamps are in a holding position until powered to release, or alternatively released until powered to engage; and further alternatively wherein the middle section 5104 is expanded until powered to contract or alternatively contracted until powered to expand. Which of these variations might be preferred, will depend on the specific intended application.

Essentially, the GLA frame 5100F is a system of levers that converts a small stroke into a larger one (which is usually required when working with piezoelectric stacks) or conversely, increases the force at the expense of reducing the stroke (this is sometimes needed for electromagnetic actuators). The various GLA embodiments described herein might consist of a metallic, plastic, or ceramic housing-a lever system frame and one or more piezoelectric stacks placed within the frame. When voltage is applied to a piezoelectric stack, the GLA frame 5100F slightly changes shape. The GLA frame 5100F may comprise wide and narrow elements, which bend differently as a result of the piezoelectric stack's lengthening. The GLA frame 5100F as instantiated in multiple embodiments described herein may generally include a pair of support bases 5126 (an A-side support base 5126A and a B-side support base 5126B), a set of four thin and thus flexible elements 5128 (a thin and thus flexible element AC 5128AC, a thin and thus flexible element AD 5128AD, a thin and thus flexible element BC 5128BC, and a thin and thus flexible element BD 5128BD), a set of four thin mechanical beams 5130 (a thin mechanical beam AC 5130AC, a thin mechanical beam AD 5130AD, a thin mechanical beam BC 5130BC, and a thin mechanical beam BD 5130BD), a set of four fulcrum shoulders 5132 (a fulcrum shoulder AC 5132AC, a fulcrum shoulder AD 5132AD, a fulcrum shoulder BC 5132BC, and a fulcrum shoulder BD 5132BD), and a set of four legs 5134 (a leg AC 5134AC, a leg AD 5134AD, a leg BC 5134BC, and a leg BD 5134BD), which end in the feet 5116. It is understood that an instantaneous position of any fulcrum within one or more fulcrum shoulders AC 5132AC, AD 5132AD, BC 5132BC, & BD 5132BD may move dynamically within a fulcrum zone of said fulcrum shoulders AC 5132AC, AD 5132AD, BC 5132BC, & BD 5132BD as the lever is under stress from the leg and/or the one or more of the actuators 5106 & 5110. It is further understood that the meaning of term fulcrum zone is defined within this disclosure to include three dimensional volume within which a fulcrum is dynamically moving.

The performance and durability of the piezoelectric stacks may depend on how parallel the support platforms are. In the GLA 5100, thanks to the device's symmetry, the original parallelism is not compromised under significant loads. Moreover, due to the overall springiness of the housing, such a design is resistant to vibrations and occupies little space. The manufacturing of a metallic embodiment of the GLA frame 5100F can be done by stamping, 3D printing, electrical discharge machining, laser cutting, or waterjet cutting. A metallic embodiment of the GLA frame 5100F can also be made using material deposition or etching. A plastic or ceramic version does not allow for the use of electrical discharge machining, as the material is not electrically conductive; other methods may be suitable to varying degrees. The direct movement of the feet after voltage application occurs as the piezoelectric stack expands, exerting force on the elastic frame, while the reverse movement occurs when the voltage is removed, due to the frame's elasticity. Here, the frame acts as a return spring. The amplification of the travel depends on the rate of the length of a shoulder divided by a length of a leg.

Referring now generally to the Figures and particularly to FIG. 51B, FIG. 51B is a line drawing further presenting a loading force rod 5118 and a track 5120. The GLA 5100 is able to move linearly over a guide (such as the track 5120 of FIG. 51B, or other guides discussed herein) and against a force. A guide may be implemented as a bar, wire, a rail with a special profile or with multiple wires or rails. The track 5120 may be implemented as one part or comprise an assembly of several parts, and might be made of materials such as but not limited to aluminum, titanium alloy, ceramics, plastic, or steel. As with other inchworm actuator variations and embodiments presented herein, the GLA 5100 achieves locomotion by performing a series of expansions and contractions of the A end clamp actuator 5106A, the B end clamp actuator 5106B, and the middle actuator 5110 to individually engage and release one or both of the two clamps 5102 and expand and contract the middle section 5104. For instance, if the GLA 5100 is moving toward the B direction as presented in FIG. 51A and FIG. 51B (i.e. the rod aperture 5114 and loading force rod 5114 are at the “front”), this might be accomplished by (1.) engaging the A end clamp 5102A with a guide such as the track 5120 and disengaging the B end clamp 5102B; (2.) extending the middle section 5104, noting that since the A end clamp 5102A is engaged the B end of the GLA 5100 will be pushed “forward” toward B and cannot extend “backward” toward A; (3.) engaging the B end clamp 5102B at the new forward position; (4.) releasing the A end clamp 5102A; and (5.) contracting the middle section 5104, thus pulling the A end of the GLA 5100 up behind. By repeating this process, the GLA 5100 “inches” along relative to the guide such as the track 5120, in the fashion of an inchworm actuator. It is noted that this motion is relative to the guide such as the track 5120; it may be said that the GLA 5100 moves forward relative to the track 5120, or the track 5120 is moved backward relative to the GLA 5100. Locomotion toward the B end could likewise be performed by replacing every B with an A and A with a B in the method discussed directly above, like so: The B end clamp 5102B holds and the A end clamp 5102A releases, the middle section 5104 extends toward the A end, the A end clamp 5102A holds, the B end clamp 5102B releases, and the middle section 5104 contracts. The A end clamp 5102A engages with the track 5120 to form a “hold” position by pushing the AC foot 5116AC and the AD foot 5116AD against adjacent surfaces of the track 5120 to produce friction; and the B end clamp 5102B engages with the track 5120 to form a “hold” position by pushing the BC foot 5116BC and the BD foot 5116BD against adjacent surfaces of the track 5120 to produce friction. All movements of the A end clamp actuator 5106A, the middle actuator 5110, and the B end clamp actuator 5106B are synchronized properly and the total linear movement is performed to forward and/or back directions along the rail by repeating described steps. The length of the track 5120 limits the length of a possible path.

Referring now generally to the Figures and particularly to FIG. 51C, FIG. 51C is a line drawing presenting a side view of the track 5120 and the GLA 5100, such as what a viewer looking from the perspective of either the A end or the B end of FIG. 51A and FIG. 51B might see. Further labeled are a C side and a D side of the track 5120. The track 5120 may include a C side cutout 5122C and a D side cutout 5122D to fit around the GLA 5100 as presented in FIGS. 51B and 51C. The feet 5116 of the A end clamp 5102A and the B end clamp 5102B are moving in a perpendicular direction relative to the track 5118. When one of the two clamp actuators 5106 is extended, the feet 5116 of that clamp 5102 are moving and press the cutouts with a force. The frame 5100F is shaped such that expansion of one of the clamp actuators 5106 along the A-B axis causes a lever effect that pushes the feet 5116 of the corresponding clamp 5102 outward along the C-D axis.

Due to a substantial force in perpendicular direction causing friction, the particular GLA's frame end is locked and holds the frame body preventing a possible shift in a forward direction. If only the A end is locked, the B end is able to move in this direction. The opposite movement is possible when the B end is locked and the A end is able to move. These movements can be performed when the middle actuator 5110 is extending/contracting. When this happens and the A end is locked, the B end is moved in a forward direction. When the B end is locked, the A end is moving in a backward direction. When the middle actuator 5110 is contracted, the unlocked end is pulled toward the rest of the GLA 5100 due to the force of elastic deformation of the C side spring 5112C and the D side spring 5112D and a loading force in the backward direction. When the middle actuator 5110 is extended, it works against the force of elastic deformation of the C side spring 5112C and the D side spring 5112D and against a load force in a forward direction. This load force is applied via the loading force rod 5118 mounted into the rod aperture 5114. Alternatively, the load can be provided by a different way via a rope, wire, rod, tendon or anything similar mounted to the rod aperture 5114 or welded directly the frame 5100F with or without the help of the rod aperture 5114.

The frequency of repeating steps depends on the own frequency of the middle actuator 5110 and the mechanical properties of the frame 5100F. For example, with solenoid actuators, the GLA 5100 may make low-frequency long steps, while with piezo actuators, the GLA 5100 may make high-frequency short steps. The speed of the locomotion depends on these parameters. The load ability depends on the amounts of force provided by actuators and the value of friction force generated by the contact of the legs 5116 and a surface being traversed, such as the track 5120.

It is important to note that that the friction force between the legs 5116 and the track 5120 is useful in a vertical part of a cutout, and is a parasite force in the horizontal parts of a cutout. Said differently, if the GLA 5100 is moving horizontally then friction with the track 5120 will drag and slow down the GLA 5100 motion, but if the GLA is climbing a vertical track, the friction between feet 5116 and track 5120 is necessary for countering gravity, and higher friction means less slipping back downward. The useful part of this force can be enhanced by using a special material or a coating for vertical walls and the vertical surface of the leg's tip. Friction can also be selectively enhanced by using dents or scratches on vertical surfaces. The parasite part of the force can be lowered by adding a sliding coating of horizontal surface, using balls like in bearings, or using a magnetic field or an air pillow.

The design of the GLA 5100 provides a broad degree of flexibility in application, with some limits. The bilateral symmetry along the C-D axis is dictated by the technical specifications of available piezoelectric actuators for implementation as the A end clamp actuator 5106A, the middle actuator 5110, and the B end clamp actuator 5106B, and further necessitates that the sides of the track 5120 or similar guide be parallel and uniform in distance apart; without this, it's possible that the piezoelectric actuators could be overstressed and break down. The design doesn't require the two sides of the track 5120 to be completely smooth or identical, can cope even if the track 5120 experiences shocks or vibrations, and can be made of lightweight or not fully rigid materials. The flat form of the device has a significant value during the implementation of the GLA device. The frame can be implemented by cutting, pressing or 3D printing. In all cases the flat form of the device significantly simplifies the manufacturing process. Depending on the material it is possible to use for cutting such processes as computer numerical control machining, laser or water cutting, electrical discharge machining, or any other similar approaches.

Referring now generally to the Figures and particularly to FIG. 51D, FIG. 51D is a line drawing presenting the three piezoelectric actuators of the GLA 5100—the A end clamp actuator 5106A, the middle actuator 5110, and the B end clamp actuator 5106B—in isolation.

Referring now generally to the Figures and particularly to FIG. 51E, FIG. 51E is a line drawing presenting the frame 5100F of the GLA 5100 in isolation, without the A end clamp actuator 5106A, the middle actuator 5110, or the B end clamp actuator 5106B.

Generally speaking, the Guided Linear Actuator (GLA 5100) is able to move linearly over a guide against a force. The guide may be implemented as a bar, wire, a rail with a special profile, or with multiple wires or rails. Further embodiments of the GLA 5100 using bars or rails are presented later on herein. The GLA contains 3 simple actuators (for example, piezo or solenoid) as described above, and a metal, plastic or ceramics frame 5100F. The frame 5100F may be implemented as one piece or assembled with several pieces. The GLA 5100 can be implemented as a Holding GLA and it is holding its position when power is off. Or, the GLA 5100 can be implemented as a Nonholding GLA, and it is sliding along the guide(s) when power is off. The GLA 5100 locomotion is implemented with steps (or cycles). During every step, the GLA 5100 is performing the following phases:
1. Zero positioning, when the GLA 5100 is not active and doesn't spend energy.
Moving forward. (From A to B direction)
   2. Hold the A-end with clamps. B-end is released. Extend the middle actuator.
   3. Hold the B-end
   4. Release A-end
   5. Contract the middle actuator

Repeating the steps 2-5 will move the actuator over the guide. This locomotion is relative. This means that we may say that the car is moving along the guide, or we may say that the guide is being moved along relative to the car.
Moving backward. (From B to A)
   2. Hold the B-end with clamps. A-end is released. Extend the middle actuator.
   3. Hold the A-end
   4. Release B-end
   5. Contract the middle actuator

Repeating the steps 2-5 will move the actuator over the guide in the back direction.

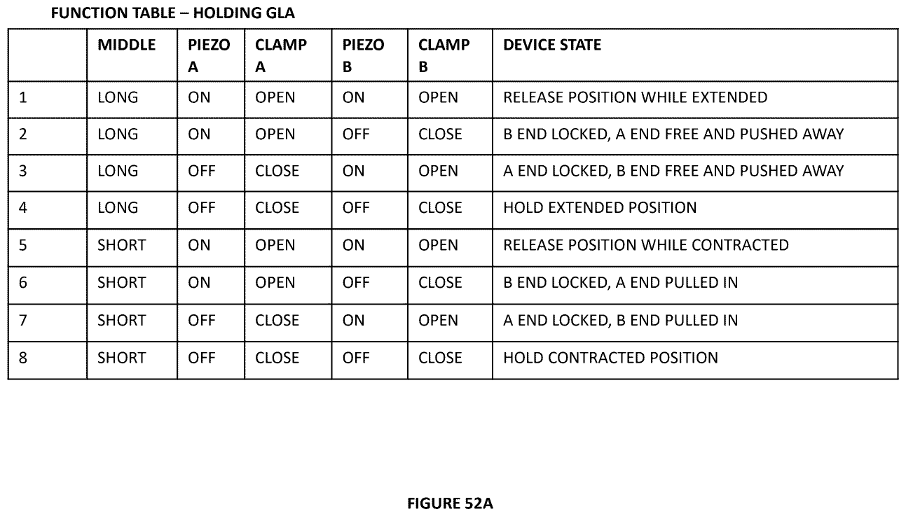

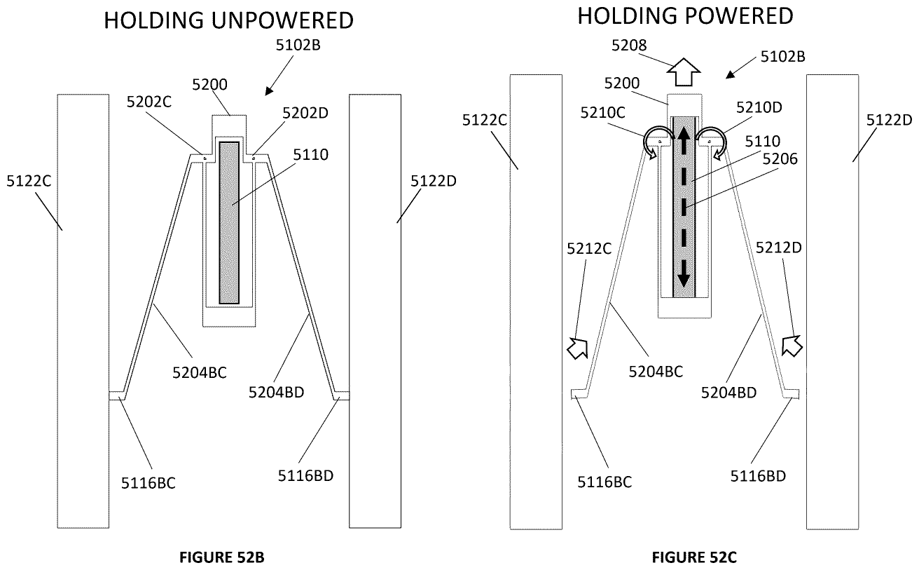

Referring now generally to the Figures and particularly to FIG. 52A, FIG. 52A is a table regarding actuator states of the GLA 5100 as a holding GLA. Because the GLA 5100 of FIG. 51A is a holding model, the A end clamp 5102A and the B end clamp 5102B each remain closed by default when their respective piezoelectric actuators, the A end clamp actuator 5106A and the B end clamp actuator 5106B respectively, are not powered, and disengage only when powered. It is noted that a piezoelectric actuator provides controllable powered motion because piezoelectric material has the property of expanding when and if provided electrical current; the frame of a holding model of clamp 5102 is shaped such that, when the clamp actuator 5106 of that clamp 5102 expands as a result of receiving electrical power, the clamp 5102 opens, and when the clamp actuator 5106 of that clamp 5102 contracts as a result of not receiving electrical power, the clamp 5102 closes. On the GLA 5100 as presented in FIG. 51A, the MIDDLE would be the middle section 5104 (comprising both the middle actuator 5110 and the middle body 5112), the PIEZO A would be the A end clamp actuator 5106A, the CLAMP A would be the A end clamp 5102A, the PIEZO B would be the B end clamp actuator 5106B, and the CLAMP B would be the B end clamp 5102B, but the presented table might apply to any “holding” model of linear actuator having two clamps 5102. It is noted that there is no “holding” or “nonholding” aspect to the middle section 5104; unlike the clamps 5102, the relevant states are not RELEASE or HOLD, but rather extended (LONG) or contracted (SHORT). Whether the middle section 5104 remains long until contracted, or remains short until extended, is a different range of variation. A column is included to represent the state of the middle section 5104 as a whole but not the state of the middle actuator 5110, as the correlation of middle actuator 5110 state (ON or OFF) to middle section 5104 state (LONG or SHORT) is a different kind of design variation unrelated to holding/nonholding clamps, and what's relevant in this table is merely whether the middle section 5104 is extended (LONG) or contracted (SHORT).

It is noted that the number of possible outputs for a function is the product of multiplying together the number of possible values of each input variable; in this case, there are three input variables with two possible values each, therefore a complete table of all combinations of variable inputs contains eight rows as presented. Though the values used in this table are ON or OFF for piezoelectric actuators, RELEASE or HOLD for clamps, and LONG or SHORT for the middle section 5104, the presented table might be understood as relevantly similar to a Boolean truth table as utilized at least in the fields of formal logic, computer science, electrical engineering, and more.

The first row of the table is a header row, and is not numbered. Row 1 of the table contains the GLA 5100 state wherein both clamps 5102 are open and the middle section 5104 is extended. Since this is a holding model, both clamp actuators 5106 are powered ON—i.e. provided with electrical current—to make each clamp 5102 RELEASE. (It is noted that this can be usefully contrasted with the nonholding table of FIG. 54A, wherein a clamp actuator 5106 state of ON corresponds to and produces a clamp 5102 state of HOLD instead.) In row 2 of the table, the middle section 5104 is extended, CLAMP A is powered on and open, and CLAMP B is powered off and closed. Therefore, the GLA 5100 is held in place on the B end, the A end is free to move, and the middle section 5104 is extended, thus resulting in the B end being locked in place and the A end being pushed or held distant from the B end. In row 3 of the table, the middle section 5104 is extended, CLAMP B is powered on and open, and CLAMP A is powered off and closed. Therefore, the GLA 5100 is held in place on the A end, the B end is free to move, and the middle section 5104 is extended, thus resulting in the A end being locked in place and the B end being pushed or held distant from the A end. In row 4 of the table, both clamp actuators 5106 are powered off, therefore both clamps 5102 are engaged and the GLA 5100 is locked in place in an extended position. In row 5 of the table, the middle section 5104 is short or contracted and both clamp actuators 5106 are powered on, therefore both clamps 5102 are disengaged and the GLA 5100 is not locked on either side. In row 6 of the table, the middle section 5104 is short or contracted, CLAMP A is powered on and open, and CLAMP B is powered off and closed. Therefore, the GLA 5100 is held in place on the B end, the A end is free to move, and the middle section 5104 is short, thus resulting in the B end being locked in place and the A end being pulled in close to the B end. In row 7 of the table, the middle section 5104 is short, CLAMP B is powered on and open, and CLAMP A is powered off and closed. Therefore, the GLA 5100 is held in place on the A end, the B end is free to move, and the middle section 5104 is contracted, thus resulting in the A end being locked in place and the B end being pulled toward or held close to the A end. In row 8 of the table, both clamp actuators 5106 are powered off, therefore both clamps 5102 are engaged and the GLA 5100 is locked in place in a short position.

It is further noted that the inchworm actuator motion described elsewhere herein can be mapped to the states of this table, beginning at the state of row 5 with both clamps 5102 disengaged and the middle section 5104 not extended, as follows. To move toward A: row 5 (start out unclamped and short), row 6 (lock B), row 2 (extend with B locked), row 4 (lock both), row 3 (unlock B), row 7 (pull B up behind), row 8 (new position reached). To move toward B: row 5 (start out unclamped and short), row 7 (lock A), row 3 (extend with A locked), row 4 (lock both), row 2 (unlock A), row 6 (pull A up behind), row 8 (new position reached). It is noted that row 1 (middle section LONG, both clamps RELEASE) is a possible permutation of actuator states, but may not be generally used in the regular locomotion cycle of the device.

Referring now generally to the Figures and particularly to FIG. 52B, FIG. 52B is a line diagram presenting the B end clamp 5102B as an example instance of a HOLDING clamp for the purpose of further discussion regarding the mechanical relationship of powering the B end clamp actuator 5106B resulting in the BC foot 5116BC and the BD foot 5116BD of the B end clamp 5102B disengaging from the C side cutout 5122C and the D side cutout 5122D (respectively) of the track 5120 (not shown). A frame shape of the B end clamp 5102B may further comprise or include a shoulder 5200, a C side fulcrum zone 5202C pivoting between the shoulder 5200 and a C side leg 5204C, and a D side fulcrum zone 5202D pivoting between the shoulder 5200 and a D side leg 5204D. FIG. 52B presents the B end clamp 5102B in a non-powered state, which, since the B end clamp 5102B is a HOLDING model of clamp, means that the B end clamp 5102B is engaged with and holding position on the track 5120 until disengaged by providing electrical power. It is further noted that the B end clamp 5102B was selected arbitrarily as an example of a holding clamp for the purpose of demonstrating concepts that can also be more broadly applied to holding clamps overall. FIG. 52B presents this clamp in an OFF (unpowered) state, and FIG. 52C presents the same clamp in an ON (powered) state.

Referring now generally to the Figures and particularly to FIG. 52C, FIG. 52C is a diagram of the B end clamp 5102B in a powered state. When the B end clamp actuator 5106B is powered ON, the B end clamp actuator 5106B expands in volume as indicated by a first arrow 5206, and pushes against the shoulder 5200. In turn, the shoulder 5200 shifts position as shown by a second arrow 5208, and pivots the C side fulcrum zone 5202C and the D side fulcrum zone 5202D as shown by a third arrow 5210C and a fourth arrow 5210D, narrowing the angles between the shoulder 5200 and the C side leg 5204C and between the shoulder 5200 and the D side leg 5204D and causing the BC foot 5116BC and the BD foot 5116BD to be pulled inward as shown by a fifth arrow 5212C and a sixth arrow 5212D.

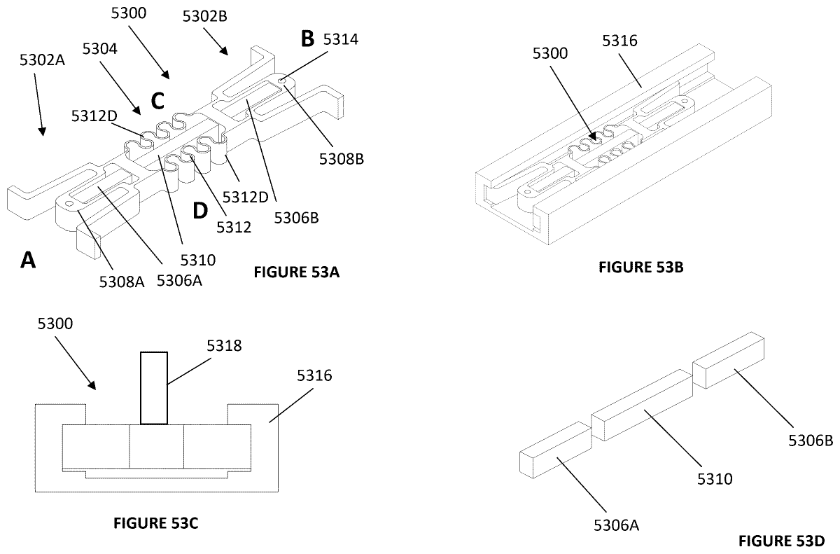

Referring now generally to the Figures and particularly to FIG. 53A, FIG. 53A is a line diagram presenting a nonholding embodiment of the GLA 5100, namely a nonholding GLA 5300. It is noted that the distinction between a holding embodiment and a nonholding embodiment is that a holding embodiment maintains a “closed clamp” position as an unpowered default and requires electrical power in order to disengage clamps, while a nonholding embodiment maintains an “open clamp” position by default and requires electrical power in order to engage clamps. Which of these options might be preferred for any given clamp or actuator machine is a matter of what application is intended. The nonholding GLA 5300 may further include or comprise a pair of nonholding clamps 5302, individually an A end nonholding clamp 5302A and a B end nonholding clamp 5302B, at either end of a nonholding GLA middle section 5304. Each of the two nonholding clamps 5302 further comprises each of a pair of two nonholding GLA clamp actuators 5306 and a pair of two nonholding clamp bodies 5308, individually an A end nonholding GLA clamp actuator 5306A and an A end nonholding clamp body 5308A of the A end nonholding clamp 5302A, and a B end nonholding GLA clamp actuator 5306B and a B end nonholding clamp body 5308B of the B end nonholding clamp 5302B. The nonholding GLA middle section 5304 further comprises a nonholding GLA middle actuator 5310 and a nonholding GLA middle body 5312, which further comprises a nonholding GLA C side spring 5312C and a nonholding GLA D side spring 5312D. The GLA 5300 may also comprise a nonholding GLA rod aperture 5314 at one end of the nonholding GLA 5300, into which is fitted a nonholding GLA loading force rod 5318 as presented and discussed later starting at FIG. 51C.

Referring now generally to the Figures and particularly to FIG. 53B, FIG. 53B is a line diagram presenting the nonholding GLA 5300 on a nonholding GLA track 5316.

Referring now generally to the Figures and particularly to FIG. 53C, FIG. 53C is a line diagram presenting a FRONT view of the nonholding GLA 5300 and the nonholding GLA track 5316, further presenting a nonholding GLA loading force rod 5318.

Referring now generally to the Figures and particularly to FIG. 53D, FIG. 53D is a line diagram presenting the three actuators of the nonholding GLA 5300 in isolation, specifically the

A end nonholding GLA clamp actuator 5306A, the B end nonholding GLA clamp actuator 5306B, and the nonholding GLA middle actuator 5310.

Referring now generally to the Figures and particularly to FIG. 54A, FIG. 54A is a table regarding actuator, clamp, and device states of the nonholding GLA 5300 as a nonholding GLA.

Because the nonholding GLA 5100 of FIG. 53A is a nonholding model, the A end nonholding clamp 5302A and the B end nonholding clamp 5302B each remain open by default when their respective piezoelectric actuators, the A end nonholding GLA clamp actuator 5306A and the B end nonholding GLA clamp actuator 5306B respectively, are not powered, and engage only when powered. It is noted that a piezoelectric actuator provides controllable powered motion because piezoelectric material has the property of expanding when and if provided electrical current; the frame of one of the nonholding clamps 5302 is shaped such that, when the nonholding GLA clamp actuator 5306 of the nonholding clamp 5302 expands as a result of receiving electrical power, the clamp 5102 closes, and when the nonholding GLA clamp actuator 5306 of the nonholding clamp 5302 contracts as a result of not receiving electrical power, the nonholding clamp 5302 opens.

On the GLA 5300 as presented in FIG. 53A, the MIDDLE would be the nonholding GLA middle section 5304 (comprising both the nonholding GLA middle actuator 5310 and the nonholding GLA middle body 5312), the PIEZO A would be the A end nonholding GLA clamp actuator 5306A, the CLAMP A would be the A end nonholding clamp 5302A, the PIEZO B would be the B end nonholding GLA clamp actuator 5306B, and the CLAMP B would be the B end nonholding clamp 5102B, but the presented table might apply to any “nonholding” model of linear actuator having two nonholding clamps 5302.

It is noted that the number of possible outputs for a function is the product of multiplying together the number of possible values of each input variable; in this case, there are three input variables with two possible values each, therefore a complete table of all combinations of variable inputs contains eight rows as presented. Though the values used in this table are ON or OFF for piezoelectric actuators, RELEASE or HOLD for clamps, and LONG or SHORT for the middle section, the presented table might be understood as relevantly similar to a Boolean truth table as utilized at least in the fields of formal logic, computer science, electrical engineering, and more.

The first row of the table is a header row, and is not numbered. Row 1 of the table contains the nonholding GLA 5300 state wherein both of the nonholding clamps 5302 are open and the middle section 5304 is extended. Since this is a nonholding model, both of the nonholding GLA clamp actuators 5306 are powered OFF—i.e. not provided with electrical current—to make each of the nonholding clamps 5302 RELEASE. (It is noted that this can be usefully contrasted with the holding GLA table of FIG. 52A, wherein the clamp actuator 5106 state of OFF corresponds to and produces the nonholding clamp 5302 state of HOLD instead. It is further noted that this table was adapted from the table of FIG. 52A by simply inverting the values in the two PIEZO columns; the device states resulting from the clamp and middle states don't change, all that changes between these two tables is which piezo state corresponds to which clamp state.) In row 2 of the table, MIDDLE is extended, CLAMP A is powered off and open, and CLAMP B is powered on and closed. Therefore, the nonholding GLA 5300 is held in place on the B end, the A end is free to move, and the middle section 5104 is extended, thus resulting in the B end being locked in place and the A end being pushed or held distant from the B end. In row 3 of the table, the middle section 5104 is extended, CLAMP B is powered off and open, and

CLAMP A is powered on and closed. Therefore, the nonholding GLA 5300 is held in place on the A end, the B end is free to move, and the middle section 5104 is extended, thus resulting in the A end being locked in place and the B end being pushed or held distant from the A end. In row 4 of the table, both clamp actuators 5106 are powered on, therefore both clamps 5102 are engaged and the GLA 5100 is locked in place in an extended position. In row 5 of the table, the middle section 5104 is short or contracted and both clamp actuators 5106 are powered off, therefore both clamps 5102 are disengaged and the GLA 5100 is not locked on either side. In row 6 of the table, the middle section 5104 is short or contracted, CLAMP A is powered off and open, and CLAMP B is powered on and closed. Therefore, the GLA 5100 is held in place on the B end, the A end is free to move, and the middle section 5104 is short, thus resulting in the B end being locked in place and the A end being pulled in close to the B end. In row 7 of the table, the middle section 5104 is short, CLAMP B is powered off and open, and CLAMP A is powered on and closed. Therefore, the GLA 5100 is held in place on the A end, the B end is free to move, and the middle section 5104 is contracted, thus resulting in the A end being locked in place and the B end being pulled toward or held close to the A end. In row 8 of the table, both clamp actuators 5106 are powered on, therefore both clamps 5102 are engaged and the GLA 5100 is locked in place in a short position.

Referring now generally to the Figures and particularly to FIG. 54B, FIG. 54B is a line diagram presenting the B end nonholding clamp 5302B as an example instance of a NONHOLDING clamp, for the purpose of further discussion regarding the mechanical relationship of the table of FIG. 54A as applied in the context of operation of the nonholding GLA 5300, wherein, for a NONHOLDING clamp 5302, an actuator OFF state produces a RELEASE (i.e. disengaged) clamp state, while an actuator ON state produces a HOLD (i.e. engaged) clamp state wherein the B end nonholding clamp 5302B engages with the track 5316 (specifically here, a track C side 5316C and a track D side 5316D). A frame shape of the B end clamp 5302B may further comprise or include a nonholding clamp shoulder 5400, a nonholding clamp C side fulcrum zone 5402C pivoting between the nonholding clamp shoulder 5400 and a C side nonholding clamp leg 5404C, and a D side nonholding clamp fulcrum zone 5402D pivoting between the nonholding clamp shoulder 5400 and a D side nonholding clamp leg 5404D. FIG. 54B presents the B end nonholding clamp 5302B in a non-powered state, which, since the B end clamp 5302B is a NONHOLDING model of clamp, means that the B end nonholding clamp 5302B is disengaged with and not holding position on the track 5316 until engaged by providing electrical power. It is further noted that the B end nonholding clamp 5302B was selected arbitrarily as an example of a nonholding clamp for the purpose of demonstrating concepts that can also be more broadly applied to nonholding clamps overall. FIG. 54B presents this clamp in an OFF (unpowered) state, and FIG. 54C presents the same clamp in an ON (powered) state.

Referring now generally to the Figures and particularly to FIG. 54C, FIG. 54C is a diagram of the B end nonholding clamp 5302B in a powered (ON) state. When the B end nonholding clamp actuator 5306B is powered, the B end nonholding clamp actuator 5306B expands in volume as indicated by a first arrow 5406, and pushes against the nonholding clamp shoulder 5400, pushing the nonholding clamp shoulder 5400 in the direction of a second arrow 5408 as shown. This motion, in turn, distorts the frame such that the nonholding clamp C side fulcrum zone 5402C and the D side nonholding clamp fulcrum zone 5402D shift position, pivoting inward as shown by a third arrow 5410C and a fourth arrow 5410D and levering the C side nonholding clamp leg 5404C and the D side nonholding clamp leg 5404D outward to engage with the track 5316 as shown by a fifth arrow 5412C and a sixth arrow 5412D.

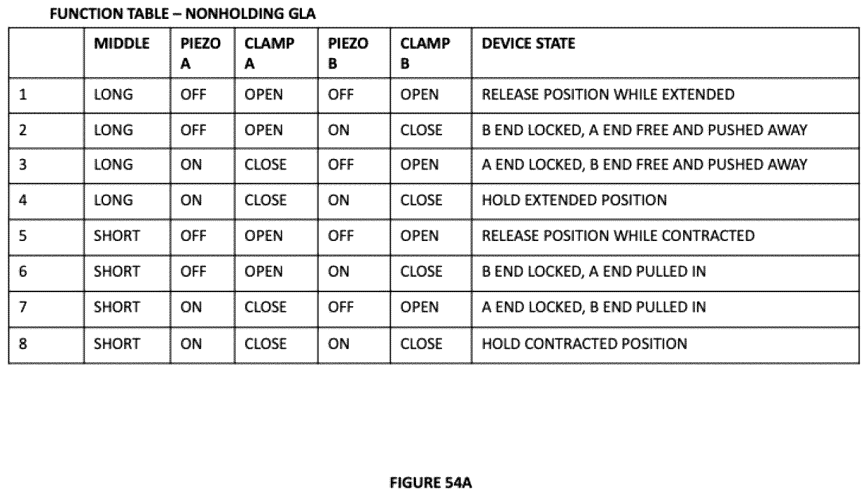

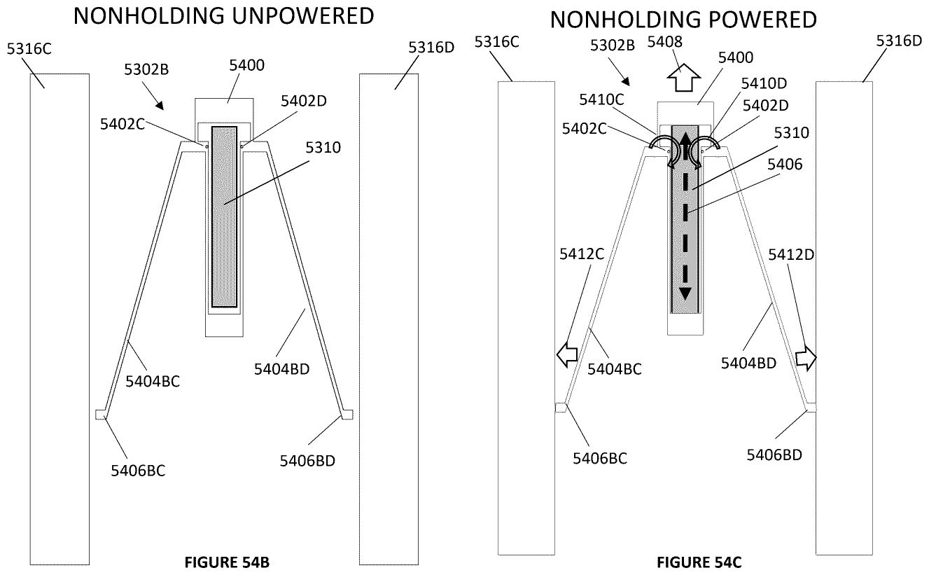

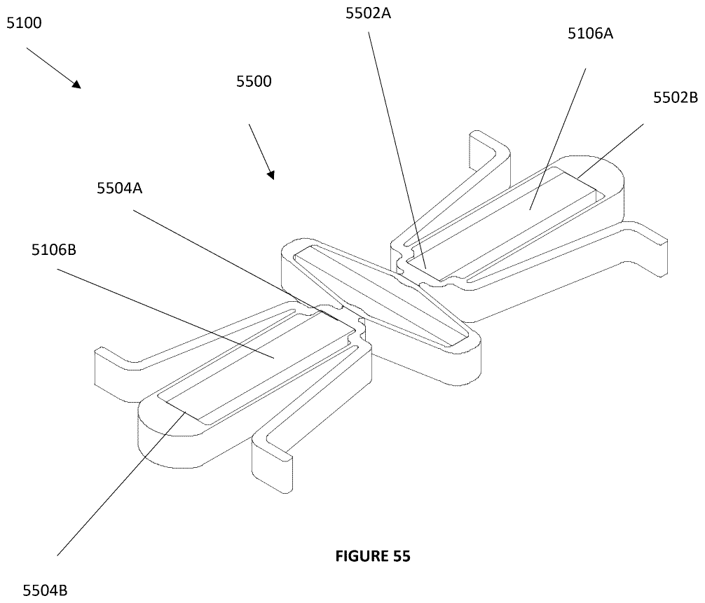

Referring now generally to the Figures and particularly to FIG. 55, FIG. 55 is a line diagram presenting an embodiment of the GLA 5100 which has an amplifying middle section 5500. This is a variation in the shape of the middle section 5104 designed to amplify the displacement exhibited by the middle actuator 5110. A first extended end 5502A and a first rooted end 5502B of the A end clamp actuator 5106A is noted as are a second extended end 5504A and a second rooted end 5504B of the B end clamp actuator 5106A are denoted in FIG. 55.

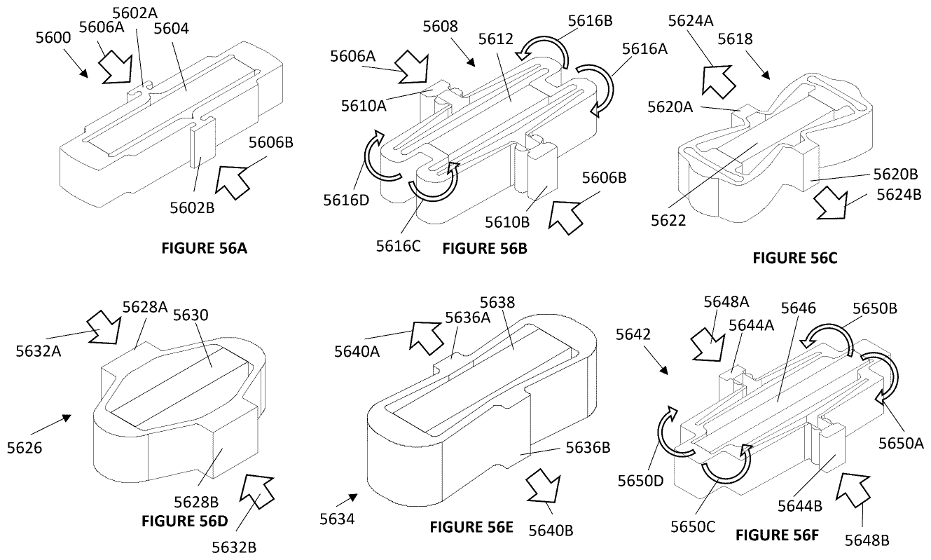

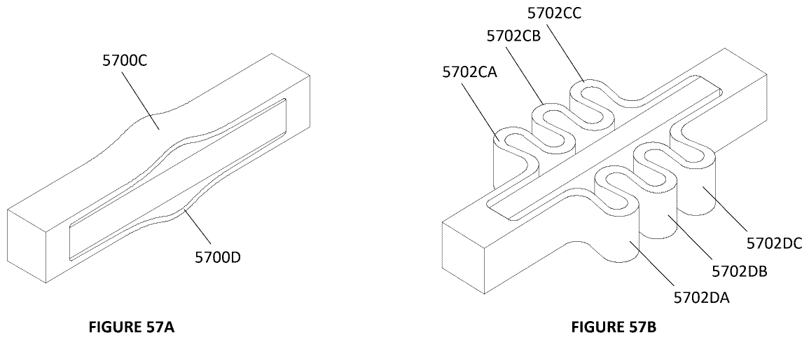

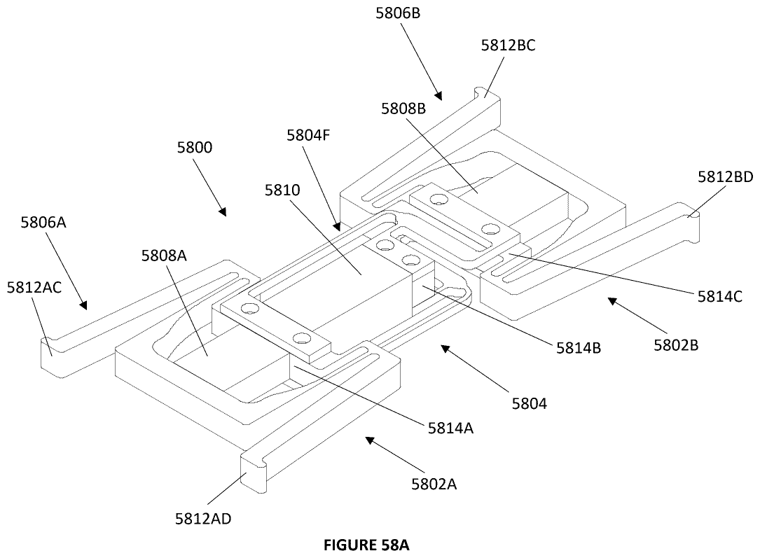

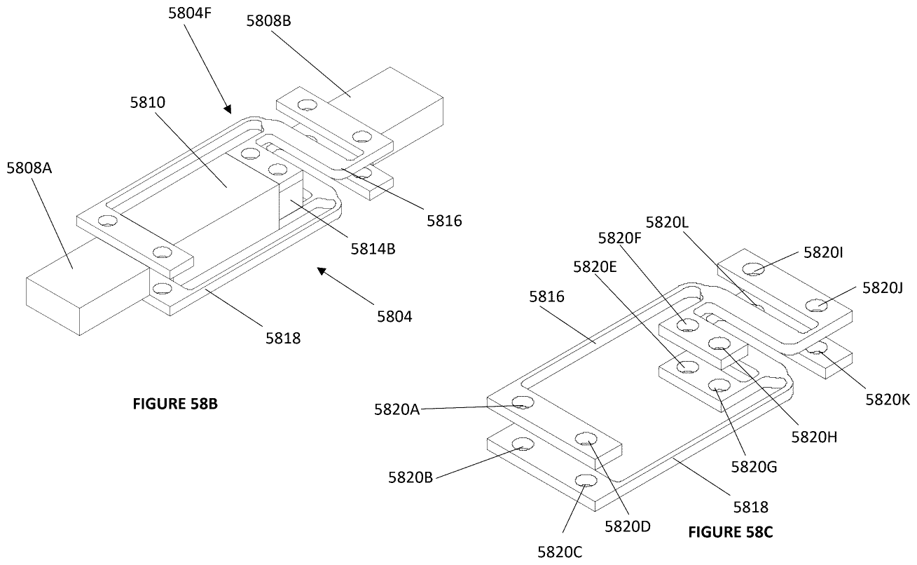

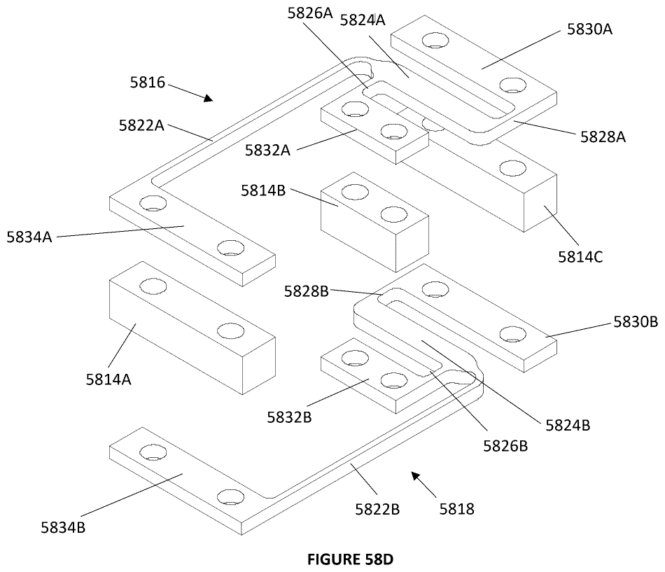

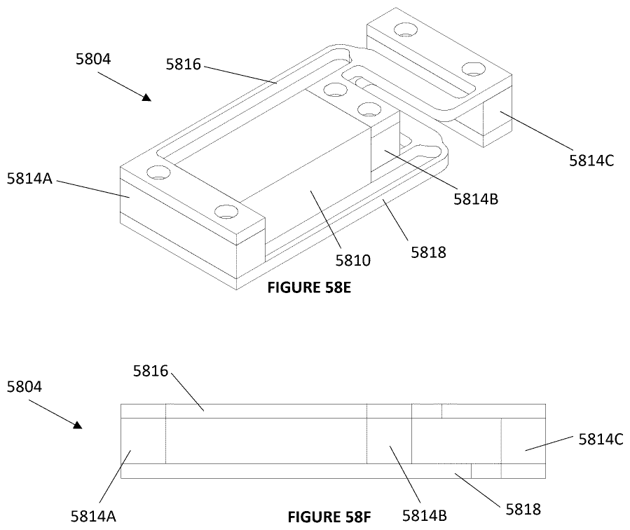

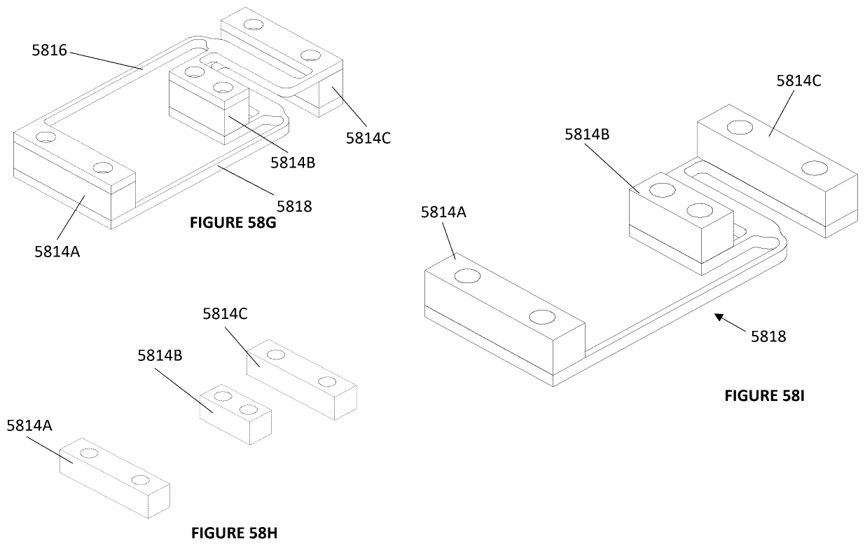

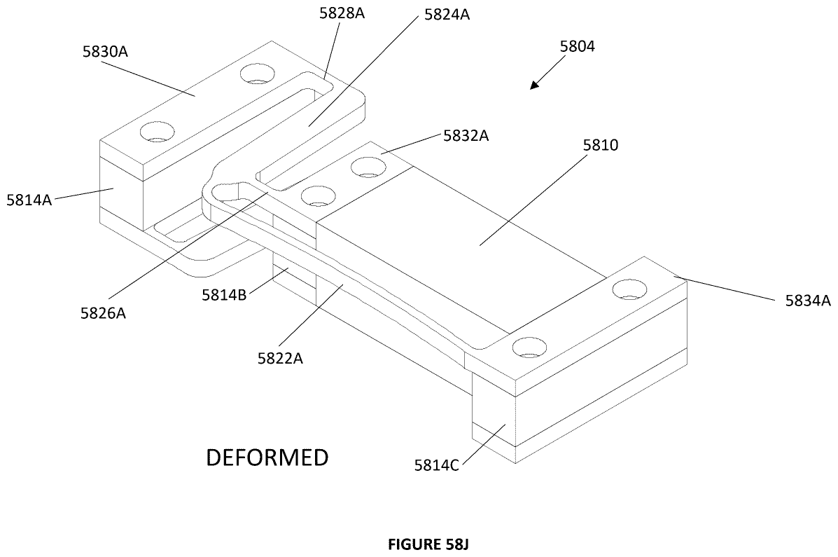

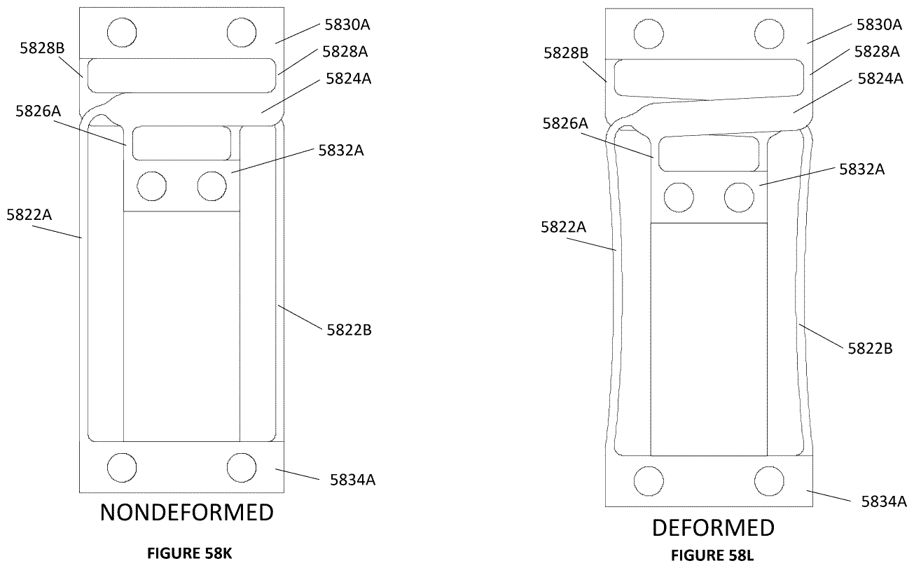

It is noted that a wide variety of embodiments of the GLA 5100 having various different specialties, capabilities, and applications might be built by mixing-and-matching preferred middle section shapes (such as the amplifying middle section 5500 of FIG. 55, the middle section variations presented in FIGS. 56A through 57B, or aspects of the amplified push mechanism of FIGS. 58A through 58D) with preferred clamp designs (such as either holding or nonholding, but further also including a variety of clamp shapes within those categories, such as those of FIGS. 60A through 60F).

Referring now generally to the Figures and particularly to FIG. 56A, FIG. 56A is a line diagram presenting a first additional alternative variation of the middle section 5104 shape of the GLA 5100, a first alternative contracting middle design 5600. Just as the clamps 5102 of the GLA 5100 can be designed to be either holding or nonholding, the middle section 5104 can be designed to be either “contracting” or “extending”; i.e. “LONG by default until powered to contract” or “SHORT by default until powered to extend”. Please additionally note the function tables of FIGS. 60A and 60B. When the middle section 5104 is SHORT, the A end and the B end of the middle section 5104 are positioned comparatively close together; alternatively, when the middle section 5104 is LONG, the A end and the B end are positioned comparatively far apart. By modifying the shape of the middle section 5104 frame elements and which direction the middle actuator 5110 extends, one can, as presented here, create an embodiment of the middle section 5104 wherein extension of the middle actuator 5110 causes the A end and the B end to be pulled together, producing a SHORT state.

FIG. 56A presents the first alternative contracting middle 5600, having a pair of first middle ends 5602 (a first middle A end 5602A and a first middle B end 5602B), and a first middle actuator stack 5604, wherein the default unpowered state of the first alternative contracting middle 5600 is LONG, and providing electrical power to the first middle actuator stack 5604 causes the first alternative contracting middle 5600 to pull the first middle ends 5602 INWARD and contract to a SHORT state. It is noted that the first middle actuator stack 5604 is positioned orthogonally to the first middle ends 5602, such that expansion of first middle actuator stack 5604 pulls the first middle ends 5602 towards each other, as shown by a pair of first middle contraction arrows 5606 (individually, an A end first middle contraction arrow 5606A and a B end first middle contraction arrow 5606B). The first alternative contracting middle 5600 is presented in a powered state, with the first middle actuator stack 5604 fully extended.

Referring now generally to the Figures and particularly to FIG. 56B, FIG. 56B is a line diagram presenting a second additional alternative variation of the middle section 5104 shape of the GLA 5100, a second alternative middle design 5608 (“the second middle 5608”) having a pair of second middle ends 5610 (a second middle A end 5610A and a second middle B end 5610B), and a second middle actuator stack 5612. The second alternative middle 5606 is presented in a powered state, with the second middle actuator stack 5610 fully extended, resulting in the second middle ends 5608 of the second alternative middle 5606 being contracted together in a SHORT position, as shown by a pair of second middle contraction arrows 5614 (individually, an A end second middle contraction arrow 5614A and a B end second middle contraction arrow 5614B). Additional second middle curving arrows 5616A through 5616D (individually, a second middle curving arrow #1 5616A, a second middle curving arrow #2 5616B, a second middle curving arrow #3 5616C, and a second middle curving arrow #4 5616D) further describe motion and contortion of frame elements in response to being pushed on by extension of the second middle actuator stack 5612.

Referring now generally to the Figures and particularly to FIG. 56C, FIG. 56C is a line diagram presenting a third additional alternative variation of the middle section 5104 shape of the GLA 5100, a third alternative middle design 5618 (“the third middle 5618”) having a pair of third middle ends 5620 (a third middle A end 5620A and a third middle B end 5620B), and a third middle actuator stack 5622. The third middle 5618 is presented in a powered state, with the third middle actuator stack 5622 fully extended, resulting in the third middle ends 5620 of the third middle 5618 being pushed apart in a LONG position, as shown by a pair of third middle expansion arrows 5624 (individually, an A end third middle expansion arrow 5624A and a B end third middle expansion arrow 5624B). It is noted that this is an EXTENDING model, with a default SHORT position and a powered LONG position, whereas the designs of FIGS. 56A and 56B were CONTRACTING models, with a default LONG position which contracts to a SHORT position when powered.

Referring now generally to the Figures and particularly to FIG. 56D, FIG. 56D is a line diagram presenting a fourth additional alternative variation of the middle section 5104 shape of the GLA 5100, a fourth alternative middle design 5626 (“the fourth middle 5626”) having a pair of fourth middle ends 5628 (a fourth middle A end 5628A and a fourth middle B end 5628B), and a fourth middle actuator stack 5630. The fourth middle 5626 is a CONTRACTING model, and is presented here in a powered state, with the fourth middle actuator stack 5630 fully extended, resulting in the fourth middle ends 5628 being pulled together in a SHORT position, as shown by a pair of fourth middle contraction arrows 5632 (individually, an A end fourth middle contraction arrow 5632A and a B end fourth middle contraction arrow 5632B).

Referring now generally to the Figures and particularly to FIG. 56E, FIG. 56E is a line diagram presenting a fifth additional alternative variation of the middle section 5104 shape of the GLA 5100, a fifth alternative middle design 5634 (“the fifth middle 5634”) having a pair of fifth middle ends 5636 (a fifth middle A end 5636A and a fifth middle B end 5636B), and a fifth middle actuator stack 5638. The fifth middle 5634 is presented in a powered state, with the fifth middle actuator stack 5638 fully extended, resulting in the fifth middle ends 5636 of the fifth middle 5634 being extended apart in a LONG position, as shown by a pair of fifth middle expansion arrows 5640 (individually, an A end fifth middle expansion arrow 5640A and a B end fifth middle expansion arrow 5640B).

Referring now generally to the Figures and particularly to FIG. 56F, FIG. 56F is a line diagram presenting a sixth additional alternative variation of the middle section 5104 shape of the GLA 5100, a sixth alternative middle design 5642 (“the sixth middle 5642”) having a pair of sixth middle ends 5644 (a sixth middle A end 5644A and a sixth middle B end 5644B), and a sixth middle actuator stack 5646. The sixth middle 5642 is presented in a powered state, with the sixth middle actuator stack 5646 fully extended, resulting in the sixth middle ends 5644 of the sixth middle 5642 being pulled together in a SHORT position, as shown by a pair of sixth middle expansion arrows 5648 (individually, an A end sixth middle contraction arrow 5648A and a B end sixth middle contraction arrow 5648B). An additional set of sixth middle curving arrows 5650A through 5650D (individually, a sixth middle curving arrow #1 5650A, a sixth middle curving arrow #2 5650B, a sixth middle curving arrow #3 5650C, and a sixth middle curving arrow #4 5650D) further describe motion and contortion of frame elements in response to being pushed on by extension of the sixth middle actuator stack 5646.

Referring now generally to the Figures and particularly to FIG. 57A, FIG. 57A is a line drawing presenting a first visual aid regarding the further discussion below of modifying the shape of the middle section 5104. This embodiment of the middle section 5104 has just one curve 5700 on each side, specifically a C-side curve 5700C and a D-side curve 5700D.

The image of FIG. 57A presents a version of the middle section 5104 with just one slight curve; the image of FIG. 57B presents a version of the middle section 5104 with several curves. The mechanical advantage to adding more curves to a design for the middle section 5104 is similar to the effect of a spring: when the middle actuator 5110 expands, the middle section body 5112 stores less mechanical energy, and this energy is returned when the middle actuator 5110 contracts again. By selecting alternate spring coefficients, the designer can vary this effect as preferred.

Referring now generally to the Figures and particularly to FIG. 57B, FIG. 57B is a line drawing presenting a second visual aid regarding the above discussion of modifying the shape of the middle section 5104. This embodiment of the middle section 5104 has multiple curves 5700 on each side, specifically a first C-side curve 5702CA, a second C-side curve 5702CB, a third C-side curve 5702CC, a first D-side curve 5702DA, a second D-side curve 5702DB, and a third D-side curve 5702DC.

Referring now generally to the Figures and particularly to FIG. 58A, FIG. 58A is a line drawing presenting an amplified push GLA 5800, which is an embodiment of the GLA 5100 which is optimized for traveling long distances. Generally, a piezoelectric stack extends a short distance with significant force when electrical power is provided; as a rule, this extension is only 1/1000 of the whole piezoelectric stack's length. Therefore, piezoelectric stacks are preferably used in applications performing short, strong, precise steps, such as the “inching” of an inchworm actuator device as discussed herein. However, engineered amplification such as a specialized shape of frame can significantly and usefully facilitate use of piezoelectric stacks in applications where a greater distance of travel is preferred even at the expense of reduced force. As an example, let's consider a piezo stack that is able to generate the force of 100N with a travel distance of 0.1 mm; an amplified actuator which provides a travel range 1 mm and a force of 10N force may still be useful or preferable for many applications. Engineering of a lightweight and minimal version of the frame 5700F is an important factor of this amplification optimization, as carrying extra weight lowers the frequency of the actuator. The amplified push GLA 5800 is presented as an example of an alternative middle section design optimized for longer stroke and greater distance of travel. The amplified push GLA 5800 comprises an amplified push GLA A end 5802A; an amplified push GLA B end 5802B; an amplified push middle section 5804 further comprising an amplified push middle section frame 5804F; an amplified push GLA A-end clamp 5806A; an amplified push GLA B-end clamp 5806B; an amplified push GLA A-end clamp actuator 5808A; an amplified push GLA B-end clamp actuator 5808B; an amplified push middle section actuator 5810; a set of amplified push GLA feet 5812, specifically an amplified push GLA AC foot 5812AC, an amplified push GLA AD foot 5812AD, an amplified push GLA BC foot 5812BC, and an amplified push GLA BD foot 5812BD; and a set of three gaskets 5814, specifically a first gasket 5814A, a second gasket 5814B, and a third gasket 5814C. The design of the amplified push middle section 5804 is further discussed in FIGS. 58B through 58H.

Referring now generally to the Figures and particularly to FIG. 58B, FIG. 58B is a line drawing presenting a first partial assembly of the amplified push GLA 5800. Represented here are the amplified push GLA A-end clamp actuator 5808A; the amplified push GLA B-end clamp actuator 5808B; the amplified push middle section actuator 5810; the amplified push middle section frame 5804F, which is further subdivided into a pair of identical amplified push frame pieces 5816-18, an amplified push first frame piece 5816 and an amplified push second frame piece 5818; and the second gasket 5814B.

Referring now generally to the Figures and particularly to FIG. 58C, FIG. 58C is a line drawing presenting only the pair of identical amplified push frame pieces 5816-18 of the amplified push GLA 5800. The pair of identical amplified push frame pieces 5816-18 may further include a plurality of coupling apertures 5820, specifically a first AP frame coupling aperture 5820A, a second AP frame coupling aperture 5820B, a third AP frame coupling aperture 5820C, a fourth AP frame coupling aperture 5820D, a fifth AP frame coupling aperture 5820E, a sixth AP frame coupling aperture 5820F, a seventh AP frame coupling aperture 5820G, an eighth AP frame coupling aperture 5820H, a ninth AP frame coupling aperture 5820I, a tenth AP frame coupling aperture 5820J, a eleventh AP frame coupling aperture 5820K, and a twelfth AP frame coupling aperture 5820L. The plurality of coupling apertures 5820 may be utilized to couple together the pair of identical amplified push frame pieces 5816-18 and the set of three gaskets 5814 (“the gaskets 5814”) to form the amplified push middle section frame 5804F, such as utilizing bolts and nuts, rivets, or other similar means known in the art. It is further noted that these elements might be coupled together by other means also which don't utilize the coupling apertures 5820, such as but not limited to welding or gluing.

Referring now generally to the Figures and particularly to FIG. 58D, FIG. 58D is an exploded view of the amplified push middle section 5804, specifically the amplified push first frame piece 5816, the amplified push second frame piece 5818, the first gasket 5814A, the second gasket 5814B, and the third gasket 5814C. Each of the pair of identical amplified push frame pieces 5816-18 further comprises an amplified push tendon 5822 (respectively, a first amplified push tendon 5822A and a second amplified push tendon 5822B); an amplified push lever 5824 (respectively, a first amplified push lever 5824A and a second amplified push lever 5824B); a small amplified pusher 5826 (respectively, a first small amplified pusher 5826A and a second small amplified pusher 5826B); a big amplified pusher 5828 (respectively, a first big amplified pusher 5828A and a second big amplified pusher 5828B); a short end base 5830 (respectively, a first short end base 5830A and a second short end base 5830B); a middle base 5832 (respectively, a first middle base 5832A and a second middle base 5832B); and a long end base 5834 (respectively, a first long end base 5834A and a second long end base 5834B). The pair of identical amplified push frame pieces 5816-18 are positioned oppositely, such that the respective tendons 5822 of each of the pair of identical amplified push frame pieces 5816-18 are on different sides of the amplified push GLA 5800.

Referring now generally to the Figures and particularly to FIG. 58E, FIG. 58E is a line drawing presenting additional aspects of the amplified push middle section 5804. The set of three gaskets 5814 are placed between the pair of identical frame pieces 5816-18, forming a distance between the pair of identical frame pieces 5816-18. This distance is needed to allow free movement of the levers 5822, the tendons 5820, the first pushers 5822, and the second pushers 5824.

Referring now generally to the Figures and particularly to FIG. 58F, FIG. 58F is a line drawing presenting a side view of the amplified push middle section 5804. The set of three gaskets 5814 are placed between the pair of identical frame pieces 5816-18, forming a distance between the pair of identical frame pieces 5816-18.

Referring now generally to the Figures and particularly to FIG. 58G, FIG. 58G is a line drawing presenting an additional partial assembly of the amplified push middle section 5804.

The set of three gaskets 5814 are placed between the pair of identical frame pieces 5816-18, forming a distance between the pair of identical frame pieces 5816-18.

Referring now generally to the Figures and particularly to FIG. 58H, FIG. 58H is a line drawing presenting the gaskets 5814 of the amplified push middle section 5804 in isolation.

Referring now generally to the Figures and particularly to FIG. 58I, FIG. 58I is a line drawing presenting a partial assembly of the amplified push actuator middle section 5804. Shown here are the amplified push second frame piece 5818 and the gaskets 5814. Further regarding a leverage system of the amplified push actuator middle section 5804, the amplified push middle section actuator 5810 extends for a small distance and creates a mechanical strain between a lower AP frame section 5830B and a small AP frame section 5832B against the elastic force provided by the second amplified push tendon 5820B via a leverage system between the second amplified push lever 5822B, the second small amplified pusher 5824B, and the second big amplified pusher 5826B. During this movements the second amplified push tendon 5820B pulls the short lever arm of the second amplified push lever 5822B, the second small amplified pusher 5824B composes the turning point of the second amplified push lever 5822B, and a long lever arm of the second amplified push lever 5822B pushes the second big amplified pusher 5826B, which transfers the amplified movement to an upper AP frame section 5834B. It is noted that this is a simplified explanation, and digital modeling of the mechanical stress and behavior of the components involved would more accurately describe exactly what is going on. This extension of the amplified push middle section actuator 5810 may be caused by applying electric voltage, in the case where the amplified push middle section actuator 5810 is a piezoelectric stack or a solenoid, but may be achieved by utilizing any actuation means which produces a similar mechanical pushing effect. For example, some materials can be extended or contracted by changes in temperature and/or pressure.

Further regarding the amplified push GLA 5800 design, the frame elements, including the gaskets 5814 and the pair of identical frame pieces 5816-18, may be implemented as an assembly of several parts, or may also be manufactured as one part for simplification of the manufacturing process. Further, the gaskets 5814 may be implemented as separate parts, may be created by some manufacturing process such as but not limited to coating or material deposition, or may be created by removing some of materials from other components, such as the pair of identical frame pieces 5816-18, by computer numerical control or by etching. The pair of identical frame pieces 5816-18, with or without the gaskets 5814, could be formed by stamping, injection molding, 3D-printing, laser or waterjet cutting, electrical discharge machining, and other technologies. It is further understood that the components of the amplified push GLA 5800 may be directly coupled together, but may also be indirectly coupled together by both being coupled to an adjacent one of the gaskets 5814. The pair of identical frame pieces 5816-18 can be made of various metals or metal alloys, such as steel, titanium, aluminum, etc.; plastic, or even ceramics; it is preferred for the pair of identical frame pieces 5816-18 to be at least somewhat elastic. The amplified push middle section actuator 5810 may be inserted into the amplified push actuator middle section 5804, and the elasticity and mechanical strain of the pair of identical frame pieces 5816-18 will hold the amplified push middle section actuator 5810 in place. The amplified push middle section actuator 5810 might be any extended actuator, such as a piezoelectric stack, electromagnetic solenoid, EAP actuator, electrostatic, or any other actuator.

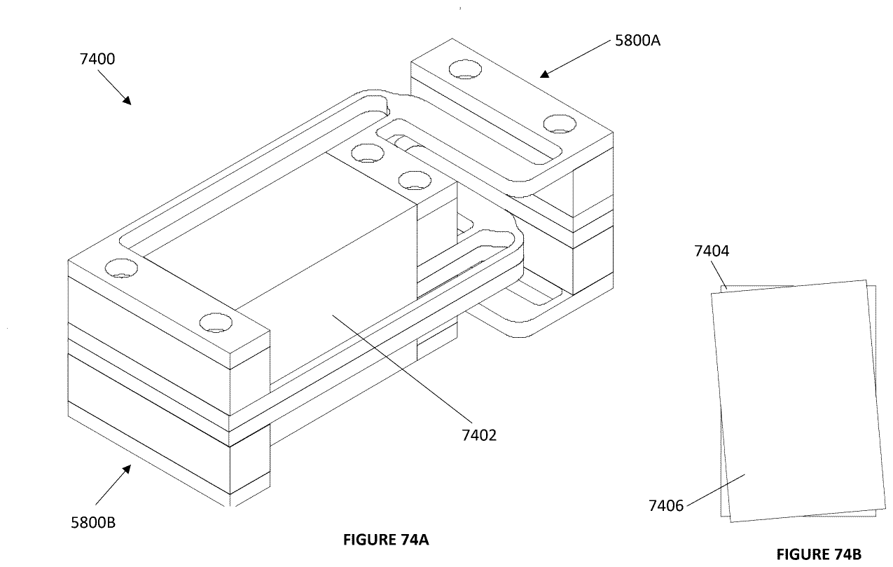

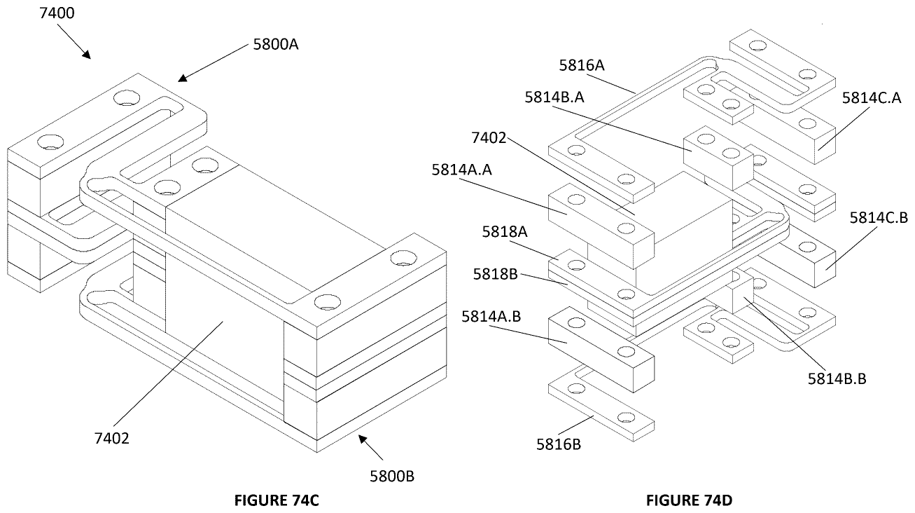

Referring now generally to the Figures and particularly to FIG. 58J, FIG. 58J is a line drawing presenting the amplified push middle section 5804, with bending of lever components exaggerated to demonstrate how expansion of the amplified push middle section actuator 5810 moves and bends components of the amplified push middle section frame 5804F. As the amplified push middle section actuator 5810 expands and pushes against elements of the amplified push middle section frame 5804F, the amplified push middle section frame 5804F distorts and twists as shown here and in FIG. 58L. Labeled here also are the first amplified push tendon 5822A, the first amplified push lever 5824A, the first small amplified pusher 5826A, the first big amplified pusher 5828A, the first short end base 5830A, the first middle base 5832A, and the first long end base 5834A. It is further noted that, while twisting of some frame elements is essential, dis-alignment of opposing ends of the amplified push middle section 5804 relative to each other (i.e. the amplified push GLA A end 5802A being twisted out of alignment with the amplified push GLA B end 5802B) is not preferred. In a small application, particularly with a track, this phenomenon isn't much of a concern, but in applications where this is an issue, FIGS. 74A through 74D discuss an additional relevant solution of stacking two instances of the amplified push GLA 5800 together.

Referring now generally to the Figures and particularly to FIG. 58K, FIG. 58K is a line drawing presenting a top view of the amplified push middle section 5804 in an unpowered state, for comparison alongside FIG. 58L. Labeled here also are the first amplified push tendon 5822A, the first amplified push lever 5824A, the first small amplified pusher 5826A, the first big amplified pusher 5828A, the first short end base 5830A, the first middle base 5832A, and the first long end base 5834A.

Referring now generally to the Figures and particularly to FIG. 58L, FIG. 58L is a line drawing presenting a top view of the amplified push middle section 5804, with bending of lever components exaggerated to demonstrate how expansion of the amplified push middle section actuator 5810 moves components of the amplified push middle section frame 5804F. Labeled here also are the first amplified push tendon 5822A, the first amplified push lever 5824A, the first small amplified pusher 5826A, the first big amplified pusher 5828A, the first short end base 5830A, the first middle base 5832A, and the first long end base 5834A.

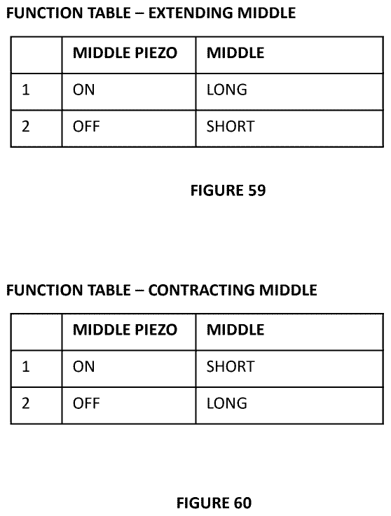

Referring now generally to the Figures and particularly to FIG. 59, FIG. 59 is a function table for an extending middle section embodiment. In row 1, an ON state of the middle actuator 5110 results in a LONG state for the middle section 5104. In row 2, an OFF state of the middle actuator 5110 results in a SHORT state for the middle section 5104.

Referring now generally to the Figures and particularly to FIG. 60, FIG. 60 is a function table for a contracting middle section embodiment. In row 1, an OFF state of the middle actuator 5110 results in a LONG state for the middle section 5104. In row 2, an ON state of the middle actuator 5110 results in a SHORT state for the middle section 5104.

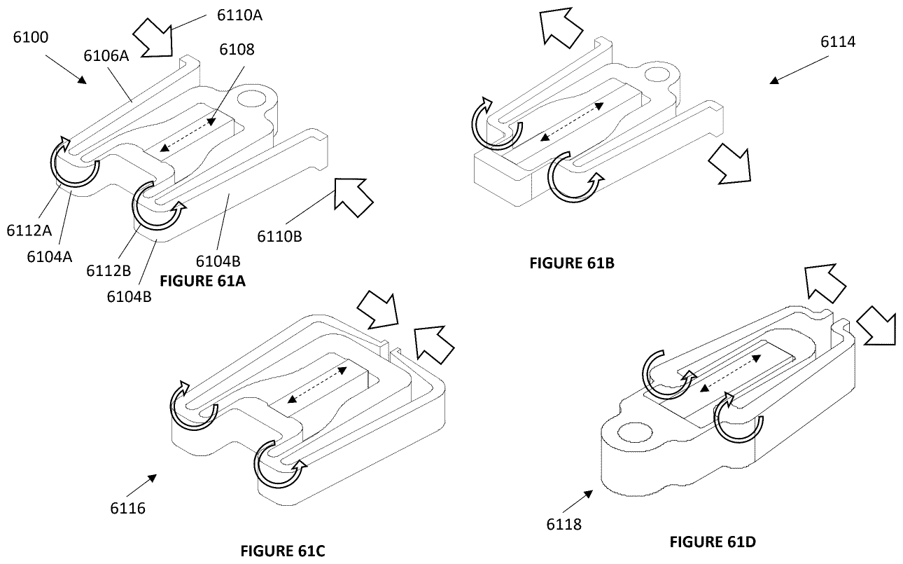

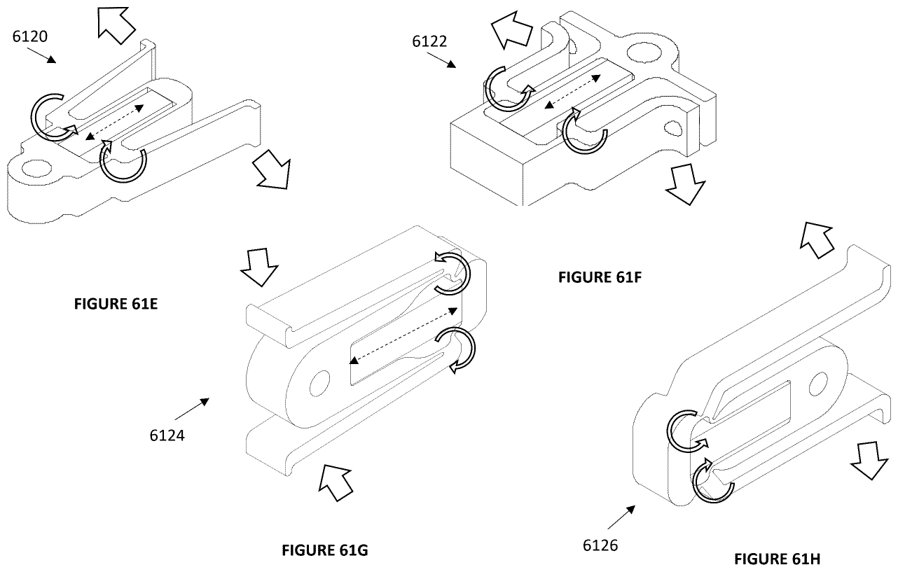

Referring now generally to the Figures and particularly to FIG. 61A, FIG. 61A is a first alternative clamp design 6100 for the clamps 5102 of the GLA 5100. While each of the alternative clamp designs presented in FIGS. 61A through 61H each generally include the aspects of a piezo stack 6102 whose expansion causes a pair of shoulders 6104A and 6104B to pivot, thus moving a pair of legs 6106A and 6106B, the shapes of the various clamp designs presented in FIGS. 61A through 61H mechanically apply the expansion force of the clamp actuator 5106 differently, as shown throughout FIGS. 61A through 61H by a piezo expansion arrow 6108, a pair of leg movement arrows 6110A and 6110B, and a pair of shoulder movement arrows 6112A and 6112B. The first alternative clamp design 6100 is a HOLDING embodiment. As the piezo stack 6102 expands, the pair of shoulders 6104A and 6104B rotate outward and the pair of legs 6106A and 6106B move inward, such as to disengage from a track.

Referring now generally to the Figures and particularly to FIG. 61B, FIG. 61B is a second alternative clamp design 6114 for the clamps 5102 of the GLA 5100. The second alternative clamp design 6114 is a HOLDING embodiment. As the piezo stack 6102 expands, the pair of shoulders 6104A and 6104B rotate outward and the pair of legs 6106A and 6106B move outward, as shown by the arrows following the same convention established in FIG. 61A.

Referring now generally to the Figures and particularly to FIG. 61C, FIG. 61C is a third alternative clamp design 6116 for the clamps 5102 of the GLA 5100. The third alternative clamp design 6116 is a NONHOLDING embodiment. As the piezo stack 6102 expands, the pair of shoulders 6104A and 6104B rotate outward and the pair of legs 6106A and 6106B move inward, such as to bring the clamp sides together to pinch or grip something, as shown by the arrows following the same convention established in FIG. 61A.

Referring now generally to the Figures and particularly to FIG. 61D, FIG. 61D is a fourth alternative clamp design 6118 for the clamps 5102 of the GLA 5100. This clamp is a NONHOLDING embodiment. As the piezo stack 6102 expands, the pair of shoulders 6104A and 6104B rotate inward and the pair of legs 6106A and 6106B move outward, such as to hold the legs apart and “un-pinch” something held by the clamp, as shown by the arrows following the same convention established in FIG. 61A.

Referring now generally to the Figures and particularly to FIG. 61E, FIG. 61E is a fifth alternative clamp design 6120 for the clamps 5102 of the GLA 5100. This clamp is a NONHOLDING embodiment. As the piezo stack 6102 expands, the pair of shoulders 6104A and 6104B rotate inward and the pair of legs 6106A and 6106B move outward, such as to engage with a track, as shown by the arrows following the same convention established in FIG. 61A.

Referring now generally to the Figures and particularly to FIG. 61F, FIG. 61F is a sixth alternative clamp design 6122 for the clamps 5102 of the GLA 5100. This is a nonholding clamp embodiment. This clamp is a NONHOLDING embodiment. As the piezo stack 6102 expands, the pair of shoulders 6104A and 6104B rotate inward and the pair of legs 6106A and 6106B move outward, as shown by the arrows following the same convention established in FIG. 61A.

Referring now generally to the Figures and particularly to FIG. 61G, FIG. 61G is a seventh alternative clamp design 6124 for the clamps 5102 of the GLA 5100. This clamp is a HOLDING embodiment. As the piezo stack 6102 expands, the pair of shoulders 6104A and 6104B rotate outward and the pair of legs 6106A and 6106B move inward, such as to disengage from a track, as shown by the arrows following the same convention established in FIG. 61A.

Referring now generally to the Figures and particularly to FIG. 61H, FIG. 61H is an eighth alternative clamp design 6126 for the clamps 5102 of the GLA 5100. This clamp is a NONHOLDING embodiment. As the piezo stack 6102 expands, the pair of shoulders 6104A and 6104B rotate inward and the pair of legs 6106A and 6106B move outward, such as to engage with a track, as shown by the arrows following the same convention established in FIG. 61A.

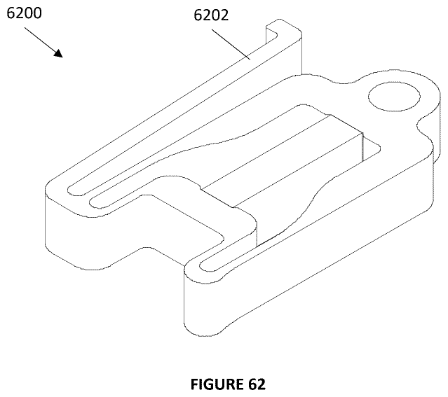

Referring now generally to the Figures and particularly to FIG. 62, FIG. 62 is a one-armed clamp design 6200 for the clamps 5102 of the GLA 5100, which might be preferable in some applications. The one-armed clamp design has only one arm 6202, not two like the designs of FIGS. 61A through 61F. While a single-legged version of the GLA 5100 utilizing this clamp variation could also work with some precautions, the symmetrical variant is generally preferred. Another significant advantage of a symmetrical embodiment of the GLA 5100 over an asymmetrical embodiment is that the working stroke, measured by the movement of the feet relative to each other, is twice as large as that of an asymmetrical embodiment of the GLA 5100.

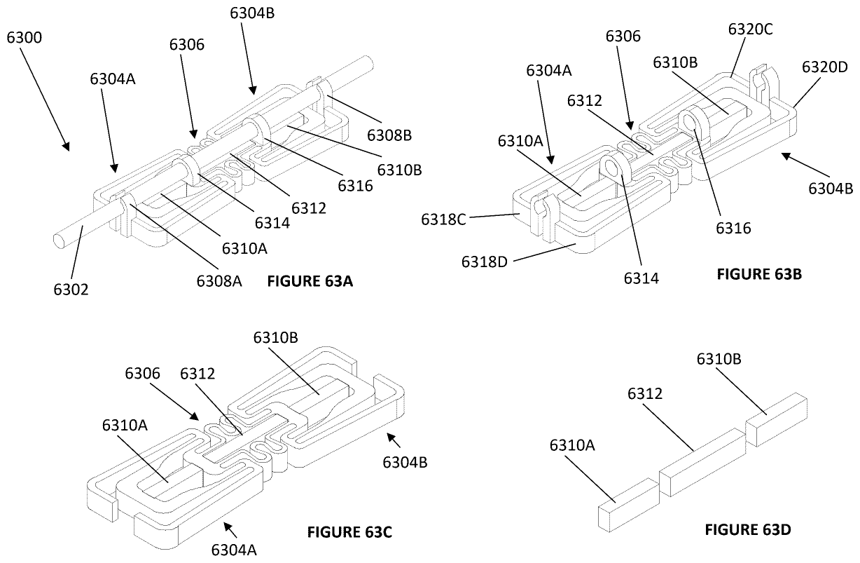

Referring now generally to the Figures and particularly to FIG. 63A, FIG. 63A is a line drawing presenting a one-guide GLA 6300, which is an embodiment of the GLA 5100 designed for locomotion along a guide rail 6302; it is noted that the guide 6302 might be a wire, rod, or other linear guiding element, with clamp designs varying to engage with these respective variations in “terrain”. In some cases it is important to have only one guide (rod or wire) instead of two. In this embodiment, the GLA 5100 is implemented as a flat shape device, with vertically-oriented clamps to engage with the guide rail 6302 except of vertical clamps intended to hold the rod. The one-guide GLA 6300 may include a one-guide GLA A end 6304A, a one-guide GLA B end 6304B, a one-guide GLA middle 6306. The one-guide GLA 6300 may further include a pair of two one-guide GLA clamps 6308, specifically a one-guide GLA A-end clamp 6308A and a one-guide GLA B-end clamp 6308B, actuated by a pair of two one-guide GLA clamp actuators 6310, specifically a one-guide GLA A-end clamp actuator 6310A and a one-guide GLA B-end clamp actuator 6310B. The one-guide GLA middle 6306 is actuated by a one-guide GLA middle actuator 6312. The one-guide GLA 6300 may further include one or more petals 6314 and 6316 further holding the one-guide GLA 6300 on the guide rail 6302.

Referring now generally to the Figures and particularly to FIG. 63B, FIG. 63B is a line drawing presenting a view of the one-rail GLA 6300 with the guide rail 6302 not pictured. For reference, the one-guide GLA A end 6304A, the one-guide GLA B end 6304B, the one-guide GLA middle 6306, the one-guide GLA A-end clamp actuator 6310A, the one-guide GLA B-end clamp actuator 6310B, and the one-guide GLA middle actuator 6312 are labeled. It is noted that, with the guide rail 6302 not pictured, the one-guide GLA A-end clamp actuator 6310A, the one-guide GLA B-end clamp actuator 6310B, and the one-guide GLA middle actuator 6312 are more easily visible in the image. Further presented and labeled individually are four clamp legs 6318, more specifically a one-guide GLA A-end clamp C-side leg 6318AC and a one-guide GLA A-end clamp D-side leg 6318AD, together comprising the one-guide GLA A-end clamp 6308A, which are moved together and apart by expansion and contraction of the one-guide GLA A-end clamp actuator 6310A; and a one-guide GLA B-end clamp C-side leg 6318BC and a one-guide GLA B-end clamp D-side leg 6318BD, together comprising the one-guide GLA B-end clamp 6308B, which are moved together and apart by expansion and contraction of the one-guide GLA B-end clamp actuator 6310B.

Referring now generally to the Figures and particularly to FIG. 63C, FIG. 63C is a line drawing presenting a view of the one-rail GLA 6300 with the guide rail 6302, the ends of the clamp legs 6318, and the petals 6314 and 6316 not pictured. For reference, the one-guide GLA A end 6304A, the one-guide GLA B end 6304B, the one-guide GLA middle 6306, the one-guide GLA A-end clamp actuator 6310A, the one-guide GLA B-end clamp actuator 6310B, and the one-guide GLA middle actuator 6312 are labeled. It is noted that, with the guide rail 6302 not pictured, the one-guide GLA A-end clamp actuator 6310A, the one-guide GLA B-end clamp actuator 6310B, and the one-guide GLA middle actuator 6312 are more easily visible in the image.

Referring now generally to the Figures and particularly to FIG. 63D, FIG. 63D is a line drawing presenting the actuators of the rail GLA 6300 in isolation, specifically the one-guide GLA A-end clamp actuator 6310A, the one-guide GLA B-end clamp actuator 6310B, and the one-guide GLA middle actuator 6312.

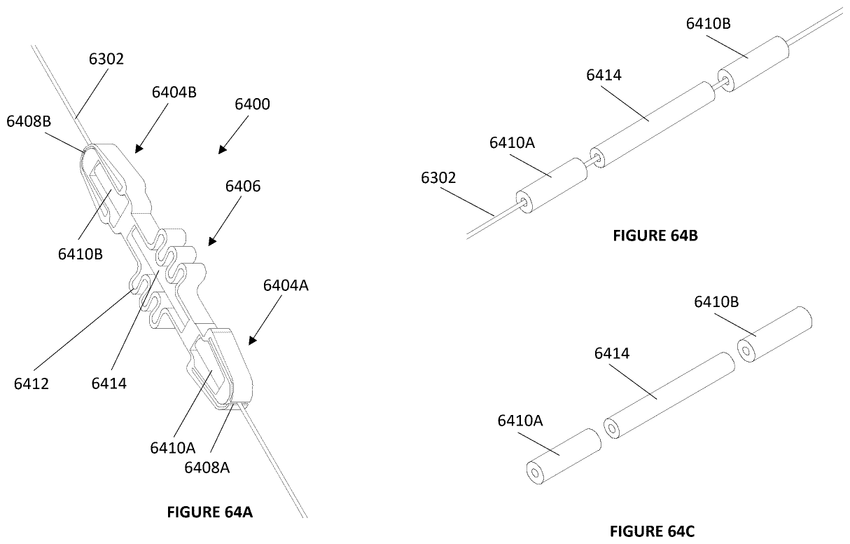

Referring now generally to the Figures and particularly to FIG. 64A, FIG. 64A is a line drawing presenting a bead GLA 6400, which is a second alternative version of the rail GLA 6300 designed for locomotion along the guide rail 6302, with the rail GLA 6300 shaped to fit around the guide rail 6302 “like a bead on a string”. The bead GLA 6400 may include or comprise a bead GLA A end 6404A, a bead GLA B end 6404B, a bead GLA middle section 6406, a bead GLA clamp A 6808A, a bead GLA clamp B 6808B, a bead GLA clamp actuator A 6810A, a bead GLA clamp actuator B 6810B, a bead GLA middle frame 6412, and a bead GLA middle actuator 6414. It is noted that, in order to have the guide rail 6302 pass through the center of the bead GLA 6400, several components of the bead GLA 6400 include apertures for the guide rail 6302 to pass through. The movement is the same: cycle by cycle the bead GLA 6400 grips the guide rail 6302 utilizing the bead GLA clamp A 6808A and the bead GLA clamp B 6808B, and inches the bead GLA 6400 along the guide rail 6302. These steps can be very fast, allowing the bead GLA 6400 to move along the guide rail 6302 with a substantial speed. The benefits of the bead GLA 6400 may include easy manufacturing. The metal frame is cut, such as utilizing an electrical discharge machining, waterjet, or laser cutting machine) from a single sheet of material. There are only 4 parts of this design. Such simple design has the following advantages: 1. Flat raw material (steel, titan, ceramics). 2. Only cutting operations needed (no welding, no additional parts).

Referring now generally to the Figures and particularly to FIG. 64B, FIG. 64B is a line drawing presenting the bead GLA clamp actuator A 6810A, the bead GLA clamp actuator B 6810B, and the bead GLA middle actuator 6414 of the bead GLA 6400 and the guide rail 6302 in isolation. As the diagram makes visually apparent, each of the three actuators is shaped as a tube (or bead), with an aperture through the center, allowing the guide rail 6302 to pass right through the bead GLA 6400.

Referring now generally to the Figures and particularly to FIG. 64C, FIG. 64C is a line drawing presenting the bead GLA clamp actuator A 6810A, the bead GLA clamp actuator B 6810B, and the bead GLA middle actuator 6414 of the bead GLA 6400 in isolation. As the diagram makes visually apparent, each of the three actuators is shaped as a tube (or bead), with an aperture through the center, allowing the guide rail 6302 to pass right through the bead GLA 6400.

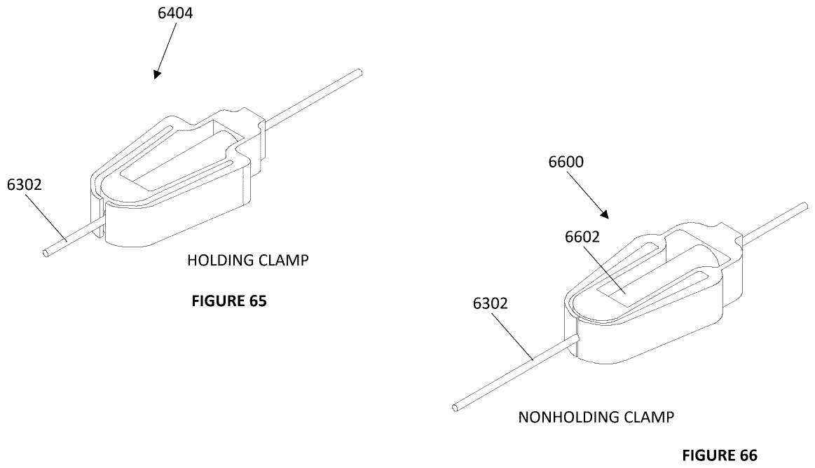

Referring now generally to the Figures and particularly to FIG. 65, FIG. 65 is a line drawing presenting the bead GLA clamp A 6808A as presented in FIG. 64A, in isolation, as an example of a HOLDING model of clamp suitable for inclusion in the bead GLA 6400 to be contrasted to a “nonholding” clamp model to be presented in FIG. 66. The guide rail 6302 is also presented here. It is noted that, as this is a “holding” clamp, the clamp remains engaged when unpowered, and only disengages when the bead GLA clamp actuator A 6810A is supplied with electrical current. When the bead GLA clamp actuator A 6810A is not powered, the bead GLA clamp actuator A 6810A clamps down and holds position on the guide rail 6302; when the bead GLA clamp actuator A 6810A is supplied with electrical power, the bead GLA clamp actuator A 6810A can move along the guide rail 6302.

Referring now generally to the Figures and particularly to FIG. 66, FIG. 66 is a line drawing presenting a NONHOLDING clamp component suitable for inclusion in the bead GLA 6400, a nonholding bead clamp 6600. It is noted that, as this is a “nonholding” clamp, the clamp remains disengaged when not powered, and only engages when the nonholding bead clamp 6600 is supplied with electrical current. When the nonholding bead clamp 6600 is not powered, the nonholding bead clamp 6600 does not hold position on the guide rail 6302 and may be shifted freely; when the nonholding bead clamp 6600 is supplied with electrical power, the nonholding bead clamp 6600 clamps down and holds position relative to the guide rail 6302.

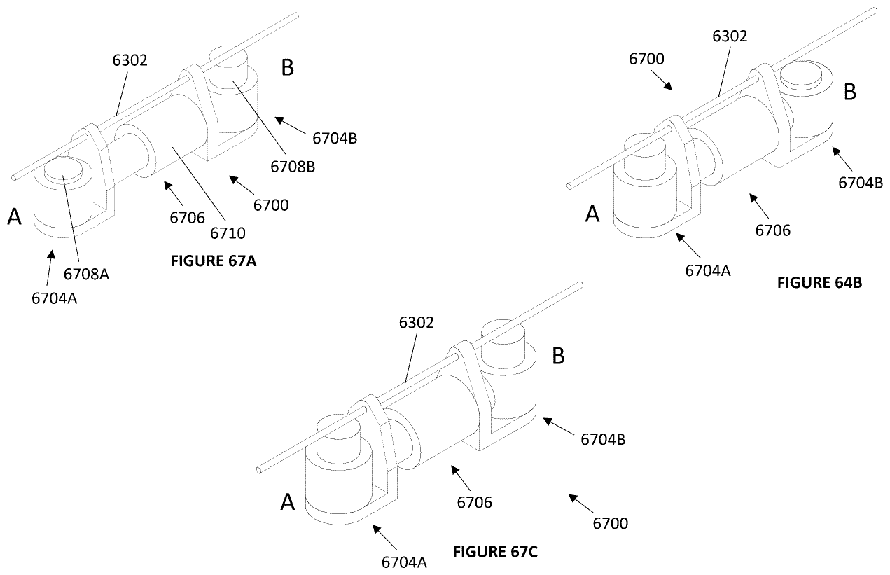

Referring now generally to the Figures and particularly to FIG. 67A, FIG. 67A is a line drawing presenting a solenoid rail GLA 6700. This embodiment of the GLA 5100 still uses a guide, in this case a guide rail 6702, and still has an A end and a B end as labeled (a solenoid rail GLA A end 6704A and solenoid rail GLA B end 6704B respectively) and a solenoid rail GLA middle section 6706. This model has the difference of utilizing solenoid actuators instead of piezoelectric stacks, specifically a solenoid rail GLA actuator A 6708A, a solenoid rail GLA actuator B 6708B, and a solenoid rail GLA middle actuator 6710. A solenoid actuator converts electrical energy into mechanical linear motion by powering and depowering an electromagnetic coil to magnetically pull or push a sliding ferromagnetic plunger back and forth relative to the position of the coil; an ON state pulls the plunger into the center of the coil, and an OFF state repels the plunger from the center of the coil. This kind of actuator is often used for locks, valves, and switches; one example of a solenoid actuator one might be familiar with in daily life is the starter solenoid in one's car, which is activated to bring together the high-voltage electric contacts of the battery and the engine in order to provide an ignition spark for starting the engine in response to a driver's cue to start the car. As the diagrams show, a solenoid actuator can also be applied to making the protruding “buttons” of the solenoid rail GLA actuator A 6708A and the solenoid rail GLA actuator B 6708B move up and down, thus selectively engaging and disengaging (respectively) with the guide rail 6702. In FIG. 64A, the solenoid rail GLA actuator A 6708A is disengaged, the solenoid rail GLA actuator B 6708B is engaged, and the solenoid rail GLA middle actuator 6710 is extended; this might correspond to row 3 of the table of FIG. 52. It is noted that, while this is one of few examples of replacing piezoelectric stacks with solenoid actuators in these applications, this shouldn't be construed as exhaustive or limiting, and it should be kept in mind that other embodiments and designs presented herein might also potentially be adapted to utilize solenoid actuators instead.

Referring now generally to the Figures and particularly to FIG. 67B, FIG. 67B is a second line drawing presenting the solenoid rail GLA 6700 in a different clamp state. The guide rail 6702, the solenoid rail GLA A end 6704A, the solenoid rail GLA B end 6704B, and the solenoid rail GLA middle section 6706 are all labeled here. In FIG. 67B, the solenoid rail GLA actuator A 6708A is engaged, the solenoid rail GLA actuator B 6708B is disengaged, and the solenoid rail GLA middle actuator 6710 is contracted; this might correspond to row 6 of the table of FIG. 52.

Referring now generally to the Figures and particularly to FIG. 67C, FIG. 67C is a third line drawing presenting the solenoid rail GLA 6700 in an additional different clamp state. The guide rail 6702, the solenoid rail GLA A end 6704A, the solenoid rail GLA B end 6704B, and the solenoid rail GLA middle section 6706 are all labeled here. In FIG. 67B, the solenoid rail GLA actuator A 6708A is engaged, the solenoid rail GLA actuator B 6708B is engaged, and the solenoid rail GLA middle actuator 6710 is contracted; this might correspond to row 8 of the table of FIG. 52.

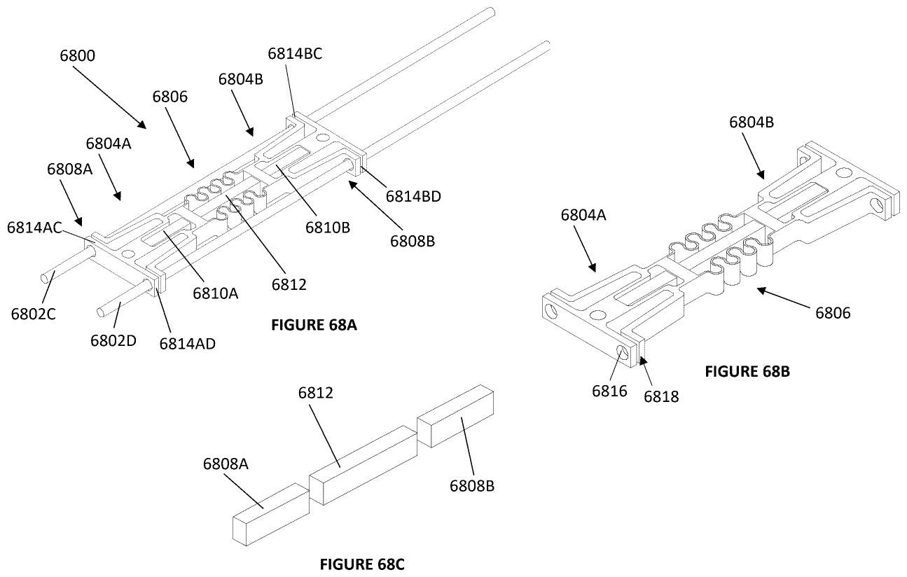

Referring now generally to the Figures and particularly to FIG. 68A, FIG. 68A is a line drawing presenting a two-guide GLA 6800, which is a version of the GLA of FIG. 51A designed for locomotion along a pair of guide rails 6802, specifically a C-side rail 6802C and a D-side rail 6802D. The two-guide GLA 6800 may include a two-guide GLA A end 6804A, a two-guide GLA B end 6804B, a two-guide GLA middle 6806. The two-guide GLA 6800 may further include a pair of two-guide GLA clamps 6808, specifically a two-guide GLA A-end clamp 6808A and a two-guide GLA B-end clamp 6808B, actuated by a pair of two-guide GLA clamp actuators 6810, specifically a two-guide GLA A-end clamp actuator 6810A and a two-guide GLA B-end clamp actuator 6810B. The two-guide GLA middle 6806 is actuated by a two-guide GLA middle actuator 6812. Since there are two rails to clamp onto, the two-guide GLA clamps 6808 are further subdivided into a two-guide GLA A-end clamp C-side 6814AC which engages with the C-side rail 6802C when the two-guide GLA A-end clamp 6808A is engaged, a two-guide GLA A-end clamp D-side 6814AD which engages with the D-side rail 6802D when the two-guide GLA A-end clamp 6808A is engaged, a two-guide GLA B-end clamp C-side 6814BC which engages with the C-side rail 6802C when the two-guide GLA B-end clamp 6808B is engaged, and a two-guide GLA B-end clamp D-side 6814BD which engages with the D-side rail 6802D when the two-guide GLA B-end clamp 6808B is engaged.

Referring now generally to the Figures and particularly to FIG. 68B, FIG. 68B is a line drawing presenting the two-rail GLA 6800 with the guide rails 6802 not pictured. The two-guide GLA A end 6804A, the two-guide GLA B end 6804B, and the two-guide GLA middle 6806 are labeled for reference.

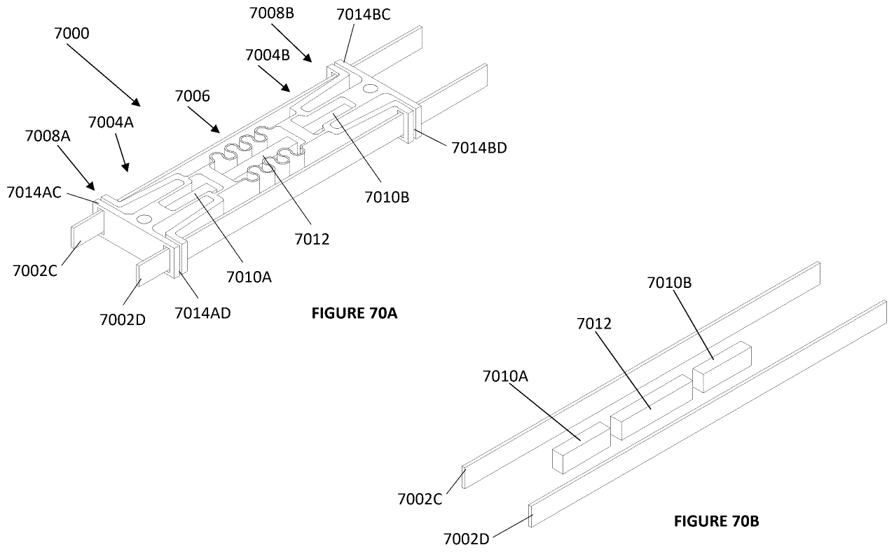

Each of the two-guide GLA clamps 6808 has a pair of two collinear apertures aligned on the associated one of the guide rails 6802; FIG. 68B has a representative pair of these indicated on the two-guide GLA A-end clamp D-side 6814AD, a first collinear aperture 6816 and a second collinear aperture 6818. Though only one representative pair is labeled, it is understood that the two-guide GLA A-end clamp C-side 6814AC, the two-guide GLA B-end clamp C-side 6814BC, and the two-guide GLA B-end clamp D-side 6814BD each have a corresponding pair of collinear apertures also. When one of the two-guide GLA clamps 6808 engages with the associated one of the guide rails 6802, the first collinear aperture 6816 and the second collinear aperture 6818 are moved in a perpendicular direction such that the collinear apertures become unaligned and the associated one of the guide rails 6802 is caught against the edges of the unaligned apertures. In some embodiments, the pair of apertures may also be more like hooks than closed circular holes. It is noted that this variety of clamp—which utilizes aligning and offsetting of apertures instead of clamping and unclamping, might still be either holding or nonholding: a nonholding embodiment would have apertures which are aligned until moved, while a holding embodiment would have apertures which are offset unless moved into an aligned position. It is further noted that the guide rails 6802 are presented as circular in cross-section in FIG. 68A, but the guide rails 6802 might have any cross-sectional shape, such as but not limited to flat strips as presented in FIG. 70A, or other cross-sectional shapes not depicted, such as but not limited to triangles, rectangles, polygons, or irregular shapes, as considered suitable by a designer; it is noted that the shapes of the first collinear aperture 6816 and the second collinear aperture 6818 may also compatibly be any of these shapes. It is noted that the amount of friction force in this implementation depends on the curvature of the strips in the points of connecting legs. A small curvature due to the pressing of the legs adds value to a friction force, helping to move bigger force to the two-rail GLA 6800.

Referring now generally to the Figures and particularly to FIG. 68C, FIG. 68C is a line drawing presenting the actuator elements of the two-rail GLA of FIG. 68A in isolation, specifically the two-guide GLA A-end clamp actuator 6810A, the two-guide GLA B-end clamp actuator 6810B, and the two-guide GLA middle actuator 6812.

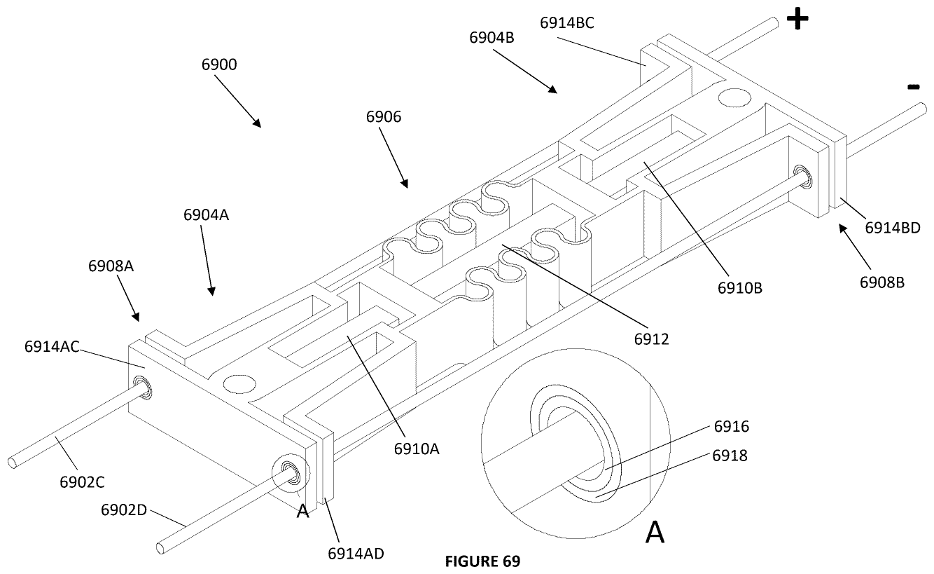

Referring now generally to the Figures and particularly to FIG. 69, FIG. 69 is a line drawing presenting a two powered rail GLA 6900, an embodiment of the two-rail GLA 6800 wherein a pair of powered guide rails 6902, specifically a C-side rail 6902C and a D-side rail 6902D further provide electrical power. The two powered rail GLA 6900 may include a two powered rail GLA A end 6904A, a two powered rail GLA B end 6904B, a two powered rail GLA middle 6906. The two powered rail GLA 6900 may further include a pair of two powered rail GLA clamps 6908, specifically a two powered rail GLA A-end clamp 6908A and a two powered rail GLA B-end clamp 6908B, actuated by a pair of two powered rail GLA clamp actuators 6910, specifically a two powered rail GLA A-end clamp actuator 6910A and a two powered rail GLA B-end clamp actuator 6910B. The two powered rail GLA middle 6906 is actuated by a two powered rail GLA middle actuator 6912. Since there are two rails to clamp onto, the two powered rail GLA clamps 6908 are further subdivided into a two powered rail GLA A-end clamp C-side 6914AC which engages with the C-side rail 6902C when the two powered rail GLA A-end clamp 6908A is engaged, a two powered rail GLA A-end clamp D-side 6914AD which engages with the D-side rail 6902D when the two powered rail GLA A-end clamp 6908A is engaged, a two powered rail GLA B-end clamp C-side 6914BC which engages with the C-side rail 6902C when the two powered rail GLA B-end clamp 6908B is engaged, and a two powered rail GLA B-end clamp D-side 6914BD which engages with the D-side rail 6902D when the two powered rail GLA B-end clamp 6908B is engaged. Further shown here, using an INSET A, is a layer of conductive material 6916 and a layer of non-conductive material 5918.

One challenge pertaining to utilizing the GLA 5100 and various embodiments thereof presented herein, is that of providing a convenient and durable power supply and data connection for control. Having a power cord attached might limit the flexibility and mobility of a device which moves around, such as those presented herein; furthermore, vibration, acceleration, or eventual wear and tear can stress and erode even soldered or welded cable connections. The powered guide rails 6902 are one example of a possible solution to this concern. When the GLA's body is implemented from non-conductive material, each wire or a rail becomes an electric bus. When an actuator's body is made from conductive material, it is possible to insert an isolation to the points of connection, made, for example, from ceramics and put contacting groups on this isolated holes and legs, as presented here. Unless the two powered rail GLA 6900 is entirely removed from the powered guide rails 6902, some part of the two powered rail GLA 6900 is always in contact with the powered guide rails 6902 as the two powered rail GLA 6900 goes through the standard inchworm actuator locomotion cycle of clamping, inching, and unclamping. The power from connected points then can be delivered via short wires on the GLA's body or via printed electric connections. Another embodiment of the same inventive aspect (not shown), is to have a rail, strip, rod or wires covered by conductive material and connecting to the proper places of the GLA's legs, forming proper conductive paths over the guides and GLA's body. With this approach even the one-rod guide may deliver the power to the actuator. In this case the rod can contain conductive coating isolated from each other.

Referring now generally to the Figures and particularly to FIG. 70A, FIG. 70A is a line drawing presenting a two-flat-rail GLA 7000, which is an alternative embodiment of the two-rail GLA 6800 designed for a pair of flat rails 7002, specifically a C-side flat rail 7002C and a D-side flat rail 7002D. The two-flat-rail GLA 7000 may include a two-flat-rail GLA A end 7004A, a two-flat-rail GLA B end 7004B, a two-flat-rail GLA middle 7006. The two-flat-rail GLA 7000 may further include a pair of two-flat-rail GLA clamps 7008, specifically a two-flat-rail GLA A-end clamp 7008A and a two-flat-rail GLA B-end clamp 7008B, actuated by a pair of two-flat-rail GLA clamp actuators 7010, specifically a two-flat-rail GLA A-end clamp actuator 7010A and a two-flat-rail GLA B-end clamp actuator 7010B. The two-flat-rail GLA middle 7006 is actuated by a two-flat-rail GLA middle actuator 7012. Since there are two rails to clamp onto, the two-flat-rail GLA clamps 7008 are further subdivided into a two-flat-rail GLA A-end clamp C-side 7014AC which engages with the C-side flat rail 7002C when the two-flat-rail GLA A-end clamp 7008A is engaged, a two-flat-rail GLA A-end clamp D-side 7014AD which engages with the D-side flat rail 7002D when the two-flat-rail GLA A-end clamp 7008A is engaged, a two-flat-rail GLA B-end clamp C-side 7014BC which engages with the C-side flat rail 7002C when the two-flat-rail GLA B-end clamp 7008B is engaged, and a two-flat-rail GLA B-end clamp D-side 7014BD which engages with the D-side flat rail 7002D when the two-flat-rail GLA B-end clamp 7008B is engaged.

Referring now generally to the Figures and particularly to FIG. 70B, FIG. 70B is a line drawing presenting the rails and actuator elements of the two-flat-rail 7000 in isolation, specifically the two-flat-rail GLA A-end clamp actuator 7010A, the two-flat-rail GLA B-end clamp actuator 7010B, and the two-flat-rail GLA middle actuator 7012.

Referring now generally to the Figures and particularly to FIG. 71A, FIG. 71A is a line drawing presenting the amplified push GLA 5800 on a toothed rail track 7100 comprising a C-side toothed rail 7102C and a D-side toothed rail 7102D. It is noted that an implementation utilizing the toothed rail track 7100 may provide at least the benefit of providing specific slots for a set of feet of a GLA to fit into, such that these feet do not have to be adapted to brace against or maintain friction with a smooth track wall; this may lead to less friction of travel overall.

Referring now generally to the Figures and particularly to FIG. 71B, FIG. 71B is a line drawing presenting the amplified push GLA 5800 on the C-side toothed rail 7102C and D-side toothed rail 7102D, with external housing of the toothed rail track 7100 not pictured. Further labeled are the amplified push GLA feet 5812, specifically the amplified push GLA AC foot 5812AC, the amplified push GLA AD foot 5812AD, the amplified push GLA BC foot 5812BC, and the amplified push GLA BD foot 5812BD. It is noted that the combination of design features presented here—inchworm actuation, which moves incrementally by precise steps, and feet shaped to fit into or onto a guide element such as the toothed rail track 7100—can make this kind of implementation very effective and useful: the amplified push GLA feet 5812 move precise steps between track teeth, distances of movement are easy to calibrate and measure by number of teeth, and the shape of the track helps to keep the amplified push GLA 5800 secure in place and moving in a straight line.

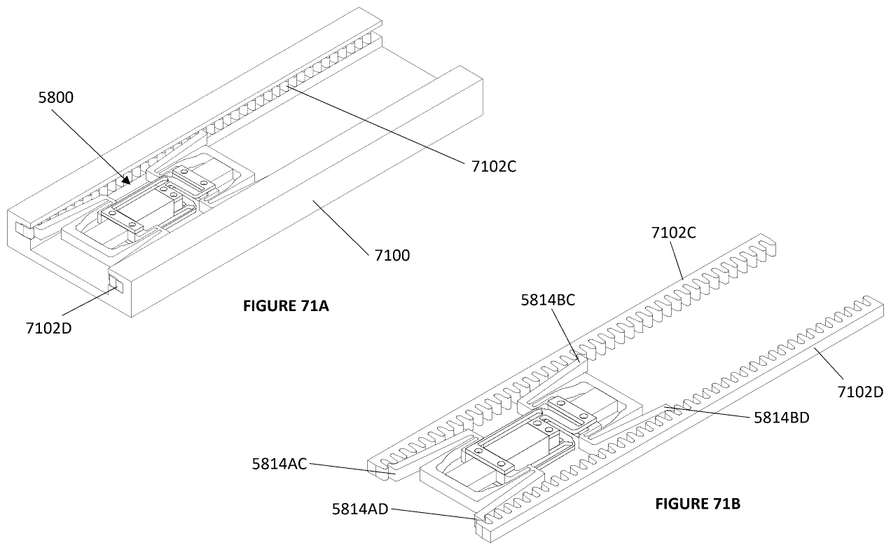

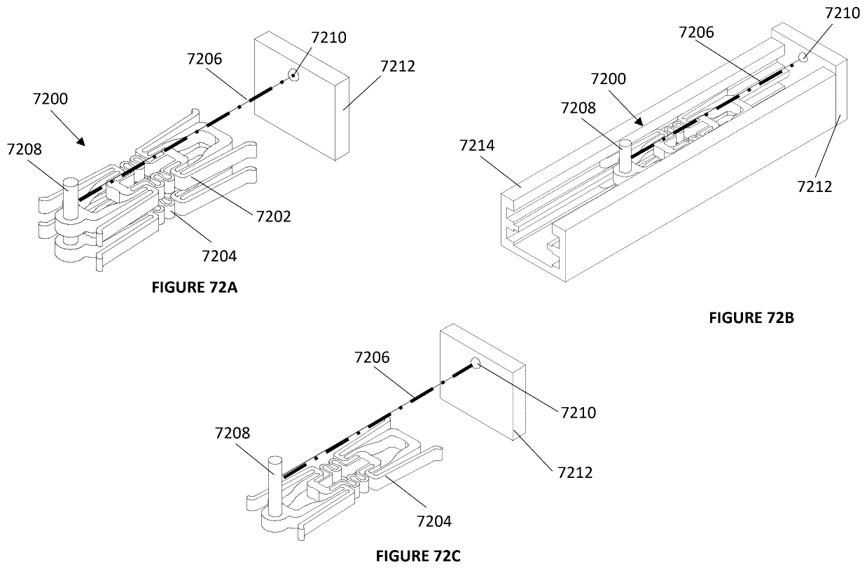

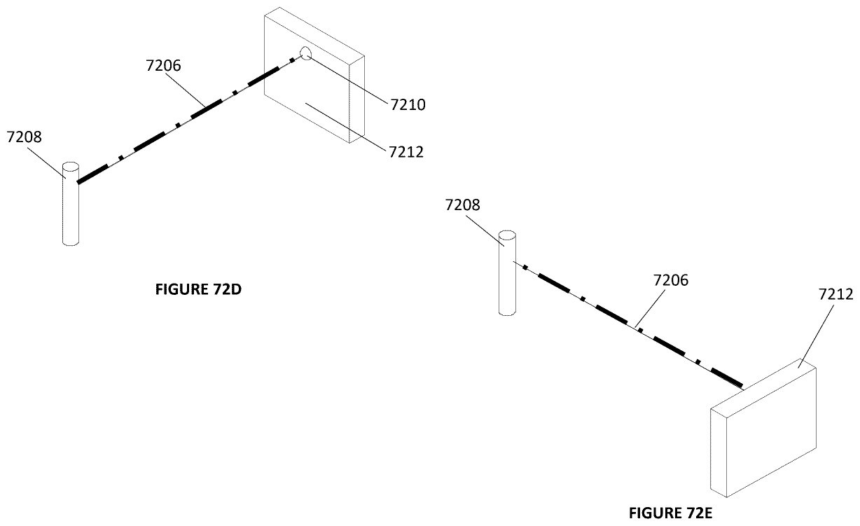

Referring now generally to the Figures and particularly to FIG. 72A, FIG. 72A is a line drawing presenting a tandem GLA system 7200 comprising two instances of the GLA 5100, specifically a top tandem GLA 7202 and a bottom tandem GLA 7204 (“the tandem GLAs 7202-4”). Generally, the precision of the GLA 5100 depends on the length of each step. The shorter the step, the more precise is the whole travel. However, shorter steps mean proportionally lower speed. The tandem GLA system 7200 offers a solution to this tradeoff between precision and speed, providing a very fast moving device with a high force, speed and precision. The tandem GLA system 7200 provides the feature of being able to select between two different step lengths, and therefore two alternate modes of speed and precision, if the step length of the top tandem GLA 7202 is different from the step length of the bottom tandem GLA 7204. For instance, the tandem GLA system 7200 might have a “long distance mode” and a “short distance mode”, wherein one of the tandem GLAs 7202-4 is optimized for long steps and long-distance travel (such as for instance the amplified push embodiment of FIG. 58A, not shown here), and the other of the tandem GLAs 7202-4 is made to travel more slowly and precisely; toward the end of a long distance, the tandem GLA system 7200 described can “shift gears” and slow down to a tidy, precise stop. It is noted that other combinations of “modes” might also be possible or preferred, and “long distance/short distance” is only one example of the utility of the tandem GLA system 7200 concept. The tandem GLA system 7200 changes speeds by changing which one of the tandem GLAs 7202-4 is actually powered and running; the other one of the tandem GLAs 7202-4 gets carried along in a disengaged state until the tandem GLA system 7200 changes speeds, whereupon which one of the tandem GLAs 7202-4 is carrying the whole tandem GLA system 7200 and which is being carried will switch. It is noted that nonholding clamp embodiments may be preferred in tandem assemblies, as when one of the tandem GLAs 7202-4 is being carried, that carried one of the tandem GLAs 7202-4 should be disengaged for minimal friction.

Further introduced here is an interferometer laser beam 7206, an interferometer system rod 7208 coupled with the tandem GLA system 7200, and a laser interferometer 7210 positioned on a track end wall 7212 as shown. The interferometer laser beam 7206 can inform the tandem GLA system 7200 when a stop is coming up, in order to allow the tandem GLA system 7200 to switch from fast locomotion to slow and precise, as discussed above.

Referring now generally to the Figures and particularly to FIG. 72B, FIG. 72B is a line drawing presenting a view of the tandem GLA system 7200 further including a tandem track 7214. Labeled here also are the interferometer laser beam 7206, the interferometer system rod 7208, the laser interferometer 7210, and the track end wall 7212.

Referring now generally to the Figures and particularly to FIG. 72C, FIG. 72C is a line drawing presenting the tandem GLA system of FIG. 72A with some elements removed to better display other elements. More specifically, the top tandem GLA 7202 has been omitted to reveal the bottom tandem GLA 7204. Labeled here also are the interferometer laser beam 7206, the interferometer system rod 7208, the laser interferometer 7210, and the track end wall 7212.

Referring now generally to the Figures and particularly to FIG. 72D, FIG. 72D is a first line drawing presenting the control system components of the tandem GLA system 7200 in isolation, specifically the interferometer laser beam 7206, the interferometer system rod 7208, the laser interferometer 7210, and the track end wall 7212.

Referring now generally to the Figures and particularly to FIG. 72E, FIG. 72E is a second line drawing presenting a second view of the control system components of FIG. 72D. Labeled here are interferometer laser beam 7206, the interferometer system rod 7208, and the track end wall 7212. It is noted that the laser interferometer 7210 is concealed by the view angle.

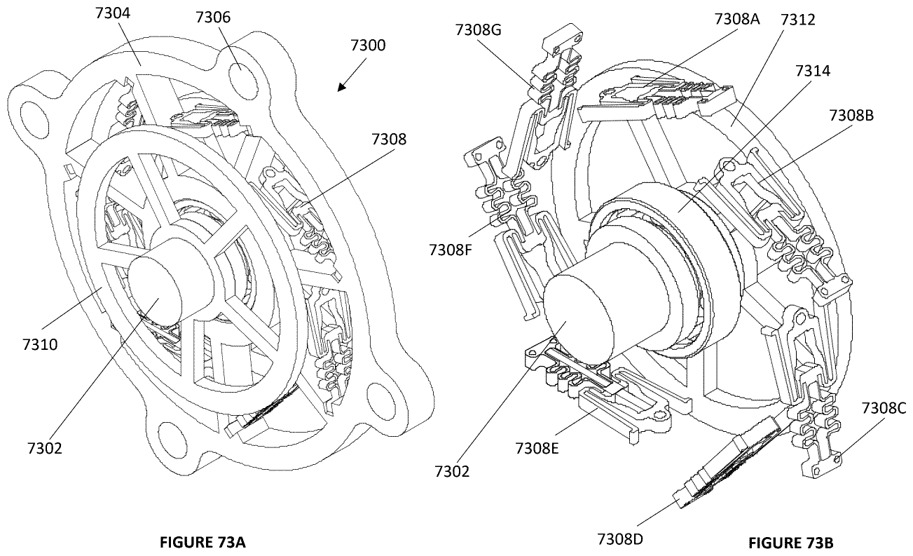

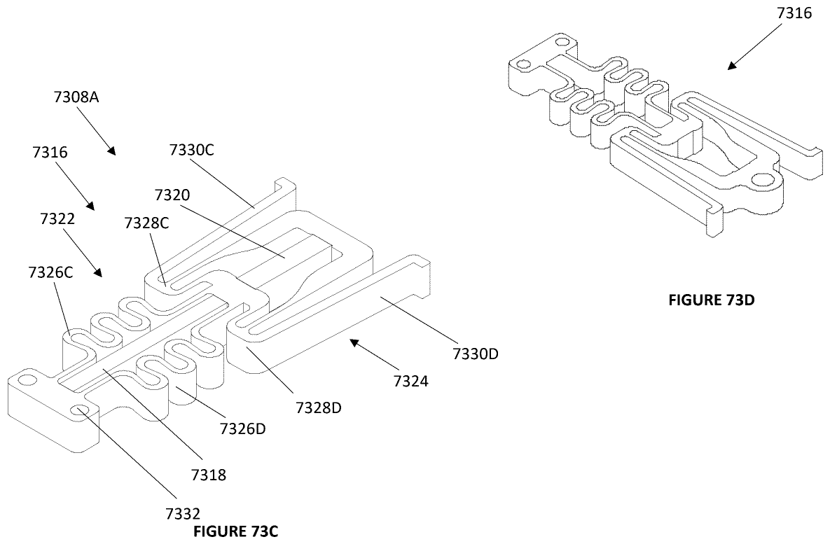

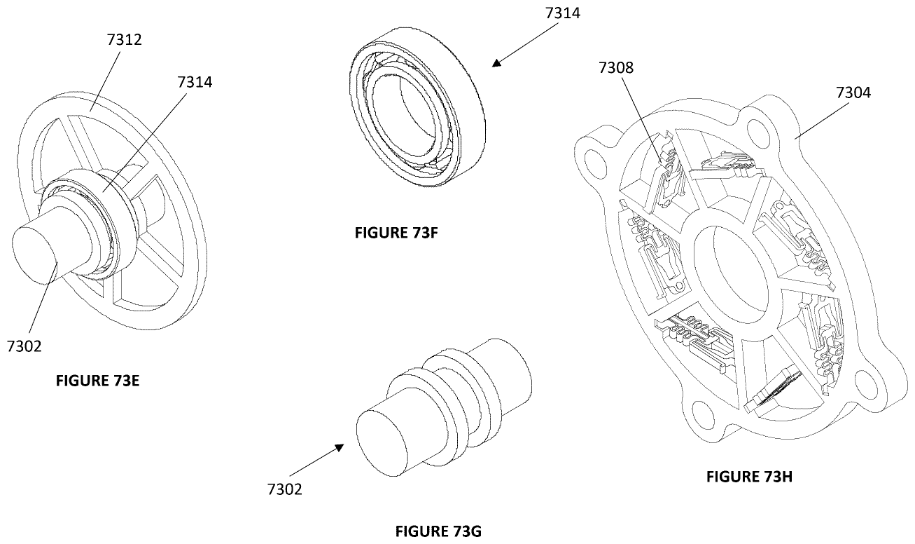

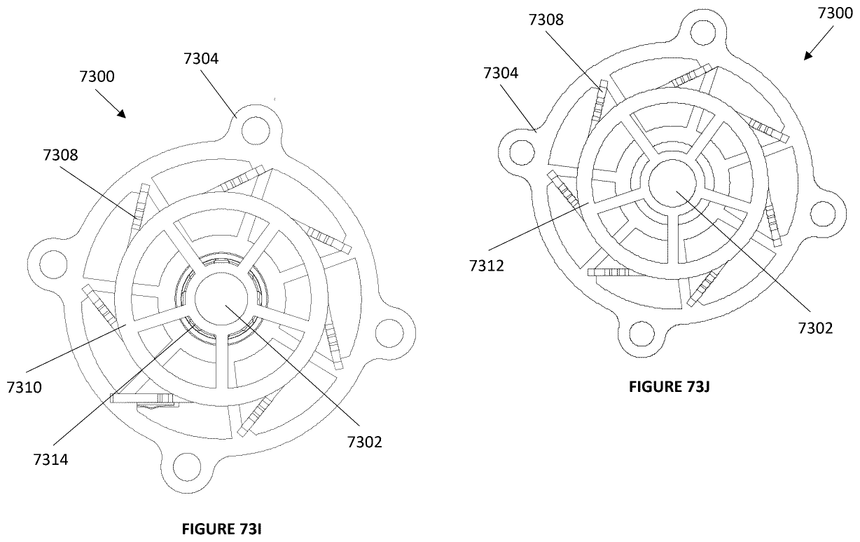

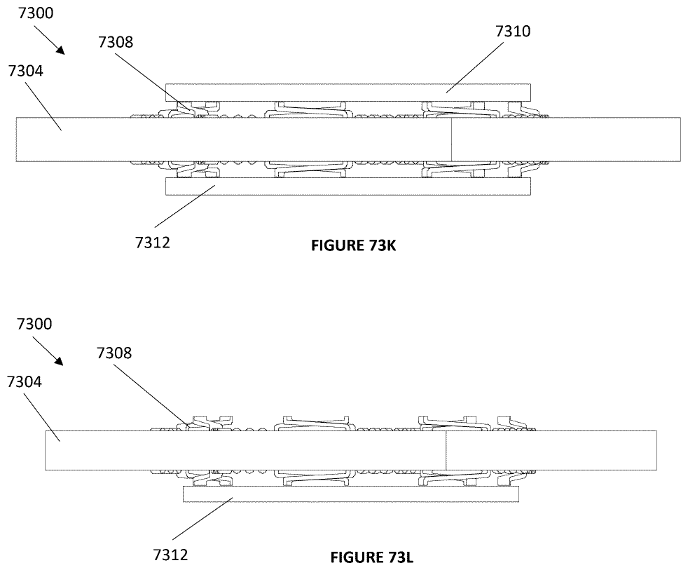

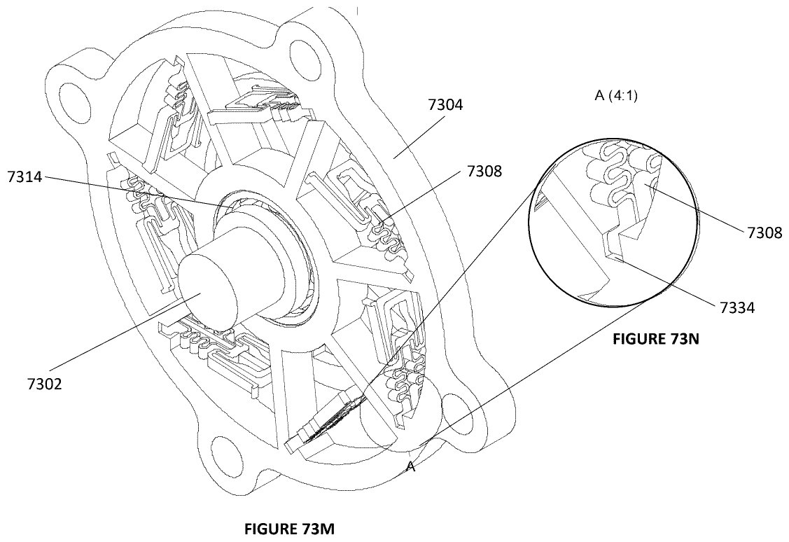

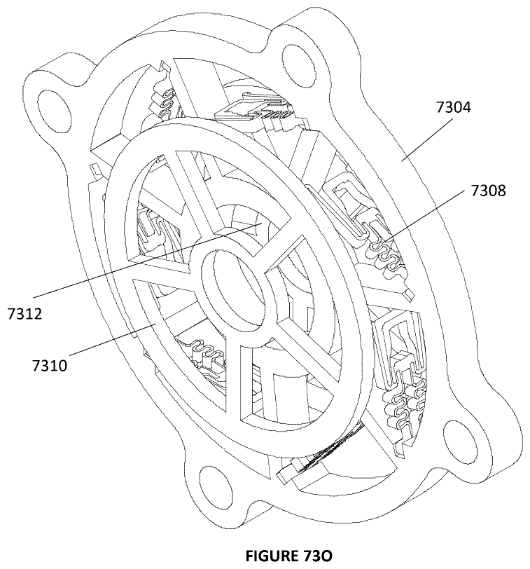

Referring now generally to the Figures and particularly to FIG. 73A, FIG. 73A is a line drawing presenting a rotary motor 7300, which is a rotating apparatus incorporating a plurality of linear actuators. The rotary motor 7300 may comprise a central axle 7302, a housing 7304 optionally including one or more securing apertures 7306, a plurality of linear actuator paddles 7308 (it is noted that only a representative one of the plurality of linear actuator paddles 7308 is labeled in FIG. 73A, and each one of the plurality of linear actuator paddles 7308 will be numbered and named individually later on in FIG. 73B), and a pair of outer discs 7310-12 (a first outer disc 7310 and a second outer disc 7312; the second outer disc 7312 is not visible from this angle, but will be shown in subsequent Figures). The pair of outer discs 7310-12 rotate synchronously because the pair of outer discs 7310-12 are linked one to another in the axial space. The securing apertures 7306 may be utilized for mounting to some other device, like, for example, a scooter, a car, or industrial equipment (not shown).

Referring now generally to the Figures and particularly to FIG. 73B, FIG. 73B is a line drawing presenting the rotary motor 7300 with the casing removed, revealing additional components of the rotary motor 7300, such as a second outer disc 7312 and a central disc 7314. The plurality of linear actuator paddles 7308 is also individually differentiated into a first linear actuator paddle 7308A, a second linear actuator paddle 7308B, a third linear actuator paddle 7308C, a fourth linear actuator paddle 7308D, a fifth linear actuator paddle 7308E, a sixth linear actuator paddle 7308F, and a seventh linear actuator paddle 7308G. While the presented embodiment includes seven linear actuator paddles 7308, different embodiments with different numbers of linear actuator paddles 7308 are possible, even including a version with just one linear actuator paddle 7308. The central disc 7314 is able to rotate freely around the central axle 7302. A bearing or bearings are placed in the center, allowing the pair of outer discs 7310-12 and the central disc 7314 to rotate smoothly without substantial friction. The central disk 7314 has a bigger diameter and can transfer rotation torque where needed. One possible application of the rotary motor 7300 is powering an electric bicycle, with a plurality of bicycle wheel spokes mounted to the central disk 7314 and the rotary motor 7300 powering rotation of a bicycle wheel. As another example application, a robotic rover may have an instance of the rotary motor 7300 on each wheel, covered by a tire.

Referring now generally to the Figures and particularly to FIG. 73C, FIG. 73C is a first line drawing presenting a representative one of the plurality of linear actuator paddles 7308, the first linear actuator paddle 7308A, in isolation. Each of the plurality of linear actuator paddles 7308 may comprise a linear actuator paddle frame 7316 and two actuator stacks such as piezoelectric stacks, specifically an extender actuator stack 7318 and a grip actuator stack 7320. The linear actuator paddle 7308 can be subdivided into an extender section 7322 similar to the middle section 5104 of the GLA 5100 and a grip section 7324 similar to one of the clamps 5102 of the GLA 5100. The extender section 7322 includes the extender actuator stack 7318 and a pair of extender springs 7326 (individually, a C-side extender spring 7326C and a D-side extender spring 7326D). The grip section 7324 may further include the grip actuator stack 7320, a pair of grip fulcrum zone areas 7328 (individually, a C-side grip fulcrum zone area 7328C and a D-side grip fulcrum zone area 7328D), and a pair of paddle legs 7330 (individually, a C-side paddle leg 7330C and a D-side paddle leg 7330D). The linear actuator paddle frame 7316 may also further include one or more mounting apertures 7332 such as for using bolts to mount the linear actuator paddles 7308 in place on the rotary motor 7300. It is noted that other mounting means may be used which do not require these apertures, such as but not limited to adhesives.

Referring now generally to the Figures and particularly to FIG. 73D, FIG. 73D is a line drawing presenting only the linear actuator paddle frame 7316 of the first linear actuator paddle 7308A, without the extender actuator stack 7318 and the grip actuator stack 7320.

Referring now generally to the Figures and particularly to FIG. 73E, FIG. 73E is a line drawing presenting some selected components of the rotary motor 7300 in isolation, specifically an assembly of the central axle 7302, the second outer disc 7312, and the central disc 7314.

Referring now generally to the Figures and particularly to FIG. 73F, FIG. 73F is a line drawing presenting the central disc 7314 of the rotary motor 7300 in isolation.

Referring now generally to the Figures and particularly to FIG. 73G, FIG. 73G is a line drawing presenting the central axle 7302 of the rotary motor 7300 in isolation.

Referring now generally to the Figures and particularly to FIG. 73H, FIG. 73H is a line drawing presenting some selected components of the rotary motor 7300 in isolation, specifically an assembly of the housing 7304 and the plurality of linear actuator paddles 7308.

Referring now generally to the Figures and particularly to FIG. 73I, FIG. 73I is a line drawing presenting a front view of the rotary motor 7300. Labeled here are the central axle 7302, the housing 7304, one of the plurality of linear actuator paddles 7308, the first outer disc 7310, and the central disc 7314.

Referring now generally to the Figures and particularly to FIG. 73J, FIG. 73J is a line drawing presenting a back view of the rotary motor 7300. Labeled here are the central axle 7302, the housing 7304, one of the plurality of linear actuator paddles 7308, and the second outer disc 7312.

Referring now generally to the Figures and particularly to FIG. 73K, FIG. 73K is a line drawing presenting a top view of the rotary motor 7300. Labeled here are the housing 7304, one of the plurality of linear actuator paddles 7308, the first outer disc 7310, and the second outer disc 7312.

Referring now generally to the Figures and particularly to FIG. 73L, FIG. 73L is a line drawing presenting a top view of the rotary motor 7300 with the first outer disc 7310 removed to show additional aspects. Labeled here are the housing 7304, one of the plurality of linear actuator paddles 7308, and the second outer disc 7312.

Referring now generally to the Figures and particularly to FIG. 73M, FIG. 73M is a line drawing presenting a view of a partial assembly of the rotary motor 7300 to show the positioning of the inset view of FIG. 73M. Labeled here are the central axle 7302, the housing 7304, one of the plurality of linear actuator paddles 7308, and the central disc 7314.

Referring now generally to the Figures and particularly to FIG. 73N, FIG. 73N is a line drawing presenting an inset view to show further detail of the rotating apparatus of FIG. 73A. Each of the linear actuator paddles 7308 is mounted on a cutout 7334, as shown here, using an attachment means such as but not limited to glue, welding, or bolts. It is noted that the mounting apertures 7332 are for mounting with bolts.

Referring now generally to the Figures and particularly to FIG. 73O, FIG. 73O is a line drawing presenting some selected components of the rotary motor 7300 in isolation, specifically an assembly of the housing 7304, the plurality of linear actuator paddles 7308, and the pair of outer discs 7310-12.

Further regarding locomotion aspects of the rotary motor 7300, the linear actuator paddles 7308 are positioned on the housing 7304 such that an end of each of the paddle legs 7330 is contacting each of the outer discs 7310-12, either in radial cutouts or directly, without cutouts. The outer discs 7310-12, including any cutouts shaped thereupon, may contain dents for further enhancing traction. In the embodiment presented in FIGS. 73A through 73M, the housing 7304 is fixed in place while the outer discs 7310-12 are propelled to spin; it is noted that an alternative embodiment is also possible wherein one or a pair of outer discs remain fixed and an inner disc element spins instead.

In understanding the locomotion of the rotary motor 7300, it may be useful to picture the analogy of a person manually pushing on a wheel to make the wheel spin. The person spinning the wheel doesn't maintain a constant grip, but pushes to start the wheel spinning, relies on the momentum generated by that push to make the wheel continue to spin, and periodically nudges the wheel to provide additional energy to keep the wheel spinning in the same direction at speed. With the outer discs 7310-12 as the wheel in the above-stated analogy, and the linear actuator paddles 7308 substituted for one's hand providing a push, the concept is similar. Each of the linear actuator paddles 7308 starts out in an engaged position, contacting the outer discs 7310-12. The process starts with the first linear actuator paddle 7308A extending, causing a tiny rotation of the outer discs 7310-12 relative to each other. Both of the outer discs 7310-12 are moving relatively to the central disc 7314. Once the first linear actuator paddle 7308A has extended, the first linear actuator paddle 7308A disengages from the outer discs 7310-12, letting the outer discs 7310-12 continue spinning on momentum alone or as pushed by others of the linear actuator paddles 7308, until the first linear actuator paddle 7308A finishes contracting and pushes on the outer discs 7310-12. If the extension and contraction of the linear actuator paddles 7308 is staggered, steady rotation of the outer discs 7310-12 can be achieved, without significant jarring or vibration. It is further noted that, while the presented embodiment includes seven linear actuator paddles 7308, different embodiments with different numbers of linear actuator paddles 7308 are possible, even including a version with just one linear actuator paddle 7308. The paddle legs 7330 of each of the linear actuator paddles 7308 are moving around an oval trajectory. This trajectory is defined by synchronous oscillating of the extender actuator stack 7318 (defining the perpendicular movements) and the grip actuator stack 7320, defining the back and forward movements. This small oscillation allows the paddle legs 7330 to touch the surface of the outer discs 7310-12 in the tangent direction. The paddle legs 7330 are touching the surface of the outer discs 7310-12 again and again and providing a tangent impulse.

One important design consideration is how electricity is to be provided to the plurality of linear actuator paddles 7308. Two approaches are suggested. A first option is to mount some or all of the plurality of linear actuator paddles 7308 to a non-moving disk connected to a device (such as the housing 7304) and provide external electricity to the non-moving disk, and through the disk, to the plurality of linear actuator paddles 7308. A second option is to make the legs of the linear actuator paddles 7308 conductive, and provide electricity non-constantly via the conductive legs when the legs contact a charged surface. When the legs are not touching the charged surface, a capacitor in the controller may keep enough energy to complete the movement of the cycle and to be re-charged incrementally each time a leg touches the charged surface.

Referring now generally to the Figures and particularly to FIG. 74A, FIG. 74A is a line drawing presenting a double-decker amplified push GLA 7400, which is an assembly of two instances of the amplified push GLA 5800 frame, identified individually here as a first paired amplified push GLA frame 5800A and a second paired amplified push GLA frame 5800B. The double-decker amplified push GLA 7400 has a double-decker amplified middle actuator 7402.

Referring now generally to the Figures and particularly to FIG. 74B, FIG. 74B is a second line drawing pertaining to discussion of the double-decker amplified push GLA 7400, particularly a visual aid for discussing a key benefit of the double-decker amplified push GLA 7400. As discussed generally regarding the GLA 5100 and more specifically regarding the amplified push GLA 5800, when the middle actuator 5110 (more specifically regarding the amplified push GLA 5800, the amplified push middle section actuator 5810) expands, adjacent frame elements are pushed on and distorted, thus mechanically amplifying the motion effected by the middle actuator 5110. However, in certain applications of the amplified push GLA 5800, there is a potential issue of the expansion of the amplified push middle section actuator 5810 twisting the amplified push GLA frame 5800F such that an A end 7404 of the amplified push GLA 5800 is skewed out of alignment with a B end 7406. The double-decker amplified push GLA 7400 is presented as a possible solution to this issue, particularly for larger-scale applications. The double-decker amplified push GLA 7400 is a little more complex to manufacture than just a single instance of the amplified push GLA 5800, but the two mirrored instances of the amplified push GLA 5800 can compensate against each other's tendency to twist the wrong way.

Referring now generally to the Figures and particularly to FIG. 74C, FIG. 74C is a third line drawing presenting a second view of the double-decker amplified push GLA 7400, further including the first paired amplified push GLA frame 5800A, the second paired amplified push GLA frame 5800B, and the double-decker amplified middle actuator 7402.

Referring now generally to the Figures and particularly to FIG. 74D, FIG. 74D is a line drawing presenting an exploded view of the double-decker amplified push GLA 7400. The first paired amplified push GLA frame 5800A further comprises a first paired amplified push first frame piece 5816A, a first paired amplified push second frame piece 5818A, and a set of three first paired amplified push gaskets, specifically a first paired amplified push first gasket 5814A.A, a first paired amplified push second gasket 5814B.A, and a first paired amplified push third gasket 5814C.A. The second paired amplified push GLA frame 5800B further comprises a second paired amplified push first frame piece 5816B, a second paired amplified push second frame piece 5818B, and a set of three second paired amplified push gaskets, specifically a second paired amplified push first gasket 5814A.B, a second paired amplified push second gasket 5814B.B, and a second paired amplified push third gasket 5814C.B. It is noted that the first paired amplified push GLA frame 5800A and the second paired amplified push GLA frame 5800B are reversed relative to each other, such that the first paired amplified push second frame piece 5818A and the second paired amplified push second frame piece 5818B are against each other; it is further noted that the two pieces of the first paired amplified push second frame piece 5818A and the second paired amplified push second frame piece 5818B could alternatively be replaced by a single piece of material with doubled height.

The various elements, aspects, systems and components of various preferred embodiments of the present invention as disclosed herein can be designed by one of ordinary skill in the art at least by means of prior art Computer Aided Design (“CAD”) software products commercially available on the market, including but not limited to the following: SOLIDWORKS™ as marketed by Dassault Systèmes of Vélizy-villacoublay, France; suitable software products of the ANSYS™ product line as marketed by ANSYS, Inc. of Canonsburg PA; AUTODESK INVENTOR or AUTODESK FUSION 360 CAD software products as marketed by AUTODESK, Inc. of San Francisco, CA; SOLID EDGE™ CAD software as marketed by Siemens AG of Munich and Berlin, Federal Republic of Germany; a suitable CREO™ CAD software selected from the CREO™ product line as marketed by PTC of Boston, MA and/or other a suitable, prior art, CAD software product

These commercially available CAD software products allow user to not only model solid device behavior, but also create an animation to predict device deformations under a load with great accuracy. This capacity of the mentioned CAD software products provides the user with not only numerical data for understanding and adjusting the parameters of the deformation, but also to get a visual representation of this deformation.

Most practical design calculations involve components with a complicated three-dimensional geometry, and may also need to account for inherently nonlinear phenomena such as contact, large shape changes, or nonlinear material behavior. These problems can be solved using prior art computer simulation software and systems, to include instances of suitable, prior art, commercially available, CAD software products running on an HP ZBOOK POWER™ 15.6 inch G9 Mobile Workstation PC-Wolf Pro Security Edition™ as marketed by Hewlett-Packard, Inc. of Palo Alto, CA; a suitable APPLE™ workstation or APPLE™ computer running MACOS 13 VENTURA™ (Version 2.0.15289 or newer) as marketed by Apple, Inc. of Cupertino, CA, and/or other suitable prior art computer or workstation products and software.

It is understood that a suitable, prior art, commercially available CAD software product may additionally apply the finite element method (“FEM”); FEM is by far the most widely used and versatile technique for simulating deformable solids. FEM is a suitable, prior art computational technique applied to solve pluralities or multiplicities of partial differential equations. Furthermore, FEM is a prior art computational method used to predict the deformation and stress fields within solid bodies subjected to external forces.

The prior art includes many commercially available FEM software products, including (1.) SOLIDWORKS™ as marketed by Dassault Systèmes of Vélizy-villacoublay, France; (2.); a suitable AUTODESK FUSION 360 CAD software product as marketed by AUTODESK, Inc. of San Francisco, CA, and/or other suitable prior art computer or workstation products and software.

Suitable, prior art, commercially available, FEM software products can be run on an HP ZBOOK POWER™ 15.6 inch G9 Mobile Workstation PC-Wolf Pro Security Edition™ as marketed by Hewlett-Packard, Inc. of Palo Alto, CA; a suitable APPLE™ workstation or APPLE™ computer running MACOS 13 VENTURA™ (Version 2.0.15289 or newer) as marketed by Apple, Inc. of Cupertino, CA; and/or other suitable prior art computer or workstation products and software

To set up a finite element calculation with prior art software products and computational equipment, the user may first specify the geometry of a solid element of interest. This is done in the prior art by computationally generating a finite element mesh for selected solid. The mesh can be generated automatically from a prior art CAD representation of the solid.

The properties of the material must also be considered. The user generally must specify a constitutive law for the solid; This constitutive law enforces compatibility, i.e, impenetrability constraint preventing contacting bodies from penetrating one another, through the use of a “penalty” stress that is proportional to the violation of compatibility.

The nature of the loading to be applied to the selected solid must be computationally modelled as well; specifying the boundary conditions for the problem are required. There are also other problems that can be solved by a FEM system and prior art software, e.g., vibrational effects, material flows, dynamic properties, and etc.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

I claim:

1. An apparatus comprising:
a piezoelectric element having a rooted end and an extending end, the piezoelectric element configured to extend the extending end along an axis and away from the rooted end when energized;
a lever assembly comprising a lever arm a fulcrum zone, the lever coupled with the extended end at an inner lever end and with a leg at an opposing outer lever end, wherein the fulcrum zone is configured to enable transfer of mechanical force received from the piezoelectric element extending end to cause displacement of the outer lever end and the leg.

2. The apparatus of claim 1, wherein the fulcrum zone is positioned to cause the leg to rotate toward the piezoelectric element rooted end when the lever receives mechanical force transferred from the piezoelectric element extending end.

3. The apparatus of claim 2, wherein the fulcrum zone is positioned closer to the inner lever end then to the outer lever end.

4. The apparatus of claim 1, wherein fulcrum zone is positioned to drive the leg away from the rooted end extending when the lever receives mechanical force from the piezoelectric element extending end.

5. The apparatus of claim 1, wherein fulcrum zone is positioned to drive the outer lever end away from the piezoelectric element rooted end when the lever receives mechanical force from the piezoelectric element extending end.

6. An apparatus comprising:
a piezoelectric element having a rooted end and an extending end, the piezoelectric element configured to extend the extending end along an axis and away from the rooted end when energized;
a first lever assembly comprising a first lever arm a first fulcrum zone, the first lever coupled with the extended end at a first inner lever end and with a first leg at an first opposing lever end, wherein the first fulcrum zone is configured to enable transfer of mechanical force received from the piezoelectric element extending end to cause displacement of the first outer lever end and the first leg; and
a second lever assembly comprising a second lever arm a second fulcrum zone, the second lever coupled with the extended end at a second inner lever end and with a second leg at an second opposing lever end, wherein the second fulcrum zone is configured to enable transfer of mechanical force received from the piezoelectric element extending end to cause displacement of the second outer lever end and the second leg.

7. The apparatus of claim 6, wherein first fulcrum zone is positioned to enable the first leg to rotate toward the piezoelectric element rooted end when the first lever receives mechanical force transferred from the piezoelectric element extending end.

8. The apparatus of claim 7, wherein second fulcrum zone is positioned to enable the second leg to rotate toward the piezoelectric element rooted end when the second lever receives mechanical force transferred from the piezoelectric element extending end.

9. The apparatus of claim 6, wherein first fulcrum zone is positioned to enable the first leg to rotate away from the piezoelectric element rooted end when the first lever receives mechanical force transferred from the piezoelectric element extending end.

10. The apparatus of claim 9, wherein second fulcrum zone is positioned to enable the second leg to rotate away from the piezoelectric element rooted end when the second lever receives mechanical force transferred from the piezoelectric element extending end.

11. The apparatus of claim 6, further comprising a frame, wherein the first lever is attached to the first leg and with the frame at a first side of the frame, and the second lever is attached to the second leg and with the frame at an opposing second side of the frame.

12. The apparatus of claim 11, further comprising a second assembly comprising:
a second piezoelectric element having a second rooted end and a second extending end, the second piezoelectric element configured to extend the second extending end along the axis and in opposite direction from the direction of extension of the piezoelectric element;
a third lever assembly comprising a third lever arm and a third fulcrum zone, the third lever coupled with the second extended end at a third inner lever end and with a third leg at a third opposing lever end, wherein the third fulcrum zone is configured to enable transfer of mechanical force received from the second piezoelectric element extending end to cause displacement of the third outer lever end and the third leg, wherein the third lever is attached to the third leg and with the frame at the first side of the frame; and
a fourth lever assembly comprising a fourth lever arm and a fourth fulcrum zone, the fourth lever coupled with the second extended end at a fourth inner lever end and with a fourth leg at a fourth opposing lever end, wherein the fourth fulcrum zone is configured to enable transfer of mechanical force received from the second piezoelectric element extending end to cause displacement of the fourth outer lever end and the fourth leg, wherein the fourth lever is attached to the fourth leg and with the frame at the opposing second side of the frame.

13. The apparatus of claim 12, wherein the third fulcrum zone is positioned to cause the third leg to rotate toward the second piezoelectric element rooted end when the third lever receives mechanical force transferred from the second piezoelectric element extending end.

14. The apparatus of claim 12, wherein the third fulcrum zone is positioned closer to the third inner lever end then to the third outer lever end.

15. The apparatus of claim 12, wherein fourth fulcrum zone is positioned to drive the fourth leg away from the second rooted end when the fourth lever receives mechanical force from the second piezoelectric element extending end.

16. The apparatus of claim 12, wherein fourth fulcrum zone is positioned to drive the fourth outer lever end away from the second rooted end when the fourth lever receives mechanical force from the second piezoelectric element extending end.

17. A method comprising:
a. positioning a device between a first surface and an opposing second surface, the device comprising:
i. a piezoelectric element having a frame, a rooted end and an extending end, the piezoelectric element configured to extend the extending end along an axis and away from the rooted end when energized;
ii. a first lever assembly comprising a first lever arm a first fulcrum zone, the first lever coupled with the extended end at a first inner lever end and with a first leg at an first opposing lever end, wherein the first fulcrum zone is configured to enable transfer of mechanical force received from the piezoelectric element extending end to cause displacement of the first outer lever end and the first leg; and
iii. a second lever assembly comprising a second lever arm a second fulcrum zone, the second lever coupled with the extended end at a second inner lever end and with a second leg at an second opposing lever end, wherein the second fulcrum zone is configured to enable transfer of mechanical force received from the piezoelectric element extending end to cause displacement of the second outer lever end and the second leg; and
b. energizing the piezoelectric element to cause the piezoelectric element to extend, whereby both the first leg and the second leg are displaced.

18. The method of claim 17, further comprising:
c. the device further comprising:
i. a second piezoelectric element having a second rooted end and a second extending end, the second piezoelectric element configured to extend the second extending end along the axis and in opposite direction from the direction of extension of the piezoelectric element;
ii. a third lever assembly comprising a third lever arm and a third fulcrum zone, the third lever coupled with the second extended end at a third inner lever end and with a third leg at a third opposing lever end, wherein the third fulcrum zone is configured to enable transfer of mechanical force received from the second piezoelectric element extending end to cause displacement of the third outer lever end and the third leg;
iii. fourth lever assembly comprising a fourth lever arm and a fourth fulcrum zone, the fourth lever coupled with the second extended end at a fourth inner lever end and with a fourth leg at a fourth opposing lever end, wherein the fourth fulcrum zone is configured to enable transfer of mechanical force received from the second piezoelectric element extending end to cause displacement of the fourth outer lever end and the fourth leg;
iv. the first lever is attached to the first leg and with the frame at a first side of the frame, the second lever is attached to the second leg and with the frame at an opposing second side of the frame, the third lever is attached to the third leg and with the frame at the first side of the frame, and the fourth lever is attached to the fourth leg and with the frame at the opposing second side of the frame; and
d. energizing the piezoelectric element to cause the piezoelectric element to extend, whereby both the first leg and the second leg are displaced; and
e. energizing the second piezoelectric element to cause the second piezoelectric element to extend, whereby both the third leg and the fourth leg are displaced.

19. The method of claim 18, further comprising positioning the first fulcrum zone to enable the first leg to rotate toward the piezoelectric element rooted end when the first lever receives mechanical force transferred from the piezoelectric element extending end.

20. The method of claim 18, further comprising positioning the first fulcrum zone to enable the first leg to rotate away from the piezoelectric element rooted end when the first lever receives mechanical force transferred from the [first] piezoelectric element extending end.
